(19) United States
(12) Patent Application Publication
(10) Pub. No.: US 2004/0101135 A1
(43) Pub. Date: May 27, 2004

(54) Encryption level indicator calculation method and computer program

(76) Inventor: Shoji Kanamaru, Tokyo (JP)

Correspondence Address: William S. Frommer, Esq., FROMMER LAWRENCE & HAUG LLP, 745 Fifth Avenue, New York, NY, 10151, US

(21) Appl. No.: 10/634,418

(22) Filed: Aug. 5, 2003

(30) Foreign Application Priority Data
Aug. 7, 2002 (JP) 2002-230270

(51) Int. Cl. H04K 1/00

(52) U.S. Cl. 380/28

(57) ABSTRACT

The present invention provides a method for reliably carrying out an encryption level evaluation process in a common-key block encryption method. To be more specific, an algorithm of a key-scheduling part is expressed in terms of equations represented by vectors and a matrix, and non-linear transformation output values and initial values are eliminated from the matricial equation by carrying out a unitary transformation process in order to find all equations expressing linear relations among round keys. In accordance with the method, it is possible to comprehend all equations expressing linear relations among round keys in the common-key block encryption method without regard to the complexity of key scheduling and evaluate the encryption level of the common-key block encryption method on the basis of the derived equations expressing linear relations among round keys.

### BACKGROUND OF THE INVENTION

The present invention relates to an encryption level indicator calculation method and a computer program. To put it in more detail, the present invention relates to an encryption level indicator calculation method for calculating an indicator for evaluating safety and level of a common-key block encryption method as well as relates to a computer program implementing the encryption level indicator calculation method.

There is a variety of encryption processing algorithms, which can be roughly classified a public key encryption method and a common-key encryption method. The public key encryption method is an encryption method, which sets an encryption key and a decryption key as different keys such as a public key and a private key. On the other hand, the common-key encryption method is an encryption method, which sets an encryption key and a decryption key as a common key.

There is also a variety of algorithms adopted in the common-key encryption method. An encryption method adopts one of the algorithms. In accordance with this encryption method, a plurality of keys is generated with a common key used as a base and the generated keys are used in carrying out an encryption process. As a method for generating the keys, a method using a round function is adopted. To put it in detail, in accordance with this key generation method, the round function is applied to a common key to generate a new key on the basis of the output value. Then, the round function is applied to the new key to generate another key. Subsequently, the round function is applied to the other key to generate a further key. Then, the round function is applied to the further key to generate a still further key. This procedure repeating the operation to generate a key results in a plurality of keys. A representative algorithm for generating a plurality of keys as described above is referred to as a common-key block encryption method.

The common-key block encryption processing algorithm can be divided mainly into a round function part and a key-scheduling part. Conventionally, in order to secure safety against attacks related to a key or the like, an designer of encryption method is required to design a key-scheduling part with great caution in designing a common-key block encryption method so that a simple relation among round functions is not established.

As an encryption method designed on the basis of such a guiding principle, Toshiba has proposed a common-key block encryption method called Hierocrypt. For details of the Hierocrypt common-key block encryption method, refers to, for example, a reference authored by K. Ohkuma et al. with a title of “The Block Cipher Hierocrypt,” Selected Areas in Cryptography, LNCS 2012, pp. 72-88, 2000. The key-scheduling part of the Hierocrypt algorithm has a repetitive structure called a Feistel structure. A linear transformation part forming the right half of the Feistel structure tries an operation to avoid an attack related to a key by carrying out an XOR addition process on round-dependent constants.

As a matter of fact, however, in the year of 2001, Furuya et al. discovered the fact that a linear relation among round keys is established. The fact that a linear relation among round keys is established was not expected by the creator of the Hierocypt algorithm. For details of the discovery made by Furuya et al., refer to, for example, a reference authored by S. Furuya and V. Rijmen with a title of “Observations on Hierocrypt-3/L1 Key-scheduling Algorithms,” Second NESSIE workshop, 2001.

In accordance with a method developed by Furuya et al. as described in the above reference, however, an equation expressing a linear relation among round keys is derived by combining algorithms of the key-scheduling part of the Hierocrypt method on a trial-and-error basis. Thus, there is no assurance that the discovered equations are all comprehended. In addition, with the trial-and-error basis, the difficulty in finding a relation equation increases in case the key scheduling becomes more complicated.

### SUMMARY OF THE INVENTION

It is thus an object of the present invention addressing the problems described above to provide an encryption level indicator calculation method that is capable of comprehending all linear equations expressing relations among round keys in a common-key block encryption method without regard to the complexity of key scheduling, and capable of evaluating the encryption level of the common-key block encryption method on the basis of a discovered linear-relation equation, as well as provide a computer program implementing the encryption level indicator calculation method.

In accordance with a first aspect of the present invention, there is provided an encryption level indicator calculation method based on an encryption processing algorithm and composed of:

a step of setting a common key block encryption processing algorithm, which is to serve as the encryption processing algorithm to be used as the base of the encryption level indicator calculation method, has a key-scheduling part comprising a linear transformation part and a non-linear transformation part and includes:

a sub-step of generating initial values Uᵢ (where i=1, 2 and so on) from a master key;

a sub-step of calculating intermediate values Zᵢ⁽⁰⁾ (where i=1, 2 and so on) from the initial values Uᵢ (where i=1, 2 and so on);

a plurality of sub-steps of calculating intermediate values Zᵢ⁽⁰⁾ (where i=1, 2 and so on) from intermediate values Zᵢ^{(r-1)} (where i=1, 2 and so on);

a sub-step of calculating the non-linear transformation part outputs Vᵢ^{(r)} (where i=1, 2 and so on and r=1, 2 and so on) from the intermediate values Zᵢ^{(r)} (where i=1, 2 and so on and r=1, 2 and so on) and the initial values Uᵢ (where i=1, 2 and so on); and

a sub-step of calculating round keys Kᵢ^{(r)} (where i=1, 2 and so on and r=1, 2 and so on) from the intermediate values Zᵢ^{(r)} (where i=1, 2 and so on and r=1, 2 and so on) and the non-linear transformation part outputs Vᵢ^{(r)} (where i=1, 2 and so on and r=1, 2 and so on);

a step of eliminating the intermediate values Zᵢ^{(r)} (where i=1, 2 and so on and r=1, 2 and so on) serving as variables so that the round keys Kᵢ^{(r)} (where i=1, 2 and so on and r=1, 2 and so on) can be expressed as a linear combination of the initial values Uᵢ (where i=1, 2 and so on) and the non-linear transformation part outputs Vᵢ^{(r)} (where i=1, 2 and so on and r=1, 2. and so on);

a step of transforming the linear combination into a simultaneous linear equation completing transposition of terms and, thus, consisting of only terms of the initial values Uᵢ (where i=1, 2 and so on) and the non-linear transformation part outputs Vᵢ^{(r)} (where i=1, 2 and so on and r=1, 2 and so on) on the right-hand side of the equation;

a step of transforming the simultaneous linear equation into a matricial equation;

a step of multiplying both the left-hand and right-hand sides of the matricial equation by a row-deform unitary matrix deforming a matrix on the right-hand side of the matricial equation obtained as a result of transformation into a step matrix from the left;

a step of creating a new matrix consisting of lowest N rows of a matrix on the left-hand side of the matricial equation obtained as a result of transformation where N is a number obtained as a result of subtracting the rank value of the step matrix from the number of rows in the step matrix; and

a step of finding N linear-relation equations by multiplying a column vector consisting of the round keys Kᵢ^{(r)} (where i=1, 2 and so on and r=1, 2 and so on) as elements by the new matrix generated at the preceding step,

where:

symbol Uᵢ (where i=1, 2 and so on) denotes an initial value of the key-scheduling part;

symbol Zᵢ^{(r)} (where i=1, 2 and so on and r=1, 2 and so on) denotes an intermediate value of the key-scheduling part;

symbol Vᵢ^{(r)} (where i=1, 2 and so on and r=1, 2 and so on) denotes an output of the non-linear transformation part; and

symbol Kᵢ^{(r)} (where i=1, 2 and so on and r=1, 2 and so on) denotes a round key calculated from the intermediate values Zᵢ (where i=1, 2 and so on)

In accordance with a second aspect of the present invention, there is provided a program to be executed as a computer program in carrying out an encryption level indicator calculation process based on an encryption processing algorithm and composed of:

a step of setting a common key block encryption processing algorithm, which is to serve as the encryption processing algorithm to be used as the base of the encryption level indicator calculation method and includes:

a sub-step of generating initial values Uᵢ (where i=1, 2 and so on) from a master key;

a sub-step of calculating intermediate values Zᵢ⁽⁰⁾ (where i=1, 2 and so on) from the initial values Uᵢ (where i=1, 2 and so on);

a plurality of sub-steps of calculating intermediate values Zᵢ^{(r)} (where i=1, 2 and so on) from intermediate values Zᵢ^{(r-1)} (where i=1, 2 and so on);

a sub-step of calculating the non-linear transformation part outputs Vᵢ^{(r)} (where i=1, 2 and so on and r=1, 2 and so on) from the intermediate values Zᵢ^{(r)} (where i=1, 2 and so on and r=1, 2 and so on) and the initial values Uᵢ (where i=1, 2 and so on) ; and

a sub-step of calculating round keys Kᵢ^{(r)} (where i==1, 2 and so on and r=1, 2 and so on) from the intermediate values Zᵢ^{(r)} (where i=1, 2 and so on and r=1, 2 and so on) and the non-linear transformation part outputs Vᵢ^{(r)} (where i=1, 2 and so on and r=1, 2 and so on);

a step of eliminating the intermediate values Zᵢ^{(r)} (where i=1, 2 and so on and r=1, 2 and so on) serving as variables so that the round keys Kᵢ(r) (where i=1, 2 and so on and r=1, 2 and so on) can be expressed as a linear combination of the initial values Uᵢ (where i=1, 2 and so on) and the non-linear transformation part outputs Vᵢ^{(r)} (where i=1, 2 and so on and r=1, 2 and so on);

a step of transforming the linear combination into a simultaneous linear equation completing transposition of terms and, thus, consisting of only terms of the initial values Uᵢ (where i=1, 2 and so on) and the non-linear transformation part outputs Vᵢ^{(r)} (where i=1, 2 and so on and r=1, 2 and so on) on the right-hand side of the equation;

a step of transforming the simultaneous linear equation into a matricial equation;

a step of multiplying both the left-hand and right-hand sides of the matricial equation by a row-deform unitary matrix deforming a matrix on the right-hand side of the matricial equation obtained as a result of transformation into a step matrix from the left;

a step of creating a new matrix consisting of lowest N rows of a matrix on the left-hand side of the matricial equation obtained as a result of transformation where N is a number obtained as a result of subtracting the rank value of the step matrix from the number of rows in the step matrix; and

a step of finding N linear-relation equations by multiplying a column vector consisting of the round keys Kᵢ^{(r)} (where i=1, 2 and so on and r=1, 2 and so on) as elements by the new matrix generated at the preceding step,

where:

symbol Uᵢ (where i=1, 2 and so on) denotes an initial value of the key-scheduling part;

symbol Zᵢ^{(r)} (where i=1, 2 and so on and r=1, 2 and so on) denotes an intermediate value of the key-scheduling part;

symbol Vᵢ^{(r)} (where i=1, 2 and so on and r=1, 2 and so on) denotes an output of the non-linear transformation part; and

symbol Kᵢ^{(r)} (where i=1, 2 and so on and r=1, 2 and so on) denotes a round key calculated from the intermediate values Zᵢ (where i=1, 2 and so on).

In accordance with the configuration of the present invention, it is possible to comprehend all equations expressing relations among round keys in a common-key block encryption method without regard to the complexity of key scheduling and evaluate the encryption level of the common-key block encryption method on the basis of a discovered linear-relation equation.

In addition, in accordance with the configuration of the present invention, by expressing the key-scheduling part algorithm, which is one of encryption processing algorithms, in terms of equations represented by vectors and a matrix and by eliminating non-linear transformation output values and initial values from the matrix-based equation through use of unitary transformation, it is possible to find all linear-relation equations expressing relations among round keys.

It is to be noted that the computer program provided by the present invention is a computer program that can be presented to for example a general-purpose computer system, which is capable of executing various kinds of program code, by being recorded on a recording medium in a computer-readable form or by way of communication media such as a network also in a computer-readable form. Examples of the recording medium are a CD, an FD and an MO disc. Since the computer program is presented to the computer system in a computer-readable form, the computer system is capable of carrying out a process according to the program.

The other objects, characteristics and merits of the present invention will probably become apparent from later detailed explanations of embodiments of the present invention with reference to diagrams. It is to be noted that the technical term ‘system’ used in this specification means a logical group configuration of a plurality of apparatus, which is not necessarily put in the same case.

### BRIEF DESCRIPTION OF THE DRAWING

FIG. 1 shows a flowchart referred to in explanation of an encryption level indicator calculation procedure according to the present invention.

### DETAILED DESCRIPTION OF THE PREFERRED EMBODIMENTS

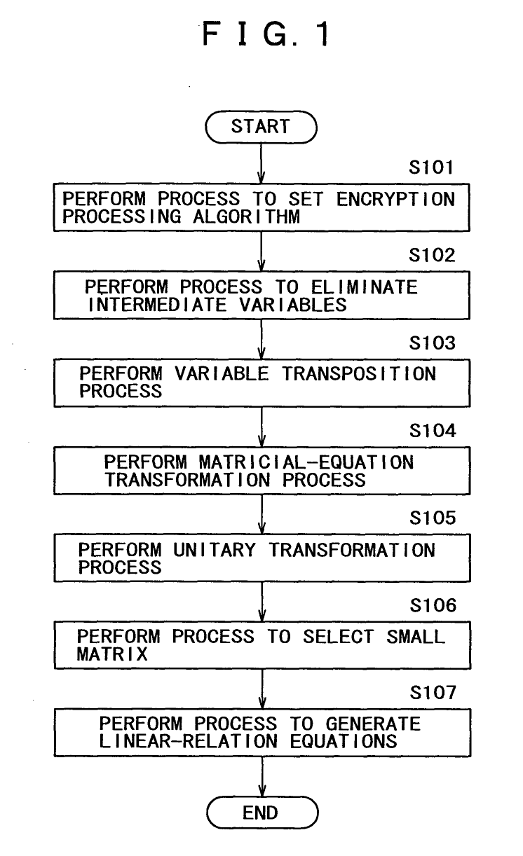

The encryption level indicator calculation method provided by the present invention is explained in detail as follows. First of all, an outline of a procedure of an encryption level indicator calculation process is explained by referring to a flowchart shown in FIG. 1. After that, embodiments implementing the encryption level indicator calculation process provided by the present invention are described by giving a plurality of concrete common-key block encryption processing algorithms as examples.

[Outline of the Encryption level Indicator Calculation Process]

FIG. 1 shows a flowchart representing the encryption level indicator calculation process provided by the present invention. An outline of each processing step in the flowchart is explained as follows.

The flowchart begins with a step S101 to set an encryption processing algorithm to be used as the base of the encryption level indicator calculation method. In this case, the encryption processing algorithm to be used as the base of the encryption level indicator calculation method is a common key block encryption processing algorithm.

To put it concretely, as the encryption processing algorithm to be used as the base of the encryption level indicator calculation method, the processing at this step S101 sets a common key block encryption processing algorithm including a key-scheduling part, which comprises a linear conversion part and a non-linear transformation part, and having:

a step of generating initial values Uᵢ (where i=1, 2 and so on) from a master key;

a step of calculating intermediate values Zᵢ⁽⁰⁾ (where i=1, 2 and so on) from the initial values Uᵢ (where i=1, 2 and so on);

a plurality of steps of calculating intermediate values Zᵢ^{(r)} (where i=1, 2 and so on) from intermediate values Zᵢ^{(r-l)} (where i=1, 2 and so on);

a step of calculating the non-linear transformation part outputs Vᵢ^{(r)} (where i=1, 2 and so on and r=1, 2 and so on) from the intermediate values Zᵢ^{(r)} (where i=1, 2 and so on and r=1, 2 and so on) and the initial values Uᵢ (where i=1, 2 and so on) ; and

a step of calculating round keys Kᵢ^{(r)} (where i=1, 2 and so on and r=1, 2 and so on) from the intermediate values Zᵢ^{(r)} (where i=1, 2 and so on and r=1, 2 and so on) and the non-linear transformation part outputs Vᵢ^{(r)} (where i=1, 2 and so on and r=1, 2 and so on), where:

symbol Uᵢ (where i=1, 2 and so on) denotes an initial value of the key-scheduling part;

symbol Zᵢ^{(r)} (where i=1, 2 and so on and r=1, 2 and so on) denotes an intermediate values of the key-scheduling part;

symbol Vᵢ^{(r)} (where i=1, 2 and so on and r=1, 2 and so on) denotes an output of the non-linear transformation part; and

symbol Kᵢ^{(r)} (where i=1, 2 and so on and r=1, 2 and so on) denotes a round key calculated from the intermediate values Zᵢ (where i=1, 2 and so on).

Then, at the next step S102, intermediate variables of the common-key block encryption processing algorithm set at the step S101 are eliminated. To put it concretely, the processing carried out at the step S102 eliminates the intermediate values Zᵢ^{(r)} (where i=1, 2 and so on and r=1, 2 and so on) so that the round keys Kᵢ^{(r)} (where i=1, 2 and so on and r=1, 2 and so on) can be expressed as a linear combination of the initial values Uᵢ (where i=1, 2 and so on) and the non-linear transformation part outputs Vᵢ^{(r)} (where i=1, 2 and so on and r=1, 2 and so on). The concrete example of the processing will be described later.

Then, at the next step S103, a variable transposition process is carried out. To put it concretely, the processing carried out at the step S103 transforms the expression of the linear combination into a simultaneous linear equation completing transposition of terms and, thus, consisting of only terms of the initial values Uᵢ (where i=1, 2 and so on) and the non-linear transformation part outputs Vᵢ^{(r)} (where i=1, 2 and so on and r=1, 2 and so on). The concrete example of the processing will be described later.

Then, at the next step S104, a matricial-equation transformation process is carried out. The matricial-equation transformation process is a process to transform the simultaneous linear equation into a matricial equation. The matricial-equation transformation process will be explained in concrete terms later.

Then, at the next step S105, a unitary transformation process is carried out. To put it in detail, both the left-hand and right-hand sides of the matricial equation are multiplied by a row-deform unitary matrix deforming a matrix on the right-hand side of the matricial equation obtained as a result of transformation into a step matrix from the left. An embodiment of the unitary transformation process will be described later.

Then, at the next step S106, a small-matrix selection process is carried out. To put it in detail, the small-matrix selection process is a process to create a new matrix consisting of lowest N rows of a matrix on the left-hand side of the matricial equation obtained as a result of transformation where N is a number obtained as a result of subtracting the rank value of the step matrix from the number of rows in the step matrix. An embodiment of the small-matrix selection process will be described later.

Then, at the next step S107, a linear-relation equation generation process is carried out. To put it in detail, the linear-relation equation generation process is a process to find N linear-relation equations by multiplying a column vector consisting of the round keys Kᵢ^{(r)} (where i=1, 2 and so on and r=1, 2 and so on) as elements by the new matrix generated at the preceding step S106. An embodiment of the linear-relation equation generation process will be described later.

The number (N) of linear-relation equations found in the process carried out at the step S107 is the encryption level indicator of the common-key block encryption algorithm set at the step S101. The processing represented by the flowchart described above is executed as a process to find the value of N, which is number of linear-relation equations comprehensively including equations representing linear relations among round keys of the common-key block encryption algorithm set at the step S101. The larger the number (N) of linear-relation equations, the smaller the encryption level. Conversely speaking, the smaller the number (N) of linear-relation equations, the larger the encryption level. Thus, the number (N) of linear-relation equations found by carrying out the processing represented by the flowchart shown in FIG. 1 can be used as the encryption level indicator of the common-key block encryption algorithm.

In accordance with the processing according to the processing procedure represented by the flowchart shown in FIG. 1, the key-scheduling part algorithm, which is one of encryption algorithms, is expressed by a matricial equation represented by vectors and a matrix. By eliminating non-linear transformation output values and initial values from the matricial equation through a unitary transformation process, all equations of linear relations among round keys can be found.

[First Embodiment of Encryption Level Indicator Calculation Process]

As a first embodiment of the encryption level indicator calculation process provided by the present invention, a typical process of applying an encryption level evaluation method provided by the present invention to ‘Hierocrypt-L1’ is explained in detail. ‘Hierocrypt-L1’ is the name of a block encryption process proposed by Toshiba. The ‘Heirocrypt-L1’ block encryption process is a common-key block encryption process with a block length of 64 bits and a key length of 128 bits.

First of all, the step S101 of the flowchart shown in FIG. 1 is explained. As described earlier, at this step, an encryption processing algorithm is set. This step is executed as a process to set the ‘Hierocrypt-L1’ block encryption algorithm proposed by Toshiba.

Let symbol On denote a null matrix consisting of n rows and n columns whereas symbol In denote a unit matrix consisting of n rows and n columns. In this case, a matrix P16 is defined as follows:

[Formula 1]

$$P16 = ( \begin{matrix}I2 & O2 & I2 & O2 \\ O2 & I2 & O2 & I2 \\ O2 & I2 & I2 & I2 \\ I2 & O2 & I2 & I2\end{matrix} )$$

Let symbol P16I denote the inverse matrix of the matrix P16. Next, matrices M5 and MB are defined as follows:

$$\begin{matrix}M5 = ( \begin{matrix}1 & 0 & 1 & 0 \\ 1 & 1 & 0 & 1 \\ 1 & 1 & 1 & 0 \\ 0 & 1 & 0 & 1\end{matrix} ) \\ M B = ( \begin{matrix}0 & 1 & 0 & 1 \\ 1 & 0 & 1 & 0 \\ 1 & 1 & 0 & 1 \\ 1 & 0 & 1 & 1\end{matrix} )\end{matrix}$$

Then matrices M5B and MB5 are defined, being expressed in terms of the matrices M5 and MB as follows:

[Formula 3]

$$\begin{matrix}M5B = ( \begin{matrix}M5 & O4 \\ O4 & M B\end{matrix} ) \\ M B5 = ( \begin{matrix}M B & O4 \\ O4 & M5\end{matrix} )\end{matrix}$$

Next, round dependent constant vectors Gi (where i=0, . . . , 7) are defined as follows:

G0=(h01, h02, h03, h04, 0, 0, 0, 0)

G1=(h11, h12, h13, h14, 0, 0, 0, 0)

G2=(h21, h22, h23, h24, 0, 0, 0, 0)

G3=(h31, h32, h33, h34, 0, 0, 0, 0)

G4=(h41, h42, h43, h44, 0, 0, 0, 0)

G5=(h41, h42, h43, h44, 0, 0, 0, 0)

G6=(h31, h32, h33, h34, 0, 0, 0, 0)

G7=(h21, h22, h23, h24, 0, 0, 0, 0) [formula 4]

It is to be noted that a vector HH with constants in the above equations used as elements is defined as follows:

HH=(h01, h02, h03, h04, h11, h12, h13, h14, h21, h22, h23, h24, h31, h32, h33, h34, h41, h42, h43, h44,) [formula 5]

The actual values of the elements h01, h02, . . . and h44 are defined as follows.

(h01, h01, h02, h03)=(0×5a, 0×82, 0×79, 0×99)

(h11, h11, h12, h13)=(0×6e, 0×9, 0×eb, 0×xz1)

(h21, h21, h22, h23)=(0×8f, 0×1b, 0×bc, 0×dc)

(h31, h31, h32, h33)=(0×ca, 0×62, 0×c1, 0×d6)

(h41, h42, h43, h44)=(0×xf7, 0×de, 0×f5, 0×8a) [formula 6]

Next, a vector ZZ with its elements composing the right half of a sequence of initial values of the key-scheduling part is defined as follows.

ZZ=(z31, z32, z33, z34, z41, z42, z43, z44) [formula 7]

By using these, the right half of the key-scheduling part in the Hierocrypt-L1 common-key encryption algorithm is expressed below. It is to be noted that the operator + used in the following expressions is an additive operator in the Galois field GF(2).

Z0=M5B*ZZ+G0

W0=P16*Z0

Z1=M5B*W0+G1

W1=P16*Z1

Z2=M5B*W1+G2

W2=P16*Z2

Z3=M5B*W2+G4

W3=P16*Z3

Z4=M5B*W3+G4

W5=M5B*(Z4+G5)

Z5=P16I*W5

W6=M5B*(Z5+G6)

Z6=P16I*W6

W7=M5B*(Z6+G7)

Z7=P16I*W7 [formula 8]

Symbols Z0, Z1, Z2, Z3, Z4, Z5, Z6, Z7, WO, W1, W2, W3, W5, W6 and W7 used in the above equations form the right half of the sequence of intermediate values of the key-scheduling part.

Next, these intermediate values are expressed by being split in accordance with the following equations.

Zn=Zn₃||ZN₄

Wn=Wn₁||WN₂ [formula 9]

Symbol || used in the above equations denotes a concatenation of vectors.

Next, let non-linear transformation part outputs of rounds be V0, V1, V2, V3, V4, V5, V6 and V7. Each of the outputs is a vector consisting of four elements as follows.

V0=(v01, v02, v03, v04)

V1=(v11, v12, v13, v14)

V2=(v21, v22, v23, v24)

V3=(v31, v32, v33, v34)

V4=(v41, v42, v43, v44)

V5=(v51, v52, v53, v54)

V6=(v61, v62, v63, v64)

V7=(v71, v72, v73, v74) [formula 10]

Here, vectors Z₁ and Z₂ are set as follows.

Z₁=(z11, z12, z13, z14)

Z₂=(z21, z22, z23, z24) [Formula 11]

With the vectors Z₁ and Z₂ set as described above, the left half of the key-scheduling part in the Hierocrypt-L1 common-key encryption algorithm is expressed as follows.

Z0₁=Z₂

Z0₂=Z₁+V0

Z1₁=Z0₂

Z1₂=Z0₁+V1

Z2₁=Z1₂

Z2₂=Z1₁+V2

Z3₁=Z2₂

Z3₂=Z2₁+V3

Z4₁=Z3₂

Z4₂=Z3₁+V4

Z5₁=Z4₂+V5

Z5₂=Z4₁

Z6₁=Z5₂+V6

Z6₂=Z5₁

Z7₁=Z5₂+V7

Z7₂=Z6₁ [formula 12]

Symbols Z0₁, Z0₂, Z1₁, Z1₂, Z2₁, Z2₂, Z3₁, Z3₂, Z4₁, Z4₂, Z5₁, Z5₂, Z6₁, Z6₂, Z7₁ and Z7₂ used in the above equations form the left half of the sequence of intermediate values of the key-scheduling part.

By using the intermediate values obtained as described above, round keys K1₁, K1₂, K1₃, K1₄t K2₁, . . . , K7₁ and K7₂ are expressed as follows:

K1₁=Z0₁+V1

K1₂=Z1₃+V1

K1₃=Z1₄+V1

K1₄=Z0₂+z1₄

K2₁=Z1₁+V2

K2₂=Z2₃+V2

K2₃=Z2₄+V2

K2₄=Z1₂+Z2₄

K3₁=Z2₁+V3

K3₂=Z3₃+V3

K3₃=Z3₄+V3

K3₄=Z2₂+Z3₄

K4₁=Z3₁+V4

K4₂=Z4₃+V4

K4₃=Z4₄+V4

K5₁=Z5₁+Z4₃

K5₂=W5₁+V5

K5₃=W5₂+V5

K5₄=Z4₁+W5₂

K6₁=Z6₁+Z5₃

K6₂=W6₁+V6

K6₃=W6₂+V6

K6₄=Z5₁+W6₂

K7₁=Z7₁+Z6₃

K7₂=W7₁+V7

K7₃=W7₂+V7

K7₄=Z6₁+W7₂ [formula 13]

It is to be noted that symbols K1₁, K1₂, K1₃, K1₄, K2₁, . . . , K7₁ and K7₂ each denote a vector consisting of four elements.

The following description explains the step S102 of carrying out a process to eliminate intermediate variables in the processing represented by the flowchart shown in FIG. 1. If the four elements of each of the vectors. K1₁, K1₂, K1₃, K1₄, K2₁, . . . , K7₁ and K7₂ are expressed by their actual values, the vectors K1₁, K1₂, K1₃, K1₄, K2₁, . . . , K7₁ and K7₂ can be expressed as follows:

[Formula 14]

$$\begin{matrix}{K1}_{1} = ( \begin{matrix}\begin{matrix}\begin{matrix}v11 + z21 \\ v12 + z22\end{matrix} \\ v13 + z23\end{matrix} \\ v14 + z24\end{matrix} ) \\ {K1}_{2} = ( \begin{matrix}\begin{matrix}\begin{matrix}h01 + h11 + h03 + v11 + z32 + z41 \\ h01 + h02 + h12 + h04 + v12 + z33 + z42\end{matrix} \\ h01 + h02 + h03 + h13 + v13 + z31 + z34 + z43\end{matrix} \\ h02 + h04 + h14 + v14 + z31 + z44\end{matrix} ) \\ {K1}_{3} = ( \begin{matrix}\begin{matrix}\begin{matrix}h02 + h04 + v11 + z31 \\ h01 + h03 + v12 + z32\end{matrix} \\ h02 + h03 + h04 + v13 + z32 + z41 + z33\end{matrix} \\ h01 + h02 + h03 + v14 + z31 + z34 + z44\end{matrix} ) \\ {K1}_{4} = ( \begin{matrix}\begin{matrix}\begin{matrix}h02 + h04 + v01 + z11 + z31 \\ h01 + h03 + v02 + z12 + z32\end{matrix} \\ h02 + h03 + h04 + v03 + z13 + z32 + z41 + z33\end{matrix} \\ h01 + h02 + h03 + v04 + z31 + z14 + z34 + z44\end{matrix} ) \\ {K2}_{1} = ( \begin{matrix}\begin{matrix}\begin{matrix}v01 + v21 + z11 \\ v02 + v22 + z12\end{matrix} \\ v03 + v23 + z13\end{matrix} \\ v04 + v24 + z14\end{matrix} ) \\ {K2}_{2} = ( \begin{matrix}\begin{matrix}\begin{matrix}h02 + h11 + h03 + h21 + h13 + v21 + z33 + z34 + z43 \\ h11 + h03 + h12 + h04 + h22 + h14 + v22 + z31 + z41 + \\ z33 + z42 + z34\end{matrix} \\ h11 + h12 + h04 + h13 + h23 + v23 + z32 + z42 + z34 + z43\end{matrix} \\ h01 + h02 + h12 + h14 + h 24 + v24 + z32 + z33 + z42 + z34\end{matrix} ) \\ {K2}_{3} = ( \begin{matrix}\begin{matrix}\begin{matrix}h01 + h12 + h14 + v21 + z31 + z33 + z42 + z44 \\ h02 + h11 + h13 + v22 + z31 + z32 + z41 + z34 + z43\end{matrix} \\ h02 + h12 + h13 + h14 + v23 + z31 + z32 + z41 + z42 + \\ z34 + z43 + z44\end{matrix} \\ h01 + h02 + h11 + h12 + h04 + h13 + v24 + z41 + z33 + \\ z42 + z43 + z44\end{matrix} ) \\ {K2}_{4} = ( \begin{matrix}\begin{matrix}\begin{matrix}h01 + h12 + h14 + v11 + z21 + z31 + z33 + z42 + z44 \\ h02 + h11 + h13 + v12 + z22 + z31 + z32 + z41 + z34 + z43\end{matrix} \\ h02 + h12 + h13 + h14 + v13 + z31 + z23 + z32 + z41 + \\ z42 + z34 + z43 + z44\end{matrix} \\ h01 + h02 + h11 + h12 + h04 + h13 + v14 + z41 + z24 + \\ z33 + z42 + z43 + z44\end{matrix} ) \\ {K3}_{1} = ( \begin{matrix}\begin{matrix}\begin{matrix}v11 + v31 + z21 \\ v12 + v32 + z22\end{matrix} \\ v13 + v33 + z23\end{matrix} \\ v14 + v34 + 24\end{matrix} ) \\ {K3}_{2} = ( \begin{matrix}\begin{matrix}\begin{matrix}h01 + h03 + h12 + h21 + h04 + h13 + h31 + h23 + v31 + \\ z41 + z42 + z34 + z43 \\ h01 + h21 + h13 + h22 + h14 + h32 + h24 + v32 + z31 + \\ z41 + z33 + z43\end{matrix} \\ h01 + h02 + h21 + h22 + h14 + h23 + h33 + v33 + z32 + \\ z41 + z33 + z34\end{matrix} \\ h02 + h11 + h03 + h12 + h22 + h24 + h34 + v34 + z41 + z33 + \\ z42 + z34 + z44\end{matrix} ) \\ {K3}_{3} = ( \begin{matrix}\begin{matrix}\begin{matrix}h01 + h02 + h11 + h03 + h04 + h22 + h24 + v31 + z31 + \\ z32 + z41 \\ h02 + h03 + h12 + h21 + h04 + h23 + v32 + z32 + z33 + z42\end{matrix} \\ h03 + h12 + h22 + h23 + h24 + v33 + z31 + z32 + z33 + z42\end{matrix} \\ h01 + h02 + h11 + h12 + h21 + h04 + h22 + h14 + h23 + \\ v34 + z41 + z33 + z42 + z44\end{matrix} ) \\ {K3}_{4} = ( \begin{matrix}\begin{matrix}\begin{matrix}h01 + h02 + h11 + h03 + h04 + h22 + h24 + v01 + v21 + \\ z11 + z31 + z32 + z41 \\ h02 + h03 + h12 + h21 + h04 + h23 + v02 + v22 + z12 + \\ z32 + z33 + z42\end{matrix} \\ h03 + h12 + h22 + h23 + h24 + v03 + v23 + z13 + z31 + \\ z32 + z33 + z42\end{matrix} \\ h01 + h02 + h11 + h12 + h21 + h04 + h22 + h14 + h23 + \\ v04 + v24 + z14 + z41 + z33 + z42 + z44 \end{matrix} ) \\ {k4}_{1} = ( \begin{matrix}\begin{matrix}\begin{matrix}v01 + v21 + v41 + z11 \\ v02 + v22 + v42 + z12\end{matrix} \\ v03 + v23 + v43 + z13\end{matrix} \\ v04 + v24 + v44 + z14\end{matrix} ) \\ {k4}_{2} = ( \begin{matrix}\begin{matrix}\begin{matrix}h01 + h11 + h03 + h13 + h22 + h31 + h14 + h23 + h41 + \\ h33 + v41 + z32 + z41 + z43 \\ h11 + h31 + h23 + h32 + h24 + h42 + h34 + v42 + z41\end{matrix} \\ h02 + h11 + h12 + h04 + h31 + h32 + h24 + h33 + h43 + \\ v43 + z31 + z42\end{matrix} \\ h02 + h12 + h21 + h13 + h22 + h32 + h34 + h44 + v44 + \\ z31 + z32 + z41 + z42 + z34 + z43\end{matrix} ) \\ {k4}_{3} = ( \begin{matrix}\begin{matrix}\begin{matrix}h01 + h02 + h11 + h03 + h12 + h21 + h13 + h14 + h32 + \\ h34 + v41 + z31 + z42 + z34 + z43 + z44 \\ h02 + h03 + h12 + h04 + h13 + h22 + h31 + h14 + h33 + \\ v42 + z32 + z33 + z42 + z43\end{matrix} \\ h01 + h02 + h03 + h04 + h13 + h22 + h32 + h33 + h34 + \\ v43 + z31 + z32 + z43 + z44\end{matrix} \\ h02 + h11 + h12 + h21 + h04 + h22 + h31 + h14 + h32 + \\ h24 + h33 + v44 + z31 + z42 + z44\end{matrix} ) \\ {k4}_{4} = ( \begin{matrix}\begin{matrix}\begin{matrix}h01 + h02 + h11 + h 03 + h 12 + h21 + h13 + h14 + h32 + \\ h34 + v11 + v31 + z21 + z31 + z42 + z34 + z43 + z44 \\ h02 + h03 + h12 + h04 + h13 + h22 + h31 + h14 + h33 + \\ v12 + v32 + z22 + z32 + z33 + z42 + z43\end{matrix} \\ h01 + h02 + h03 + h04 + h13 + h22 + h32 + h33 + h34 + \\ v13 + v33 + z31 + z23 + z32 + z43 + z44\end{matrix} \\ h02 + h11 + h12 + h21 + h04 + h22 + h31 + h14 + h32 + \\ h24 + h33 + v14 + v34 + z31 + z24 + z42 + z44\end{matrix} ) \\ {K5}_{1} = ( \begin{matrix}\begin{matrix}\begin{matrix}h01 + h11 + h03 + h13 + h22 + h31 + h14 + h23 + h41 + \\ h33 + v01 + v21 + v41 + v51 + z11 + z32 + z41 + z43 \\ h11 + h31 + h23 + h32 + h24 + h42 + h34 + v02 + v22 + \\ v42 + v52 + z12 + z41\end{matrix} \\ h02 + h11 + h12 + h04 + h31 + h32 + h24 + h33 + h43 + \\ v03 + v23 + v43 + v53 + z13 + z31 + z42\end{matrix} \\ h02 + h12 + h21 + h13 + h22 + h32 + h34 + h44 + v04 + \\ v24 + v44 + z31 + v54 + z14 + z32 + z41 + z42 + z34 + z43\end{matrix} ) \\ {K5}_{2} = ( \begin{matrix}\begin{matrix}\begin{matrix}h02 + h11 + h12 + h21 + h13 + h22 + h31 + h23 + h24 + \\ v51 + z31 + z32 + z42 + z34 + z43 \\ h01 + h02 + h03 + h12 + h04 + h13 + h22 + h14 + h23 + \\ h32 + h24 + v52 + z31 + z32 + z41 + z42 + z43\end{matrix} \\ h01 + h02 + h03 + h12 + h21 + h14 + h24 + h33 + v53 + \\ z31 + z41 + z42 + z34\end{matrix} \\ h01 + h03 + h21 + h04 + h14 + h23 + h24 + h34 + \\ v54 + z34\end{matrix} ) \\ {K5}_{3} = ( \begin{matrix}\begin{matrix}\begin{matrix}h11 + h12 + h21 + h04 + h22 + h14 + h33 + v51 + z32 + \\ z42 + z34 \\ h01 + h02 + h12 + h14 + h24 + h34 + v52 + z32 + z33 + \\ z42 + z34\end{matrix} \\ h02 + h11 + h03 + h21 + h13 + h31 + v53 + z33 + z34 + z43\end{matrix} \\ h11 + h03 + h21 + h13 + h32 + h24 + z31 + v54 + z32 + \\ z33 + z43 + z44\end{matrix} ) \\ {K5}_{4} = ( \begin{matrix}\begin{matrix}\begin{matrix}h11 + h12 + h21 + h04 + h22 + h14 + h33 + v11 + v31 + \\ z21 + z32 + z42 + z34 \\ h01 + h02 + h12 + h14 + h24 + h34 + v12 + v32 + z22 + z32 + \\ z33 + z42 + z34\end{matrix} \\ h02 + h11 + h03 + h21 + h13 + h31 + v13 + v33 + z23 + \\ z33 + z34 + z43\end{matrix} \\ h11 + h03 + h21 + h13 + h32 + h24 + v14 + v34 + z31 + \\ z32 + z24 + z33 + z43 + z44\end{matrix} ) \\ {K6}_{1} = ( \begin{matrix}\begin{matrix}\begin{matrix}h01 + h03 + h12 + h21 + h04 + h13 + h31 + h23 + v11 + \\ v31 + v61 + z21 + z41 + z42 + z34 + z43 \\ h01 + h21 + h13 + h22 + h14 + h32 + h24 + v12 + v32 + \\ v62 + z22 + z31 + z41 + z33 + z43\end{matrix} \\ h01 + h02 + h21 + h22 + h14 + h23 + h33 + v13 + v33 + \\ v63 + z23 + z32 + z41 + z33 + z34\end{matrix} \\ h02 + h11 + h03 + h12 + h22 + h24 + h34 + v14 + v34 + \\ z41 + v64 + z24 + z 33 + z42 + z34 + z44\end{matrix} ) \\ {K6}_{2} = ( \begin{matrix}\begin{matrix}\begin{matrix}h01 + h02 + h11 + h03 + h12 + h13 + h14 + v61 + z31 + \\ z42 + z34 + z43 + z44 \\ h02 + h03 + h12 + h04 + h13 + h22 + h14 + v62 + z32 + \\ z33 + z42 + z43\end{matrix} \\ h02 + h11 + h04 + h14 + h23 + z31 + v63 + z41 + z44\end{matrix} \\ h11 + h04 + h13 + h14 + h24 + h32 + z41 + v64 + \\ z34 + z43 + z44\end{matrix} ) \\ {K6}_{3} = ( \begin{matrix}\begin{matrix}\begin{matrix} h01 + h02 + h11 + h12 + h04 + h 23 + v61 + z41 + z33 + z42 \\ h02 + h04 + h14 + h24 + v62 + z31 + z44\end{matrix} \\ h01 + h11 + h03 + h21 + v63 + z32 + z41\end{matrix} \\ h01 + h11 + h03 + h22 + h14 + z32 + z41 + v64 + z44\end{matrix} ) \\ {K6}_{4} = ( \begin{matrix}\begin{matrix}\begin{matrix}h01 + h02 + h11 + h12 + h04 + h23 + v01 + v21 + v41 + \\ v51 + z11 + z41 + z33 + z42 \\ h02 + h04 + h14 + h24 + v02 + v22 + v42 + v52 + \\ z12 + z31 + z44\end{matrix} \\ h01 + h11 + h03 + h21 + v03 + v23 + v43 + v53 + \\ z13 + z32 + z41\end{matrix} \\ h01 + h11 + h03 + h22 + h14 + v04 + v24 + v44 + \\ v54 + z14 + z32 + z41 + z44\end{matrix} ) \\ {K7}_{1} = ( \begin{matrix}\begin{matrix}\begin{matrix}h02 + h11 + h03 + h21 + h13 + v01 + v21 + v41 + v51 + \\ z11 + v71 + z33 + z34 + z43 \\ h11 + h03 + h12 + h04 + h22 + h14 + v02 + v22 + v42 + \\ v52 + z12 + z31 + v72 + z41 + z33 + z42 + z34\end{matrix} \\ h11 + h12 + h04 + h13 + h23 + v03 + v23 + v43 + v53 + \\ z13 + z32 + v73 + z42 + z34 + z43\end{matrix} \\ h01 + h02 + h12 + h14 + h24 + v04 + v24 + v44 + v54 + \\ z14 + z32 + z33 + z42 + z44 + v74 + z34\end{matrix} ) \\ {K7}_{2} = ( \begin{matrix}\begin{matrix}\begin{matrix} h01 + h02 + h11 + h03 + h04 + v71 + z31 + z32 + z41 \\ h02 + h03 + h12 + h04 + v72 + z32 + z33 + z42\end{matrix} \\ h01 + h04 + h13 + z31 + z32 + z41 + v73 + z33 + z34 + z43\end{matrix} \\ h01 + h03 + h04 + h14 + v74 + z34\end{matrix} )\end{matrix}$$

Then, the next step S103 is executed to carry out a variable transposition process. With the results of the vectors K1₁, K1₂, K1₃, K1₄, K2₁, . . . , K7₁ and K7₂ used as a base, the simultaneous linear equation is transformed so as to result in equations, which each include only terms zxx and vxx on the right-hand side thereof as follows.

k1₁₁=v11+z21

k1₁₂=v12+z22

k1₁₃=v13+z23

k1₁₄=v14+z24

h01+h11+h03k1₂₁=v11z32+z41

h01+h02+h12+h04+k1₂₂=v12+z33+z42

h01+h02+h03+h13+k1₂₃=v13+z31+z34+z43

h02+h04+h14+k1₂₄=v14+z31+z44

h02+h04+k1₃₁=v11+z31

h01+h03+k1₃₂=v12+z32

h02+h03+h04+k1₃₃=v13+z32+z41+z33

h01+h02+h03+k1₃₄=v14+z31+z34+z44

h02+h04+k1₄₁=v01+z11+z31

h01+h03+k1₄₂=v02+z12+z32

h02+h03+h04+k1₄₃=v03+z13+z32+z41+z33

h02+h02+h03+k1₄₄=v04+z31+z14+z34+z44

k2₁₁=v01+v21+z11

k2₁₂=v02+v22+z12

k2₁₃=v03+v23+z13

k2₁₄=v04+v24+z14

h02+h11h03+h21+h13+k2₂₁=v21+v33+z34+z43

h11+h03+h12+h04+h22+h14+k2₂₂=v22+z31+z41+z33z42+z34

h11+h12+h04+h13+h23+k2₂₃=v23+z32+z42+z34+z43

h01+h02+h12+h14+h24+k2₂₄=v24+z32+z33+z42+z34

h01+h12+h14+k2₃₁=v21+z31+z33+z42+z44

h02+h11+h13+k2₃₂=v22+z31+z32+z41+z34+z43

h02+h12+h13+h14+k2₃₃=v23+z31+z32+z41+z42+z34+z43+z44

h01+h02+h11+h12+h04+h13+k2₃₄=v24+z41+z33+z42+z43+z44

h01+h12+h14+k2₄₁=v11+z21+z31+z33+z42+z44

h02+h11+h13+k2₄₂=v12+z22+z31+z32+z41+z34+z43

h02+h12+h13+h14+k2₄₃=v13+z31+z23+z32+z41+z42+z34+z42+z44

h01+h02+h11+h12+h04+h13+k2₄₄=v14+z41+z24+z33+z42+z43+z44

k3₁₁=v11+v31+z21

k3₁₂=v12+v32+z22

k3₁₃=v13+v33+z23

k3₁₄=v14+v34+z24

h01+h03+h12+h21+h04+h13+h31+h23+k3₂₁=v31+z41+z42+z34+z43

h01+h21+h13+h22+h14+h32+h24+k3₂₂=v32+z31+z41+z33+z43

h01+h02+h21+h22+h14+h23+h33+k3₂₃=v33+z32+z41+z33+z34

h02+h11+h03+h12+h22+h24+h34+k3₂₄=v34+z41+z33+z42+z34+z44

h01+h02+h11+h03+h04+h22+h24+k3₃₁=v31+z31+z32+z41

h02+h03+h12+h21+h04+h23+k3₃₂=v32+z32+z33+z42

h03+h12+h22+h23+h24+k3₃₃=v33+z31+z32+z33+z42

h01+h02+h11+h12+h21+h04+h22+h14+h23+k3₃₄=v34+z41+z33+z42+z44

h01+h02+h11+h03+h04+h22+h24+k3₄₁=v01+v21+z11+z31+z32+z41

h02+h03+h12+h21h04+h23+k3₄₂=v02+v22+z12+z32+z33+z42

h03+h12+h22+h23+h24+k3₄₃=v03+v23+z13+z31+z32+z33+z42

h01+h02+h11+h12+h21+h04+h22+h14+h23+k3₄₄=v04+v24+z14+z41z33+z42+z44

k4₁₁=v01+v21+v41+z11

k4₁₂=v02+v22+v42+z12

k4₁₃=v03+v23+v43+z13

k4₁₄=v04+v24+v44+z14

h01+h11+h03+h13+h22+h31+h14+h23+h41+h33+k4₂₁=v41+z32+z41+z43

h11+h31+h23+h32+h24+h42+h34+k4₂₂=v42+z41

h02+h11+h12+h04+h31+h32+h24+h33+h43+k4₂₃=v43+z31+z42

h02+h12+h21+h13+h22+h32+h34+h44+k4₂₄=v44+z31+z32+z41+z42+z34+z43

h01+h02+h11+h03+h12+h21+h13+h14+h32+h34+k4₃₁=v41+z31+z42+z34+z43+z44

h02+h03+h12+h04+h13+h22+h31+h14+h33+k4₃₂=v42+z32+z33+z42+z43

h01+h02+h03+h04+h13+h22+h32+h33+h34+k4₃₃=v43+z31+z32+z43+z44

h02+h11+h12+h21+h04+h22+h31+h14+h32+h24+h33+k4₃₂=v44+z31+z42+z44

h01+h02+h11+h03+h12+h21+h13+h14+h32+h34+k4₄₁=v11+v31+z21+z31+z42+z34+z43+z44

h02+h03+h12+h04+h13+h22+h31+h14+h33+k4₄₂=v12+v32+z22+z32+z33+z42+z43

h01+h02+h03+h04+h13+h22+h32+h33+h34+k4₄₃=v13+v33+z31+z23+z32+z43+z44

h02+h11+h12+h21+h04+h22+h31+h14+h32+h24+h33+k4₄₄=v14+v34+z31+z24+z42+z44

h01+h11+h03+h13+h22+h31+h14+h23+h41+h33+k5₁₁=v01+v21+v41+v51+z11+z32+z41+z43

h11+h31+h23+h32+h24+h42+h34+k5₁₂=v02+v22+v42+v52+z12+z41

h02+h11+h12+h04+h31+h32+h24+h33+h43+k5₁₃=v03+v23+v43+v53+z13+z31+z42

h02+h12+h21+h13+h22+h32+h34+h44+k5₁₄=v04+v24+v44+v54+z14+z32+z41+z42+z34+z43

h02+h11+h12+h21+h13+h22+h31+h23+h24+k5₂₁=v51+z31+z32+z42+z34+z43

h01+h02+h03+h12+h04+h13+h22+h14+h23+h32+h24+k5₂₂=v52+z31+z32+z42+z43

h01+h02+h03+h12+h21+h14+h24+h33+k5₂₃=v53+z31+z41+z42+z34

h01+h03+h21+h04+h14+h23+h24+h34+k5₂₄=v54+z34

h11+h12+h21+h04+h22+h14+h33+k5₃₁=v51+z32+z42+z34

h01+h02+h12+h14+h24+h34k5₃₂=v52+z32+z33+z42+z34

h02+h11+h03+h21+h13+h31k5₃₃=v53+z33+z34+z43

h11+h03+h21+h13+h32+h24+z31+k5₃₄=v54+z32+z33+z43+z44

h11+h12+h21+h04+h22+h14+h33k5₄₁=v11+v31+z21+z32+z42+z34

h01+h02+h12+h14+h24+h34+k5₄₂=v12+v32+z22+z32+z33+z42+z34

h02+h11+h03+h21+h13+h31+k5₄₃=v13+v33+z23+z33+z34+z43

h11+h03+h21+h13+h32+h24+k5₄₄=v14+v34+z31+z32+z24+z33+z43+z44

h01+h03+h12+h21+h04+h13h31+h23+k6₁₁=v11+v31+v61+z21+z41+z42+z34+z43

h01+h21+h13+h22+h14+h32h24+k6₁₂=v12+v12+v33+v62+z22+z31+z41+z33+z43

h01+h02+h21+h22+h14+h23h33+k6₁₃=v13+v13+v34+v63+z23+z32+z42+z33+z43

h02+h11+h03+h12+h22+h24h34+k6₁₃=v14+v14+v34+v64+z24+z33+z43+z33+z44

h01+h02+h11+h03+h12+h21h13+h14+k6₂₁=v61+z31+z42+z34+z43+z44

h02+h03+h12+h04+h13+h22+h14+k6₂₂=v62+z32+z33+z42+z43

h02+h11+h04+h14+h23+z31+k6₂₃=v63+z41+z44

h01+h04+h13+h14+h24+z32+z41+k6₂₄=v64+z34+z43+z44

h01+h02+h11+h12+h04+h23+k6₃₁=v61+z41+z33+z42

h02+h04+h14+h24+k6₃₂=v62+z31+z44

h01+h11+h03+h21+k6₃₃=v63+z32+z41

h01+h11+h03+h22+h14+z32+z41+k6₃₄=v64+z44

h01+h02+h11+h12+h04+h23+k6₄₁=v01+v21+v41+v51+z11+z41+z33+z42

h02+h04+h14+h24+k6₄₂=v02+v22+v42+v52+z12+z31+z44

h01+h11+h03+h21+k6₄₃=v03+v23+v43+v53+z13+z32+z41

h01+h11+h03+h22+h14k6₄₄=v04+v24+v44+v54+z14+z32+z41+z44

h02+h11+h03+h21+h13+k7₁₁=v01+v21+v41+v51+z11+z71+z33+z34+z43

h11+h03+h12+h04+h22+h14+k7₁₂=v02+v22+v42+v52+z12+z31+z41+z33+z42+z34

h11+h12+h04+h13+h23+k7₁₃=v03+v23+v43+v53+z13+z32+v73+z42+z34+z43

h01+h02+h12+h14+h24+k7₁₄=v04+v24+v44+v54+z14+z32+z33+z42+v74+z34

h01+h02+h11+h03+h04+k7₂₁=v71+z31+z32+z41

h02+h03+h12+h04+k7₂₂=v72+z32+z33+z42

h01+h04+h13+z31+z32+z41 +k7₂₃=v73+z33+z34+z43

h01+h03+h04+h14+k7₂₄=v74+z34 [formula 15]

Then, the next step S104 is executed to carry out a matricial-equation transformation process. In this process, vectors K, H, U and V are set as follows.

K=(k1₁₁, k1₁₂, . . . , k7₂₄)

H=(h01, h02, . . . , h44)

U=(z01, z02, . . . , z44)

V=(v01, v02, . . . , v74) [formula 16]

With the vectors K, H, U and V set as expressed by the above equations, the simultaneous linear equation can be transformed into the following matricial equation.

[Formula 17]

$${M}_{KH} ( \begin{matrix}{}^{t} K \\ {}^{t} H\end{matrix} ) = {M}_{UV} ( \begin{matrix}{}^{t} U \\ {}^{t} V\end{matrix} )$$

It is to be noted that, in the above equation, symbols M_{KH} and M_{UV} each denote a GF(2) matrix comprising coefficients of the simultaneous linear equation described above.

Then, the next step S105 is executed to carry out a unitary transformation process.

Let symbol Nᵣ denote the rank value of the matrix M_{UV} as follows:

rank(M_{UV})=Nᵣ [formula 18]

Then, let symbol Ndenote the number of rows composing the matrix M_{UV}. By multiplying both the left-hand and right-hand sides of the matricial equation by a row-deform unitary matrix Q from the left, the matrix M_{UV} can be deformed into a step matrix. In this process, a small matrix consisting of (Nₘ-Nᵣ) lowest rows of the matrix QM_{UV}, becomes a null matrix.

Then, the next step S106 is executed to carry out a small-matrix selection process. Let symbol M*KH denote a small matrix consisting of (Nₘ-Nᵣ) lowest rows of the matrix QM_{KH}. In this case, the small matrix M*_{KH} becomes a null matrix (O) as expressed by the following equation.

M*_{KH}=O [formula 19]

Then, the next step S107 is executed to carry out a linear-relation equation generation process. This matricial equation is transformed into linear-relation equations, which are each associated with a row. Then, actual values are substituted for h01, h02, . . . , and h44 to obtain the following relation equations:

0×c7=k1₁₁+k1₂₁+k1₂₂+k1₂₄+k1₃₁+k1₃₂+k1₃₄+k1₄₂+k1₄₄+k2₁₂+k2₁₄+k2₂₂+k2₂₄+k2₄₁

0×33=k1₁₂+k1₂₁+k1₂₂+k1₂₃+k1₃₁+k1₃₂+k1₃₃+k1₄₁+k1₄₃+k2₁₁+k2₁₃+k2₂₁+k2₂₃+k2₄₂

0×48=k1₁₃+k1₂₂+k1₂₄+k1₃₂+k1₃₄+k1₄₁+k1₄₂+k1₄₄+k2₁₁+k2₁₂+k2₁₄+k2₂₁+k2₂₂+k2₂₄+k2₄₃

0×ef=k1₁₄+k1₂₁+k1₂₂+k1₂₃+k1₂₄+k1₃₁+k1₃₂+k1₃₃+k1₃₄+k2₄₁+k2₄₃+k1₄₄+k2₁₁+k2₁₃+k2₁₄+k2₂₁+k2₂₃+k2₂₄+k2₄₄

0×c7=k1₂₁+k1₂₁+k1₃₁+k2₁₁+k3₄₁

0×33=k1₂₂+k1₃₂+k2₁₂+k3₄₂

0×00=k1₂₃+k1₃₃+k1₄₁+k2₁₂+k2₁₃+k2₂₁+k3₄₁+k3₄₂+k3₄₃

0×dA=k1₂₄+k1₃₄+k1₄₃+k2₁₁+k2₁₂+k2₁₃+k2₂₃+k2₂₃+k2₄₂+k4₁₁+k4₂₁

0×7=k1₄₁+k1₄₂+k2₂₁+k2₂₂+k3₄₂+k3₄₃+k4₁₁+k4₁₃+k4₂₁+k4₂₃

0×74=k1₄₂+k1₄₃+k2₁₁+k2₁₂+k2₂₂+k2₂₃+k3₄₂+k3₄₃+k4₁₁+k4₁₂+k4₂₁+k4₂₂

0×65=k1₄₃+k2₁₂+k2₁₄+k2₂₃+k3₄₂+k4₁₃+k4₁₄+k4₂₃+k4₂₄

0×33=k1₄₄+k2₁₁+k2₂₄+k3₄₁+k3₄₄

0×8α=k2₁₁+k2₁₂+k3₄₂+k3₄₄+k4₁₁+k4₁₄+k4₂₄+k4₃₁

0×f7=k2₁₂+k2₁₃+k3₄₁+k3₄₃+k4₁₁+k4₁₂+k4₂₁+k4₃₂

0×29=k2₁₃+k2₁₄+k3₄₁+k3₄₂+k3₄₄+k4₁₁+k4₁₂+k4₁₃+k4₂₁+k4₂₂+k4₃₃

0×α1=k2₁₄+k3₄₁+k3₄₄+k4₁₁+k4₂₂+k4₂₃+k4₂₄+k4₃₁+k4₃₂+k4₃₃+k4₃₄

0×41=k2₂₁+k2₃₁+k3₄₁+k3₄₃+k3₄₄+k4₁₁+k4₁₃+k4₁₄+k4₂₃+k4₃₁+k4₃₄

0×74=k2₂₂+k2₃₂+k3₄₁+k3₄₂+k3₄₃+k4₁₁+k4₁₂+k4₁₃+k4₂₃+k4₂₄+k4₃₁+k4₃₂+k4₃₄

0×f4=k2₂₃+k2₃₃+k3₄₁+k3₄₂+k3₄₃+k3₄₄+k4₁₁+k4₁₂+k4₁₃+k4₁₄+k4₂₄+k4₃₁+k4₃₂+k4₃₃

0×57=k2₂₄+k2₃₄+k4₂₄+k4₃₄

0×f6=k2₄₁+k3₁₁+k3₂₁+k3₄₁+k3₄₂+k3₄₃+k4₁₁+k4₁₂+k4₁₃+k4₂₁+k4₂₃+k4₂₄+k4₃₂+k4₃₄

0×7c=k2₄₂+k3₁₂+k3₂₂+k3₄₂+k4₁₂+k4₂₂+k4₂₃+k4₂₄+k4₃₃+k4₃₄

0×43=k2₄₃+k3₁₃+k3₂₃+k3₄₁+k3₄₂+k3₄₃+k4₁₁+k4₁₂+k4₂₁+k4₃₂k4₃₃

0×5f=k2₄₄+k3₁₄+k3₂₄+k3₄₃+k4₁₃+k4₂₂+k4₂₄+k4₃₂+k4₃₃+k4₃₄

0×7d=k3₁₁+k3₄₁+k3₄₂+k3₄₃+k3₄₄+k4₁₁+k12+4₁₃+k4₁₄+k4₂₁+k4₂₄k4₃₂+k4₃₃+k5₄₁

0×2d=k3₁₂+k3₄₁+k3₄₂+k4₁₁+k4₁₂+k4₂₂+k4₂₃+k4₃₁+k4₃₃+k4₄₂

0×02=k3₁₃+k3₄₄+k4₁₄+k4₂₁+k4₂₃+k4₃₁+k4₃₃+k4₃₄+k4₄₃

0×de=k3₁₄+k3₄₂+k3₄₃+k3₄₄+k4₁₂+k4₁₃+k4₁₄+k4₂₂+k4₃₃+k4₃₄+k5₄₄

0×8α=k3₂₁+k3₃₁+k3₄₂+k3₄₃+k3₄₄+k4₁₂+k4₁₃+k4₁₄+k4₂₄+k4₃₂+k4₃₃

0×7f=k3₂₂+k3₃₂+k3₄₁+k3₄₂+k3₄₃+k3₄₄+k4₁₁+k4₁₂+k4₁₃+k4₁₄+k4₂₃+k4₂₄+k4₃₁+k4₃₂

0×88=k3₂₃+k3₃₃+k3₄₁+k3₄₂+k4₁₁+k4₁₂+k4₂₁+k4₂₃+k4₂₄+k4₃₂+k4₃₃+k4₃₄

0×54=k3₂₄+k3₃₄+k3₄₂+k3₄₃+k4₁₂+k4₁₃+k4₂₂+k4₂₄+k4₃₃+k4₃₄

0×7f=k3₄₁+k3₄₂+k4₁₂+k4₂₁+k4₂₃+k4₂₄+k4₃₂+k4₃₃+k4₃₄+k5₁₁+k5₂₁

0×7f=k3₄₂+k4₁₁+k4₁₂+k4₁₃+k4₂₁+k4₂₄+k4₃₁+k4₃₂+k4₃₄+k5₁₁+k5₁₃+k5₂₁+k5₂₃

0×8α=k3₄₃+k3₄₄+k4₁₁+k4₁₃+k4₂₁+k4₃₁+k4₃₃+k4₃₄+k5₁₁+k5₁₄+k5₂₁+k5₂₄

0×00=k3₄₄+k4₁₂+k4₁₄+k4₂₂+k4₃₂+k4₃₄+k5₁₂+k5₂₂

0×f7=k4₁₁+k4₁₃+k4₂₃+k4₃₃+k4₄₁+k5₁₁+k5₁₃+k5₂₁+k5₂₃+k5₄₁

0×29=k4₁₂+k4₁₃+k4₁₄+k4₂₁+k4₂₃+k4₂₄+k4₃₁+k4₃₃+k4₃₄+k4₄₁+k4₄₂+k5₁₂+k5₁₃+k5₁₄+k5₂₂+k5₂₃+k5₂₄+k5₄₁+k5₄₂

0×2b =k4₁₃+k4₁₄+k4₂₂+k4₂₄+k4₃₂+k4₃₄+k4₄₂+k4₄₃+k5₁₃+k5₁₄+k5₂₃+k5₂₄+k5₄₂+k5₄₃

0×88=k4₁₄+k4₂₁+k4₂₃+k4₃₁+k4₃₃+k4₄₁+k4₄₃+k4₄₄+k5₁₄+k5₂₄+k5₄₁+k5₄₃+k5₄₄

0×43=k4₂₁+k4₃₁+k5₄₁+k6₁₁+k6₂₁

0×e0=k4₂₂+k4₂₄+k4₃₂+k4₃₄+k4₄₁+k4₄₂+k4₄₄+k5₄₄+k6₁₁+k6₁₂+k6₂₁+k6₃₂

0×eb=k4₂₃+k4₂₄+k4₃₃+k4₃₄+k4₄₁+k5₄₃+k6₁₁+k6₁₃+k6₂₁+k6₃₃

0×81=k4₂₄+k4₃₄+k4₄₂+k4₄₃+k5₄₃+k6₁₂+k6₂₂

0×7e=k4₄₁+k5₄₁+k5₄₃+k6₁₃+k6₂₃

0×dd=k4₄₂+k4₄₃+k4₄₄+k5₄₂+k5₄₃+k6₁₄+k6₂₄

0×00=k4₄₃+k4₄₄+k5₄₃+k6₁₄+k6₃₄

0×00=k4₄₄+k5₄₁+k5₄₄+k6₁₁+k6₃₁

0×f7=k5₅₁+k5₄₁+k6₁₁+k6₃₁+k6₄₁

0×14=k5₁₂+k5₄₁+k5₄₃+k5₄₄+k6₁₁+k6₁₃+k6₁₄+k6₂₁+k6₂₃+k6₃₄+k6₄₂

0×23=k5₁₃+k5₄₁+k5₄₂+k6₁₁+k6₁₂+k6₂₂+k6₂₄+k6₃₁+k6₃₄+k6₄₃

0×8α=k5₁₄+k5₄₄+k6₁₄+k6₃₄+k6₄₄

0×v4=k5₂₁+k5₃₁+k5₄₁+k6₄₂+k6₁₁+k6₁₂+k6₂₁+k6₃₂

0×0b=k5₂₂+k5₃₂+k5₄₂+k6₄₃+k6₁₂+k6₁₃+k6₂₂+k6₃₃

0×00=k5₂₃+k5₃₃+k5₄₁+k5₄₂+k5₄₄+k6₁₁+k6₁₂+k6₁₄+k6₃₁+k6₃₂+k6₃₄

0×00=k5₂₄+k5₃₄+k5₄₁+k5₄₃+k5₄₄+k6₁₁+k6₁₃+k6₁₄+k6₃₁+k6₃₃+k6₃₄

0×c7=k5₄₁+k5₄₂+k5₄₃+k5₄₄+k6₁₁+k6₁₂+k6₁₃+k6₁₄+k6₂₁+k6₂₃+k6₃₂+k6₃₄+k6₄₁+k7₁₁+k7₂₁

0×fc=k5₄₂+k6₁₂+k6₂₁+k6₃₁+k6₃₂+k6₄₃+k7₁₃+k7₂₃

0×18=k5₄₃+k5₄₄+k6₁₃+k6₁₄+k6₂₁+k6₂₂+k6₃₁+k6₃₂+k6₃₃+k6₃₄+k6₄₃+k6₄₄+k7₁₃+k7₁₄+k7₂₃+k7₂₄

0×f4=k6₂₁+k6₂₂+k6₂₃+k6₂₄+k6₃₁+k6₃₂+k6₃₃+k6₃₄+k6₄₁+k6₄₂+k7₁₁+k7₁₂+k7₂₁+k7₂₂ [formula 20]

Here, the following equation holds true.

rank(M*K)=Nₘ-Nᵣ [formula 21]

Thus, the above 60 linear-relation equations are linear-relation equations independent of each other. It is therefore obvious that (2⁶⁰-1) linear-relation equations obtained from linear concatenation of any of the 60 equations on the GF(2) hold true. If the number of such linear-relation equations is large, it is feared that a new attack that the designer of the encryption method is not aware of is brought about. For this reason, the total number of linear-relation equations obtained by adoption of the method described above can be used as an indicator for the evaluation of the encryption level.

[Second Embodiment of Encryption Level Indicator Calculation Process]

As a second embodiment of the encryption level indicator calculation process provided by the present invention, a typical process of applying an encryption level evaluation method provided by the present invention to ‘Hierocrypt-3’ is explained in detail. ‘Hierocrypt-3’ is the name of an AES-compatible block encryption process proposed by Toshiba. The ‘Hierocrypt-3’ block encryption process is a common-key block encryption process with a block length of 128 bits and a key length of 128, 192 or 256 bits. A typical encryption process explained below is a process with a key length of 256 bits.

First of all, the step S101 of the flowchart shown in FIG. 1 is explained. As described earlier, at this step, an encryption processing algorithm is set. This step is executed as a process to set the ‘Hierocrypt-3’ block encryption algorithm proposed by Toshiba.

First of all, a matrix P32 is defined as follows:

[Formula 22]

$$P32 = ( \begin{matrix}I4 & O4 & I4 & O4 \\ O4 & I4 & O4 & I4 \\ O4 & I4 & I4 & I4 \\ I4 & O4 & I4 & I4\end{matrix} )$$

Let symbol P32I denote the inverse matrix of the matrix P32. Next, matrices M51, M52, MB1 and MB2 are defined as follows:

[Formula 231

$$\begin{matrix}M51 = ( \begin{matrix}1 & 0 & 1 & 0 \\ 1 & 1 & 0 & 1 \\ 1 & 1 & 1 & 0 \\ 0 & 1 & 0 & 1\end{matrix} ) \\ M52 = ( \begin{matrix}1 & 1 & 1 & 1 \\ 0 & 1 & 1 & 1 \\ 0 & 0 & 1 & 1 \\ 1 & 1 & 1 & 0\end{matrix} ) \\ M B1 = ( \begin{matrix}0 & 1 & 0 & 1 \\ 1 & 0 & 1 & 0 \\ 1 & 1 & 0 & 1 \\ 1 & 0 & 1 & 1\end{matrix} ) \\ M B2 = ( \begin{matrix}1 & 1 & 0 & 0 \\ 0 & 1 & 1 & 0 \\ 1 & 0 & 1 & 1 \\ 1 & 0 & 0 & 1\end{matrix} )\end{matrix}$$

Then, matrices M51, M52, MB1 and MB2 are defined, being expressed in terms of the matrices M5 and MB as follows:

[Formula 24]

$$\begin{matrix}M5 = ( \begin{matrix}M51 & O4 & O4 & O4 \\ O4 & M52 & O4 & O4 \\ O4 & O4 & M51 & O4 \\ O4 & O4 & O4 & M52\end{matrix} ) \\ MB = ( \begin{matrix}MB1 & O4 & O4 & O4 \\ O4 & MB2 & O4 & O4 \\ O4 & O4 & MB1 & O4 \\ O4 & O4 & O4 & MB2\end{matrix} )\end{matrix}$$

Next, round dependent constant vectors Gi (where i=0, . . . 9) are defined as follows:

[Formula 25]

G0=(h11,h12,h13,h14,h01,h02,h03,h04,0,0,0,0,0,0,0,0)

G1=(h21,h22,h23,h24,h31,h32,h33,h34,0,0,0,0,0,0,0,0)

G2=(h31,h32,h33,h34,h01,h02,h03,h04,0,0,0,0,0,0,0,0)

G3=(h11,h12,h13,h14,h31,h32,h33,h34,0,0,0,0,0,0,0,0)

G4=(h21,h22,h23,h24,h11,h12,h13,h14,0,0,0,0,0,0,0,0)

G5=(h01,h02,h03,h04,h21,h22,h23,h24,0,0,0,0,0,0,0,0)

G6=(h01,h02,h03,h04,h21,h22,h23,h24,0,0,0,0,0,0,0,0)

G7=(h21,h22,h23,h24,h11,h12,h13,h14,0,0,0,0,0,0,0,0)

G8=(h11,h12,h13,h14,h31,h32,h33,h34,0,0,0,0,0,0,0,0)

G9=(h31,h32,h33,h34,h01,h02,h03,h04,0,0,0,0,0,0,0,0)

It is to be noted that a vector HH with constants in the above equations used as elements is the same as the vector HH of the first embodiment implementing the encryption level indicator calculation process as described earlier.

Next, a vector ZZ with its elements composing the right half of a sequence of initial values of the key-scheduling part is defined as follows.

ZZ=(z31, z32, z33, z34, z35, z36, z37, z38, z41, z42, z43; z44, z45, z46, z47, z48) [formula 26]

By using these, the right half of the key-scheduling part in the Hierocrypt-3 common-key encryption algorithm is expressed below. It is to be noted that the operator + used in the following expressions is an additive operator in the Galois field GF(2).

Z0M5*ZZ+G0

W0=P32*Z0

Z1=M5*W0+G1

W1=P32*Z1

Z2=M5*W1+G2

W2=P32*Z2

Z3=M5*W2+G3

W3=P32*Z3

Z4=M5*W3+G4

W4=P32*Z4

Z5=M5*W4+G5

W6=MB*(Z5+G6)

Z6=P32I*W6

W7=MB*(Z6+G7)

Z7=P32I*W7

W8=MB*(Z7+G8)

Z8=P32I*W8

W9=MB*(Z8+G9)

Z9=P32I*W9 [formula 27]

Symbols Z0, Z1, Z2, Z3, Z4, Z5, Z6, Z7, Z8, Z9, W0, W1, W2, W3, W5, W6, W7, W8 and W9 used in the above equations form the right half of the sequence of intermediate values of the key-scheduling part.

Next, these intermediate values are expressed by being split in accordance with the following equations.

Zn=Zn₃||ZN₄

Wn=Wn₁||WN₃ [formula 28]

Symbol || used in the above equations denotes a concatenation of vectors.

Next, let non-linear transformation part outputs of rounds be V0, V1, V2, V3, V4, V5, V6, V7, V8 and V9. Each of the outputs is a vector consisting of eight elements as follows.

V0=(v01, v02, v03, v04, v05, v06, v07, v08)

V1=(v11, v12, v13, v14, v15, v16, v17, v18)

V2=(v21, v22, v23, v24, v25, v26, v27, v28)

V3=(v31, v32, v33, v34, v35, v36, v37, v38)

V4=(v41, v42, v43, v44, v45, v46, v47, v48)

V5=(v51, v52, v53, v54, v55, v56, v57, v58)

V6=(v61, v62, v63, v64, v65, v66, v67, v68)

V7=(v71, v72, v73, v74, v75, v76, v77, V78)

V8=(v81, v82, v83, v84, v85, v86, v87, v88)

V9=(v91, v92, v93, v94, v95, v96, v97, v98) [formula 29]

Here, vectors Z₁ and Z₂ are set as follows.

Z₁=(z11, z12, z13, z14, z15, z16, z17, z18)

Z₂=(z21, z22, z23, z24, z25, z26, z27, z28) [formula 30]

With the vectors Z₁ and Z₂ set as described above, the left half of the sequence of the key-scheduling part in the Hierocrypt-3 common-key encryption algorithm is expressed as follows.

X0₁=Z₂

Z0₂=Z₁+V0

Z1₁=Z0₂

Z1=Z0₁+V1

Z2₁=Z1₁

Z2₂=Z1₃+V2

Z3₁=Z2₂

Z3₂=Z2₁+V3

Z4₁=Z3₂

Z4₂=Z3₁+V4

Z5₁=Z₄₂

Z5₂=Z4₂+V5

Z6₂=Z5₂+V6

Z6₂=Z5₂

Z7₁=Z6₂+V7

Z7₂=Z6₃

Z8₁=Z7₂+V8

Z8₂=Z7₁

Z9₁=Z8₂+V9

Z9₂=Z8₁ [formula 31]

Symbols Z0₁, Z0₂, Z1₁, Z1₂, Z2₁, Z2₂, Z3₁, Z3₂, Z4₁, Z4₂, Z5₁, Z5₂, Z6₁, Z6₂, Z7₁, Z7₂, Z8₁, Z8₂, Z9₁ and Z9₂ used in the above equations form the left half of the sequence of intermediate values of the key-scheduling part. By using the intermediate values obtained as described above, round keys K1₁, K1₂, K1₃, K1₄, K2₁, . . . , K9₁ and K9₂ are expressed as follows:

K1₁=Z0₂+V1

K1₂=Z1₃+V1

K1₃=Z1₄+V1

K1₄=Z0₃+Z1₄

K2₁=Z1₂+V2

K2₂=Z2₃+V2

K2₃=Z2₄+V2

K2₄=Z1₂+Z2₄

K3₁=Z2₁+V3

K3₂=Z3₃+V3

K3₃=Z3₄+V3

K3₄=Z2₂+Z3₄

K4₁=Z3₁+V4

K4₂=Z4₃+V4

K4₃=Z4₄+V4

K4₄=Z3₂+Z4₄

K5₁=Z4₁+V5

K5₂=Z5₃+V5

K5₃=Z5₄+V5

K5₄=Z4₂+Z5₄

K6₁=Z6₁+Z5₃

K6₂=W6₁+V6

K6₃=W6₂+V6

K6₄=Z5₁+W6₂

K7₁=Z7₁+Z6₃

K7₂=W7₁+V7

K7₃=W7₂+V7

K7₄=Z6₁+W7₂

K8₁=Z8₁+Z7₃

K8₃=W8₁+V8

K8₃=Z7₁+W8₂

K9₁=Z9₁+Z8₃

K9₂=W9₁+V9

K9₃=W9₂+V9

K9₄=Z8₁+W9₃ [formula 32]

It is to be noted that symbols K11, K12, K13, K14, K21, . . , K91 and K92 each denote a vector consisting of eight elements.

The following description explains the step S102 of carrying out a process to eliminate intermediate variables in the processing represented by the flowchart shown in FIG. 1. If the eight elements of each of the vectors K11, K12, K13, K14, K21, . . . , K91 and K92 are expressed by their actual values, the vectors K11, K12, K13, K14, K21, . . . , K91 and K92 can be expressed as follows:

[Formula 33]

$$\begin{matrix}{K1}_{1} = ( \begin{matrix}\begin{matrix}\begin{matrix}\begin{matrix}\begin{matrix}\begin{matrix}\begin{matrix}v11 + z21 \\ v12 + z22\end{matrix} \\ v13 + z23\end{matrix} \\ v14 + z24\end{matrix} \\ v15 + z25\end{matrix} \\ v16 + z26\end{matrix} \\ v17 + z27\end{matrix} \\ v18 + z28\end{matrix} ) \\ {K1}_{2} = ( \begin{matrix}\begin{matrix}\begin{matrix}\begin{matrix}\begin{matrix}\begin{matrix}\begin{matrix}h11 + h21 + h13 + v11 + z32 + z42 \\ h11 + h12 + h22 + h14 + v12 + z33 + z43\end{matrix} \\ h11 + h12 + h13 + h23 + v13 + z31 + z41 + z34 + z44\end{matrix} \\ h12 + h14 + h24 + v14 + z31 + z41\end{matrix} \\ h01 + h02 + h03 + h04 + h31 + v15 + z36 + z46 + z38 + z48\end{matrix} \\ h02 + h03 + h04 + h32 + v16 + z35 + z45 + z37 + z47\end{matrix} \\ h03 + h04 + h33 + v17 + z35 + z36 + z45 + z46 + z38 + z48\end{matrix} \\ h01 + h02 + h03 + h34 + v18 + z35 + z45 + z37 + z38 + \\ z47 + z48\end{matrix} ) \\ {K1}_{3} = ( \begin{matrix}\begin{matrix}\begin{matrix}\begin{matrix}\begin{matrix}\begin{matrix}\begin{matrix}h01 + h03 + v11 + z42 + z35 + z36 + z45 + z46 \\ h01 + h02 + h04 + v12 + z43 + z36 + z37 + z46 + z47\end{matrix} \\ h01 + h02 + h03 + v13 + z41 + z35 + z44 + z45 + z37 + z38 + \\ z47 + z48\end{matrix} \\ h02 + h04 + v14 + z41 + z35 + z45 + z38 + z48\end{matrix} \\ h11 + h12 + h13 + h14 + v15 + z31 + z32 + z41 + z42 + z46 + \\ z48\end{matrix} \\ h12 + h13 + h14 + v16 + z32 + z33 + z42 + z43 + z45 + z47\end{matrix} \\ h13 + h14 + v17 + z31 + z41 + z33 + z34 + z43 + z44 + z45 + \\ z46 + z48\end{matrix} \\ h11 + h12 + h13 + z31 + v18 + z41 + z34 + z44 + z45 + \\ z47 + z48\end{matrix} ) \\ {K1}_{4} = ( \begin{matrix}\begin{matrix}\begin{matrix}\begin{matrix}\begin{matrix}\begin{matrix}\begin{matrix}h01 + h 03 + v01 + z11 + z42 + z35 + z36 + z45 + z46 \\ h01 + h02 + h04 + v02 + z12 + z43 + z36 + z37 + z46 + z47\end{matrix} \\ h01 + h02 + h03 + v03 + z13 + z41 + z35 + z44 + z45 + z37 + \\ z38 + z47 + z48\end{matrix} \\ h02 + h04 + v04 + z14 + z41 + z35 + z45 + z38 + z48\end{matrix} \\ h11 + h12 + h1 \; 3 + h14 + v05 + z31 + z32 + z41 + z15 + \\ z42 + z46 + z48\end{matrix} \\ h12 + h13 + h14 + v06 + z32 + z33 + z42 + z16 + z43 + \\ z45 + z47\end{matrix} \\ h13 + h14 + v07 + z31 + z41 + z33 + z34 + z43 + z17 + z44 + \\ z45 + z46 + z48\end{matrix} \\ h11 + h12 + h13 + v08 + z31 + z41 + z34 + z44 + z18 + \\ z45 + z47 + z48\end{matrix} ) \\ {K2}_{1} = ( \begin{matrix}\begin{matrix}\begin{matrix}\begin{matrix}\begin{matrix}\begin{matrix}\begin{matrix}v01 + v21 + z21 \\ v02 + v22 + z22\end{matrix} \\ v03 + v23 + z23\end{matrix} \\ v04 + v24 + z24\end{matrix} \\ v05 + v25 + z25\end{matrix} \\ v06 + v26 + z26\end{matrix} \\ v07 + v27 + z27\end{matrix} \\ v08 + v28 + z28\end{matrix} ) \\ {K2}_{2} = ( \begin{matrix}\begin{matrix}\begin{matrix}\begin{matrix}\begin{matrix}\begin{matrix}\begin{matrix}h02 + h12 + h21 + h31 + h 23 + τ 21 + z31 + z32 + z34 + \\ z36 + z37 + z45 + z38 + z47 + z48 \\ h 08 + h21 + h13 + h22 + h32 + h24 + v22 + z31 + z32 + \\ z33 + z37 + z38 + z47 + z48\end{matrix} \\ h01 + h11 + h21 + h04 + h22 + h23 + h33 + v23 + z31 + \\ z32 + z33 + z34 + z38 + z48\end{matrix} \\ h01 + h11 + h22 + h24 + h34 + v24 + z31 + z33 + z35 + \\ z36 + z45 + z37 + z46 + z38 + z47 + z48\end{matrix} \\ h01 + h02 + h12 + h04 + h31 + h14 + h32 + h33 + h34 + \\ v25 + z31 + z41 + z35 + z38\end{matrix} \\ h01 + h02 + h11 + h03 + h13 + h32 + h33 + h34 + v26 + \\ z32 + z42 + z35 + z36\end{matrix} \\ h01 + h02 + h11 + h03 + h12 + h04 + h14 + h33 + h34 + \\ v27 + z33 + z43 + z36 + z37\end{matrix} \\ h01 + h11 + h03 + h13 + h31 + h14 + h32 + h33 + v28 + \\ z34 + z44 + z37\end{matrix} ) \\ {K2}_{3} = ( \begin{matrix}\begin{matrix}\begin{matrix}\begin{matrix}\begin{matrix}\begin{matrix}\begin{matrix}h01 + h11 + h12 + h31 + h33 + v21 + z32 + z41 + z33 + \\ z34 + z43 + z35 + z36 + z37 + z46 + z38 + z47 + z48 \\ h02 + h12 + h13 + h31 + h32 + h34 + v22 + z41 + z33 + \\ z42 + z34 + z44 + z36 + z37 + z38 + z47 + z48\end{matrix} \\ h11 + h03 + h13 + h31 + h14 + h32 + h33 + v23 + z41 + \\ z42 + z34 + z43 + z37 + z38 + z48\end{matrix} \\ h11 + h04 + h14 + h32 + h34 + v24 + z31 + z32 + z33 + \\ z42 + z34 + z35 + z44 + z36 + z45 + z37 + z46 + z47 + z48\end{matrix} \\ h01 + h02 + h11 + h21 + h22 + h14 + h23 + h24 + \\ v25 + z31 + z32 + z41 + z33 + z34 + z35 + z48\end{matrix} \\ h02 + h11 + h03 + h12 + h22 + h23 + h24 + v26 + z32 + \\ z33 + z42 + z34 + z36 + z45\end{matrix} \\ h01 + h03 + h12 + h04 + h13 + h23 + h24 + v27 + \\ z33 + z34 + z43 + z37 + z46\end{matrix} \\ h01 + h21 + h04 + h13 + h22 + h23 + z31 + z32 + \\ v28 + z33 + z44 + z38 + z47 + z48\end{matrix} ) \\ {K2}_{4} = ( \begin{matrix}\begin{matrix}\begin{matrix}\begin{matrix}\begin{matrix}\begin{matrix}\begin{matrix}h01 + h11 + h12 + h31 + h33 + v11 + z21 + z32 + z41 + \\ z33 + z34 + z43 + z35 + z36 + z37 + z46 + z38 + z47 + z48 \\ h02 + h12 + h13 + h31 + h32 + h34 + v12 + z22 + z41 + \\ z33 + z42 + z34 + z44 + z36 + z37 + z38 + z47 + z48\end{matrix} \\ h11 + h03 + h13 + h31 + h14 + h32 + h33 + v13 + z23 + \\ z41 + z42 + z34 + z43 + z37 + z38 + z48\end{matrix} \\ h11 + h04 + h14 + h32 + h34 + v14 + z31 + z32 + z24 + z34 + \\ z35 + z44 + z36 + z45 + z37 + z46 + z47 + z48\end{matrix} \\ h01 + h02 + h11 + h21 + h22 + h14 + h23 + h24 + v25 + \\ z31 + z32 + z41 + z33 + z34 + z35 + z48\end{matrix} \\ h02 + h11 + h03 + h12 + h22 + h23 + h24 + v16 + z32 + \\ z33 + z42 + z34 + z26 + z36 + z45\end{matrix} \\ h01 + h03 + h12 + h04 + h13 + h23 + h24 + v17 + z33 + \\ z34 + z43 + z37 + z46\end{matrix} \\ h01 + h21 + h04 + h13 + h22 + h23 + z31 + v18 + z32 \\ z33 + z44 + z28 + z38 + z47 + z48\end{matrix} ) \\ {K3}_{1} = ( \begin{matrix}\begin{matrix}\begin{matrix}\begin{matrix}\begin{matrix}\begin{matrix}\begin{matrix}v11 + v31 + z21 \\ v12 + v32 + z22\end{matrix} \\ v13 + v33 + z23\end{matrix} \\ v14 + v34 + z24\end{matrix} \\ v15 + v35 + z25\end{matrix} \\ v16 + v36 + z26\end{matrix} \\ v17 + v37 + z27\end{matrix} \\ v18 + v38 + z28\end{matrix} ) \\ {K3}_{2} = ( \begin{matrix}\begin{matrix}\begin{matrix}\begin{matrix}\begin{matrix}\begin{matrix}\begin{matrix}h02 + h03 + h04 + h13 + h22 + h31 + h32 + h33 + v31 + \\ z32 + z42 + z35 + z37 \\ h11 + h03 + h04 + h31 + h14 + h23 + h32 + h33 + h34 + \\ v32 + z33 + z43 + z35 + z36 + z38\end{matrix} \\ h11 + h12 + h21 + h04 + h32 + h24 + h33 + h34 + v33 + \\ z31 + z41 + z34 + z35 + z44 + z36 + z37\end{matrix} \\ h01 + h02 + h03 + h12 + h21 + h04 + h31 + h32 + h34 + \\ v34 + z31 + z41 + z36 + z38\end{matrix} \\ h01 + h02 + h11 + h03 + h22 + h31 + h32 + h24 + h34 + \\ v35 + z31 + z33 + z35 + z36 + z45 + z37 + z46 + z47\end{matrix} \\ h01 + h02 + h03 + h12 + h21 + h04 + h31 + h23 + h32 + \\ h33 + z31 + v36 + z32 + z34 + z35 + z36 + z45 + z37 + \\ z46 + z38 + z47 + z48\end{matrix} \\ h02 + h03 + h21 + h04 + h13 + h22 + h31 + h32 + h24 + h33 + \\ h34 + z31 + z32 + v37 + z33 + z38 + z37 + z46 + z38 + z47 + z48\end{matrix} \\ h01 + h02 + h21 + h04 + h31 + h14 + h23 + h24 + h33 + z32 + \\ v38 + z34 + z35 + z36 + z45 + z46 + z38 + z48\end{matrix} ) \\ {K3}_{3} = ( \begin{matrix}\begin{matrix}\begin{matrix}\begin{matrix}\begin{matrix}\begin{matrix}\begin{matrix}h01 + h02 + h03 + h21 + h04 + h22 + h31 + v31 + z42 + z35 + \\ z38 + z47 + z48 \\ h02 + h03 + h04 + h22 + h23 + h32 + τ 32 + z43 + z35 + \\ z36 + z48\end{matrix} \\ h03 + h21 + h04 + h23 + h24 + h33 + τ 33 + z41 + z44 + \\ z36 + z45 + z37\end{matrix} \\ h01 + h02 + h03 + h21 + h24 + h34 + v34 + z41 + z37 + \\ z46 + z47 + z48\end{matrix} \\ h11 + h12 + h21 + h13 + h24 + h33 + h34 + v35 + z31 + \\ z34 + z43 + z44 + z45 + z46 + z47\end{matrix} \\ h11 + h12 + h21 + h13 + h22 + h14 + h34 + z31 + v36 + \\ z32 + z44 + z45 + z46 + z47 + z48\end{matrix} \\ h12 + h13 + h22 + h31 + h14 + h23 + z32 + z41 + v37 + \\ z33 + z46 + z47 + z48\end{matrix} \\ h11 + h12 + h14 + h23 + h32 + h33 + h34 + z33 + z42 + \\ v38 + z43 + z44 + z45 + z46 + z48\end{matrix} ) \\ {K3}_{4} = ( \begin{matrix}\begin{matrix}\begin{matrix}\begin{matrix}\begin{matrix}\begin{matrix}\begin{matrix}h01 + h02 + h03 + h21 + h04 + h22 + h31 + v01 + v21 + \\ z11 + z42 + z35 + z38 + z47 + z48 \\ h02 + h03 + h04 + h22 + h23 + h32 + v02 + v22 + z12 + \\ z43 + z35 + z36 + z48\end{matrix} \\ h03 + h21 + h04 + h23 + h24 + h33 + v03 + v23 + z13 + \\ z41 + z44 + z36 + z45 + z37\end{matrix} \\ h01 + h02 + h03 + h21 + h24 + h34 + v04 + v24 + z14 + \\ z41 + z37 + z46 + z47 + z48\end{matrix} \\ h11 + h12 + h21 + h13 + h24 + h33 + h34 + v05 + v25 + \\ z31 + z15 + z34 + z43 + z44 + z45 + z46 + z47\end{matrix} \\ h11 + h12 + h21 + h13 + h22 + h14 + h34 + v06 + v26 + \\ z31 + z32 + z16 + z44 + z45 + z46 + z47 + z48\end{matrix} \\ h12 + h13 + h22 + h31 + h14 + h23 + v07 + v27 + z32 + \\ z41 + z33 + z17 + z46 + z47 + z48\end{matrix} \\ h11 + h12 + h14 + h23 + h32 + h33 + h34 + v08 + v28 + \\ z33 + z42 + z43 + z44 + z18 + z45 + z46 + z48\end{matrix} ) \\ {K4}_{1} = ( \begin{matrix}\begin{matrix}\begin{matrix}\begin{matrix}\begin{matrix}\begin{matrix}\begin{matrix}v01 + v21 + v41 + z11 \\ v02 + v22 + v42 + z12\end{matrix} \\ v03 + v23 + v43 + z13\end{matrix} \\ v04 + v24 + v44 + z14\end{matrix} \\ v05 + v25 + v45 + z15\end{matrix} \\ v06 + v26 + v46 + z16\end{matrix} \\ v07 + v27 + v47 + z17\end{matrix} \\ v08 + v28 + v48 + z18\end{matrix} ) \\ {K4}_{2} = ( \begin{matrix}\begin{matrix}\begin{matrix}\begin{matrix}\begin{matrix}\begin{matrix}\begin{matrix}h01 + h11 + h03 + h12 + h13 + h23 + h33 + h34 + v41 + \\ z31 + z32 + z34 + z35 + z45 + z37 + z38 + z47 + z48 \\ h01 + h02 + h11 + h12 + h21 + h04 + h13 + h14 + h24 + \\ h34 + v42 + z31 + z32 + z33 + z36 + z46 + z38 + z48\end{matrix} \\ h01 + h02 + h03 + h12 + h21 + h13 + h22 + h31 + h14 + \\ v43 + z31 + z32 + z33 + z34 + z35 + z45 + z37 + z47\end{matrix} \\ h02 + h11 + h12 + h04 + h22 + h14 + h32 + h33 + h34 + \\ v44 + z31 + z33 + z36 + z37 + z46 + z47\end{matrix} \\ h01 + h11 + h03 + h12 + h23 + h04 + h31 + h33 + h34 + \\ z31 + v45 + z32 + z41 + z42 + z34 + z35 + z44 + z37 + z38\end{matrix} \\ h02 + h12 + h04 + h13 + h22 + h32 + h34 + z31 + z32 + z41 + \\ v46 + z33 + z42 + z43 + z36 + z38\end{matrix} \\ h01 + h11 + h03 + h13 + h31 + h14 + h23 + h33 + z31 + \\ z32 + z41 + z33 + z42 + v47 + z34 + z43 + z35 + z44 + z37\end{matrix} \\ h02 + h11 + h03 + h14 + h32 + h24 + h33 + z31 + z41 + \\ z33 + z43 + v48 + z36 + z37\end{matrix} ) \\ {K4}_{3} = ( \begin{matrix}\begin{matrix}\begin{matrix}\begin{matrix}\begin{matrix}\begin{matrix}h02 + h04 + h13 + h14 + h33 + h34 + v41 + z31 + z33 + \\ z42 + z34 + z43 + z36 + z45 + z37 + z47 + z48 \\ h01 + h03 + h14 + h34 + v42 + z32 + z41 + z34 + z43 + \\ z35 + z44 + z37 + z46 + z38 + z48\end{matrix} \\ h01 + h02 + h11 + h04 + h31 + v43 + z31 + z33 + z42 + \\ z44 + z36 + z45 + z38 + z47\end{matrix} \\ h01 + h03 + h12 + h04 + h13 + h14 + h32 + h33 + h34 + \\ v44 + z32 + z41 + z33 + z42 + z35 + z36 + z46 + z47\end{matrix} \\ h01 + h02 + h11 + h03 + h21 + h04 + h22 + h31 + h23 + \\ h34 + v45 + z32 + z41 + z33 + z42 + z35 + z44 + \\ z36 + z46 + z38 + z47\end{matrix} \\ h02 + h03 + h12 + h21 + h04 + h22 + h31 + h23 + \\ h32 + h24 + z31 + z41 + v46 + z33 + z42 + z34 + z43 + \\ z35 + z36 + z45 + z37 + z47 + z48\end{matrix} \\ h03 + h04 + h13 + h22 + h23 + h32 + h24 + h33 + z32 + \\ z41 + z42 + v47 + z34 + z43 + z35 + z44 + z36 + z37 + \\ z46 + z38 + z48 \\ h01 + h02 + h03 + h21 + h22 + h14 + h24 + h33 + z31 + \\ z32 + z41 + z43 + v48 + z35 + z45 + z37 + z46\end{matrix} ) \\ {K4}_{4} = ( \begin{matrix}\begin{matrix}\begin{matrix}\begin{matrix}\begin{matrix}\begin{matrix}h02 + h04 + h13 + h14 + h33 + h34 + v11 + v31 + z21 + \\ z31 + z33 + z42 + z34 + z43 + z36 + z45 + z37 + z47 + z48 \\ h01 + h03 + h14 + h34 + v12 + v32 + z22 + z32 + z41 + \\ z34 + z43 + z35 + z44 + z37 + z46 + z38 + z48\end{matrix} \\ h01 + h02 + h11 + h04 + h31 + v13 + v33 + z31 + z23 + \\ z33 + z42 + z44 + z36 + z45 + z38 + z47\end{matrix} \\ h01 + h03 + h12 + h04 + h13 + h14 + h32 + h33 + h34 + \\ v14 + v34 + z32 + z41 + z24 + z33 + z42 + z35 + z36 + \\ z46 + z47\end{matrix} \\ h01 + h02 + h11 + h03 + h21 + h04 + h22 + h31 + h23 + \\ h34 + v15 + v35 + z32 + z41 + z33 + z42 + z25 + z35 + \\ z44 + z36 + z46 + z38 + z47\end{matrix} \\ h02 + h03 + h12 + h21 + h04 + h22 + h31 + h23 + h32 + \\ h24 + v16 + z31 + v36 + z41 + z33 + z42 + z34 + z43 + \\ z26 + z35 + z36 + z45 + z37 + z47 + z48\end{matrix} \\ h03 + h04 + h13 + h22 + h23 + h32 + h24 + h33 + v17 + \\ z32 + z41 + v37 + z42 + z34 + z43 + z35 + z44 + z27 + \\ z36 + z37 + z46 + z38 + z48 \\ h01 + h02 + h03 + h21 + h22 + h14 + h24 + h33 + \\ z31 + v18 + z32 + z41 + τ 38 + z43 + z35 + z45 + \\ z28 + z37 + z46\end{matrix} ) \\ {K5}_{1} = ( \begin{matrix}\begin{matrix}\begin{matrix}\begin{matrix}\begin{matrix}\begin{matrix}\begin{matrix}v11 + v31 + v51 + z21 \\ v12 + v32 + v52 + z22\end{matrix} \\ v13 + v33 + v53 + z23\end{matrix} \\ v14 + v34 + v54 + z24\end{matrix} \\ v15 + v35 + v55 + z25\end{matrix} \\ v16 + v36 + υ56 + z26\end{matrix} \\ v17 + v37 + v57 + z27\end{matrix} \\ v18 + v38 + v58 + z28\end{matrix} ) \\ {K5}_{2} = ( \begin{matrix}\begin{matrix}\begin{matrix}\begin{matrix}\begin{matrix}\begin{matrix}\begin{matrix}h02 + h21 + h13 + h22 + h23 + v51 + z33 + z34 + \\ z43 + z44 + z37 \\ h11 + h03 + h21 + h22 + h14 + h23 + h24 + v52 + \\ z34 + z35 + z44 + z38\end{matrix} \\ h01 + h11 + h12 + h04 + h22 + h23 + h24 + v53 + \\ z31 + z41 + z35 + z36\end{matrix} \\ h01 + h12 + h21 + h22 + h24 + v54 + z32 + z33 + \\ z42 + z34 + z43 + z44 + z36\end{matrix} \\ h02 + h03 + h12 + h21 + h04 + h13 + h22 + h14 + \\ h33 + h34 + v55 + z33 + z36 + z46\end{matrix} \\ h03 + h04 + h13 + h22 + h14 + h23 + h34 + z31 + \\ v56 + z34 + z37 + z47\end{matrix} \\ h21 + h04 + h31 + h14 + h23 + h24 + z31 + z32 + \\ υ57 + z35 + z45 + z38 + z48\end{matrix} \\ h01 + h02 + h11 + h03 + h12 + h21 + h04 + h13 + \\ h14 + h32 + h24 + h33 + h34 + z32 + z35 + v58 + z45\end{matrix} ) \\ {K5}_{3} = ( \begin{matrix}\begin{matrix}\begin{matrix}\begin{matrix}\begin{matrix}\begin{matrix}\begin{matrix}h02 + h12 + h04 + h13 + h23 + h32 + h24 + h34 + \\ v51 + z43 + z44 + z47 \\ h01 + h11 + h03 + h13 + h31 + h14 + h24 + h33 + \\ v52 + z44 + z45 + z48\end{matrix} \\ h01 + h02 + h12 + h21 + h04 + h31 + h14 + h32 + \\ h34 + v53 + z41 + z45 + z46\end{matrix} \\ h01 + h11 + h03 + h12 + h04 + h22 + h31 + h23 + \\ h24 + h33 + h34 + v54 + z42 + z43 + z44 + z46\end{matrix} \\ h11 + h21 + h14 + h34 + v55 + z43 + z46\end{matrix} \\ h11 + h12 + h22 + h31 + z41 + v56 + z44 + z47\end{matrix} \\ h12 + h13 + h23 + h32 + z41 + z42 + v57 + z45 + z48\end{matrix} \\ h13 + h24 + h33 + h34 + z42 + v58 + z45\end{matrix} ) \\ {K5}_{4} = ( \begin{matrix}\begin{matrix}\begin{matrix}\begin{matrix}\begin{matrix}\begin{matrix}\begin{matrix}h02 + h12 + h04 + h13 + h23 + h32 + h24 + h34 + \\ v 01 + v 21 + v 41 + z11 + z43 + z44 + z47 \\ h01 + h11 + h03 + h13 + h31 + h14 + h24 + h33 + \\ v02 + v22 + v42 + z12 + z44 + z45 + z48\end{matrix} \\ h01 + h02 + h12 + h21 + h04 + h31 + h14 + h32 + \\ h34 + v03 + v23 + v43 + z13 + z41 + z45 + z46\end{matrix} \\ h01 + h11 + h03 + h12 + h04 + h22 + h31 + h23 + h24 + \\ h33 + h34 + v04 + v24 + v44 + z14 + z42 + z43 + z44 + z46\end{matrix} \\ h11 + h21 + h14 + h34 + v05 + v25 + v45 + z15 + v43 + z46 \\ h11 + h12 + h22 + h31 + v06 + v26 + z41 + v46 + z16 +\end{matrix} \\ z44 + z47\end{matrix} \\ h12 + h13 + h23 + h32 + v07 + v27 + z41 + z42 + v47 +\end{matrix} \\ z17 + z45 + z48 \\ h13 + h24 + h33 + h34 + v08 + v28 + z42 + v48 + z18 + z45\end{matrix} ) \\ {K6}_{1} = ( \begin{matrix}\begin{matrix}\begin{matrix}\begin{matrix}\begin{matrix}\begin{matrix}\begin{matrix}h02 + h21 + h13 + h22 + h23 + v11 + v31 + v51 + v61 + z21 + \\ z33 + z34 + z43 + z44 + z37 \\ h11 + h03 + h21 + h22 + h14 + h23 + h24 + v12 + v32 + v52 + \\ v62 + z22 + z34 + z35 + z44 + z38\end{matrix} \\ h01 + h11 + h12 + h04 + h22 + h23 + h24 + v13 + v33 + v53 + \\ z31 + v63 + z23 + z41 + z35 + z36\end{matrix} \\ h01 + h12 + h21 + h22 + h24 + v14 + v34 + v54 + z32 + v64 + \\ z24 + z33 + z42 + z34 + z43 + z44 + z36\end{matrix} \\ h02 + h03 + h12 + h21 + h04 + h13 + h22 + h14 + h33 + h34 + \\ v15 + v35 + v55 + z33 + v65 + z25 + z36 + z46\end{matrix} \\ h03 + h04 + h13 + h22 + h14 + h23 + h34 + v16 + z31 + v36 + \\ v56 + z34 + v66 + z26 + z37 + z47\end{matrix} \\ h21 + h04 + h31 + h14 + h23 + h24 + v17 + z31 + z32 + v37 + \\ v57 + z35 + v67 + z27 + z45 + z38 + z48\end{matrix} \\ h01 + h02 + h11 + h03 + h12 + h04 + h13 + h14 + h32 + h24 + \\ h33 + h34 + v18 + z32 + v38 + z35 + v58 + z45 + v68 + z28\end{matrix} ) \\ {K6}_{2} = ( \begin{matrix}\begin{matrix}\begin{matrix}\begin{matrix}\begin{matrix}\begin{matrix}\begin{matrix}h01 + h02 + h11 + h03 + h12 + h04 + h14 + h23 + v61 + z32 + \\ z33 + z42 + z43 + z35 + z36 + z38 \\ h02 + h11 + h03 + h12 + h21 + h04 + h13 + h24 + v62 + z31 + \\ z41 + z33 + z34 + z43 + z35 + z44 + z36 + z37\end{matrix} \\ h11 + h03 + h12 + h04 + h13 + h22 + h14 + v63 + z32 + z42 + \\ z34 + z35 + z44 + z36 + z37 + z38\end{matrix} \\ h01 + h02 + h11 + h03 + h13 + h22 + z31 + z32 + z41 + v64 + \\ z42 + z35 + z37\end{matrix} \\ h02 + h12 + h22 + h23 + h33 + z31 + z33 + v65 + z34 + z36 + \\ z37 + z46 + z47\end{matrix} \\ h03 + h21 + h13 + h31 + h23 + h24 + h34 + z32 + z34 + v66 + \\ z35 + z45 + z37 + z38 + z47 + z48\end{matrix} \\ h01 + h11 + h04 + h22 + h31 + h14 + h32 + h24 + z31 + z33 + \\ v67 + z36 + z46 + z38 + z48\end{matrix} \\ h01 + h11 + h21 + h22 + h32 + z32 + z33 + z35 + z36 + z45 + \\ v68 + z46\end{matrix} ) \\ {K6}_{3} = ( \begin{matrix}\begin{matrix}\begin{matrix}\begin{matrix}\begin{matrix}\begin{matrix}\begin{matrix}h12 + h04 + h13 + h22 + h14 + h23 + h34 + v61 + z42 + z43 + \\ z45 + z46 + z48 \\ h01 + h21 + h13 + h31 + h14 + h23 + h24 + v62 + z41 + z43 + \\ z44 + z45 + z46 + z47\end{matrix} \\ h02 + h22 + h14 + h32 + h24 + v63 + z42 + z44 + z45 + z46 + \\ z47 + z48\end{matrix} \\ h11 + h03 + h12 + h21 + h04 + h13 + h22 + h14 + h33 + h34 + \\ z41 + v64 + z42 + z45 + z47\end{matrix} \\ h12 + h21 + h22 + h31 + h14 + h34 + z41 + v65 + z43 + z44 + \\ z46 + z47\end{matrix} \\ h11 + h13 + h22 + h31 + h23 + h32 + z42 + v66 + z44 + z45 + \\ z47 + z48\end{matrix} \\ h11 + h12 + h21 + h14 + h23 + h32 + h24 + h33 + z41 + z43 + \\ v67 + z46 + z48\end{matrix} \\ h11 + h21 + h13 + h14 + h24 + h33 + z42 + z43 + z45 + v68 + \\ z46\end{matrix} ) \\ {K6}_{4} = ( \begin{matrix}\begin{matrix}\begin{matrix}\begin{matrix}\begin{matrix}\begin{matrix}\begin{matrix}h12 + h04 + h13 + h22 + h14 + h23 + h34 + v01 + v21 + v41 + \\ z11 + z42 + z43 + z45 + z46 + z48 \\ h01 + h21 + h13 + h31 + h14 + h23 + h24 + v02 + v22 + v42 + \\ z12 + z14 + z43 + z44 + z45 + z46 + z47\end{matrix} \\ h02 + h22 + h14 + h32 + h24 + v03 + v23 + z13 + z42 + z44 + \\ z45 + z46 + z47 + z48\end{matrix} \\ h11 + h03 + h12 + h21 + h04 + h13 + h22 + h14 + h33 + h34 + \\ v04 + v24 + v44 + z14 + z41 + z42 + z45 + z47\end{matrix} \\ h12 + h21 + h22 + h31 + h14 + h34 + v05 + v25 + v45 + z41 + \\ z15 + z43 + z44 + z46 + z47\end{matrix} \\ h11 + h13 + h22 + h31 + h23 + h32 + v06 + v25 + v46 + z42 + \\ z16 + z44 + z45 + z47 + z48\end{matrix} \\ h11 + h12 + h21 + h14 + h23 + h32 + h24 + h33 + v07 + v27 + \\ z41 + v47 + z43 + z17 + z46 + z48\end{matrix} \\ h11 + h21 + h13 + h14 + h24 + h33 + v08 + v28 + z42 + z43 + \\ v48 + z18 + z45 + z46\end{matrix} ) \\ {K7}_{1} = ( \begin{matrix}\begin{matrix}\begin{matrix}\begin{matrix}\begin{matrix}\begin{matrix}\begin{matrix}h01 + h11 + h03 + h12 + h13 + h23 + h33 + h34 + v01 + v21 + \\ v41 + z11 + v71 + z31 + z32 + z34 + z35 + z45 + z37 + z38 + \\ z47 + z48 \\ h01 + h02 + h11 + h12 + h21 + h04 + h13 + h14 + h24 + h34 + \\ v02 + v22 + v42 + z12 + z31 + v72 + z32 + z33 + z36 + z46 + \\ z38 + z48\end{matrix} \\ h01 + h02 + h03 + h12 + h21 + h13 + h22 + h31 + h14 + v03 + \\ v23 + v43 + z13 + z31 + z32 + v73 + z33 + z34 + z35 + z45 + \\ z37 + z47\end{matrix} \\ h02 + h11 + h12 + h04 + h22 + h14 + h32 + h33 + h34 + v04 + \\ v24 + v44 + z31 + z14 + z33 + v74 + z36 + z37 + z46 + z47\end{matrix} \\ h01 + h11 + h03 + h12 + h21 + h04 + h31 + h33 + h34 + v05 + \\ v25 + z31 + v45 + z32 + z41 + z15 + z42 + z34 + v75 + z35 + \\ z44 + z37 + z38\end{matrix} \\ h02 + h12 + h04 + h13 + h22 + h32 + h34 + v06 + v26 + z31 + \\ z32 + z41 + v46 + z33 + z42 + z16 + z43 + v76 + z36 + z38\end{matrix} \\ h01 + h11 + h03 + h13 + h31 + h14 + h23 + h33 + v07 + z31 + \\ v27 + z32 + z41 + z33 + z42 + v47 + z34 + z43 + z17 + z35 + \\ z44 + v77 + z37\end{matrix} \\ h02 + h11 + h03 + h14 + h32 + h24 + h33 + v08 + z31 + z41 + \\ v28 + z33 + z43 + v48 + z18 + z36 + z37 + v78\end{matrix} ) \\ {K7}_{2} = ( \begin{matrix}\begin{matrix}\begin{matrix}\begin{matrix}\begin{matrix}\begin{matrix}\begin{matrix}h01 + h21 + h13 + h32 + h33 + v71 + z32 + z37 + z38 + z47 + \\ z48 \\ h02 + h11 + h22 + h31 + h14 + h33 + h34 + v72 + z33 + z38 + \\ z48 \\ h11 + h03 + h12 + h23 + h32 + h34 + z31 + v73 + z34 + z35 + \\ z45\end{matrix} \\ h12 + h04 + h31 + h32 + h24 + z31 + v74 + z36 + z37 + z46 + \\ z38 + z47 + z48\end{matrix} \\ h01 + h02 + h03 + h12 + h21 + h13 + h22 + h31 + h32 + h33 + \\ z33 + z34 + z43 + v75 + z35 + z44 + z36 + z37\end{matrix} \\ h01 + h02 + h11 + h03 + h04 + h13 + h22 + h31 + h14 + h23 + \\ h32 + h33 + h34 + z34 + z35 + z44 + v76 + z36 + z37 + z38\end{matrix} \\ h02 + h03 + h12 + h21 + h04 + h14 + h23 + h32 + h24 + h33 + \\ h34 + z31 + z41 + z36 + v77 + z37 + z38\end{matrix} \\ h01 + h02 + h11 + h12 + h21 + h04 + h31 + h32 + h24 + h34 +\end{matrix} \\ z32 + z33 + z42 + z34 + z43 + z35 + z44 + z36 + v78 + z38\end{matrix} ) \\ {K7}_{3} = ( \begin{matrix}\begin{matrix}\begin{matrix}\begin{matrix}\begin{matrix}\begin{matrix}\begin{matrix}h12 + h04 + h13 + h32 + h33 + v71 + z33 + z42 + z34 + z43 + \\ z44 + z36 + z37 + z38 + z47 + z48 \\ h01 + h11 + h13 + h31 + h14 + h33 + h34 + v72 + z34 + z43 + \\ z44 + z37 + z38 + z48\end{matrix} \\ h02 + h12 + h14 + h32 + h34 + z31 + v73 + z44 + z45 + z38 \\ h11 + h03 + h12 + h04 + h31 + h32 + z32 + z41 + z33 + z42 + \\ v74 + z34 + z43 + z35 + z44 + z36 + z37 + z46 + z38 + z47 + \\ z48\end{matrix} \\ h01 + h11 + h12 + h32 + h24 + h34 + z31 + z32 + z34 + z43 + \\ v75 + z44 + z45 + z37 + z46 + z38 + z48\end{matrix} \\ h02 + h12 + h21 + h13 + h31 + h33 + z31 + z32 + z33 + z44 + \\ v76 + z45 + z46 + z38 + z47\end{matrix} \\ h11 + h03 + h13 + h22 + h31 + h14 + h32 + h34 + z31 + z32 + \\ z41 + z33 + z34 + z35 + z45 + v77 + z46 + z47 + z48\end{matrix} \\ h11 + h04 + h31 + h14 + h23 + h24 + h33 + h34 + z31 + z33 +\end{matrix} \\ z42 + z43 + z44 + z36 + z45 + z37 + v78 + z38 + z47\end{matrix} ) \\ {K7}_{4} = ( \begin{matrix}\begin{matrix}\begin{matrix}\begin{matrix}\begin{matrix}\begin{matrix}\begin{matrix}h12 + h04 + h13 + h32 + h33 + v11 + v31 + v51 + v61 + z21 + \\ z33 + z42 + z34 + z43 + z44 + z36 + z37 + z38 + z47 + z48 \\ h01 + h11 + h13 + h31 + h14 + h33 + h34 + v12 + v32 + v52 + \\ v62 + z22 + z34 + z43 + z44 + z37 + z38 + z48\end{matrix} \\ h02 + h12 + h14 + h32 + h34 + v13 + v33 + v53 + z31 + v63 + \\ z23 + z44 + z45 + z38\end{matrix} \\ h11 + h03 + h12 + h04 + h31 + h32 + v14 + v34 + v54 + z32 + \\ z41 + v64 + z24 + z33 + z42 + z34 + z43 + z35 + z44 + z36 + \\ z37 + z46 + z38 + z47 + z48\end{matrix} \\ h01 + h11 + h12 + h32 + h24 + h34 + v15 + v35 + z31 + z32 + \\ v55 + v65 + z25 + z34 + z43 + z44 + z45 + z37 + z46 + z38 + \\ z48\end{matrix} \\ h02 + h12 + h21 + h13 + h31 + h33 + v16 + z31 + v36 + z32 + \\ z33 + v56 + v66 + z26 + z44 + z45 + z46 + z38 + z47\end{matrix} \\ h11 + h03 + h13 + h22 + h31 + h14 + h32 + h34 + v17 + z31 + \\ z32 + z41 + v37 + z33 + z34 + v57 + z35 + v67 + z27 + z45 + \\ z46 + z47 + z48\end{matrix} \\ h11 + h04 + h31 + h14 + h23 + h24 + h33 + h34 + z31 + v18 + \\ z33 + z42 + v38 + z43 + z44 + v58 + z36 + z45 + v68 + z28 + \\ z37 + z38 + z47\end{matrix} ) \\ {K8}_{1} = ( \begin{matrix}\begin{matrix}\begin{matrix}\begin{matrix}\begin{matrix}\begin{matrix}\begin{matrix}h02 + h03 + h04 + h13 + h22 + h31 + h32 + h33 + v11 + v31 + \\ v51 + v61 + z21 + v81 + z32 + z42 + z35 + z37 \\ h11 + h03 + h04 + h31 + h14 + h23 + h32 + h33 + h34 + v12 + \\ v32 + v52 + v62 + z22 + v82 + z33 + z43 + z35 + z36 + z38\end{matrix} \\ h11 + h12 + h21 + h04 + h32 + h24 + h33 + h34 + v13 + v33 + \\ v53 + z31 + v63 + z23 + z41 + v83 + z34 + z35 + z44 + z36 + z37\end{matrix} \\ h01 + h02 + h03 + h12 + h21 + h04 + h31 + h32 + h34 + v14 + \\ v34 + z31 + v54 + z41 + v64 + z24 + v84 + z36 + z38\end{matrix} \\ h01 + h02 + h11 + h03 + h22 + h31 + h32 + h24 + h34 + v15 + \\ v35 + z31 + v55 + z33 + v65 + z25 + z35 + v85 + z36 + z45 + \\ z37 + z46 + z47\end{matrix} \\ h01 + h02 + h03 + h12 + h21 + h04 + h31 + h23 + h32 + h33 + \\ v16 + z31 + v36 + z32 + v56 + z34 + v66 + z26 + z35 + z36 + \\ z45 + v86 + z37 + z46 + z38 + z47 + z48\end{matrix} \\ h02 + h03 + h21 + h04 + h13 + h22 + h31 + h32 + h24 + h33 + \\ h34 + v17 + z31 + z32 + v37 + z33 + v57 + v67 + z27 + z36 + \\ z37 + z46 + v87 + z38 + z47 + z48\end{matrix} \\ h01 + h02 + h21 + h04 + h31 + h14 + h23 + h24 + h33 + v18 + \\ z32 + v38 + z34 + z35 + v58 + z36 + z45 + v68 + z28 + z46 + \\ z38 + v88 + z48\end{matrix} ) \\ {K8}_{2} = ( \begin{matrix}\begin{matrix}\begin{matrix}\begin{matrix}\begin{matrix}\begin{matrix}\begin{matrix}h01 + h02 + h11 + h21 + h23 + h33 + z31 + v81 + z41 + z33 + \\ z43 + z35 \\ h02 + h03 + h12 + h21 + h22 + h31 + h24 + h34 + z31 + z32 + \\ z41 + v82 + z42 + z34 + z44 + z36\end{matrix} \\ h01 + h03 + h21 + h04 + h13 + h22 + h31 + h23 + h32 + z31 + \\ z32 + z41 + z33 + z42 + v83 + z43 + z37\end{matrix} \\ h01 + h04 + h22 + h14 + h32 + h24 + z32 + z42 + z34 + v84 + \\ z44 + z38\end{matrix} \\ h11 + h12 + h21 + h04 + h22 + h31 + h23 + h32 + h24 + h33 + \\ h34 + v85 + z38 + z48\end{matrix} \\ h01 + h12 + h13 + h22 + h23 + h32 + h24 + h33 + h34 + z33 + \\ z34 + z35 + z45 + v86\end{matrix} \\ h02 + h11 + h13 + h14 + h23 + h24 + h33 + h34 + z34 + z36 + \\ z46 + v87\end{matrix} \\ h11 + h03 + h21 + h04 + h22 + h31 + h14 + h23 + h32 + h33 + \\ z31 + z32 + z33 + z34 + z37 + z38 + z47 + v88 + z48\end{matrix} ) \\ {K8}_{3} = ( \begin{matrix}\begin{matrix}\begin{matrix}\begin{matrix}\begin{matrix}\begin{matrix}\begin{matrix}h01 + h21 + h04 + h22 + h23 + h32 + h24 + h34 + v81 + z41 + \\ z43 + z35 + z36 + z37 + z46 + z47 \\ h01 + h02 + h22 + h31 + h23 + h24 + h33 + z41 + v82 + z42 + \\ z35 + z44 + z36 + z45 + z37 + z38 + z47 + z48\end{matrix} \\ h02 + h03 + h31 + h23 + h32 + h24 + h34 + z41 + z42 + v83 + \\ z43 + z36 + z37 + z46 + z38 + z48\end{matrix} \\ h03 + h21 + h22 + h31 + h23 + h33 + h34 + z42 + v84 + z35 + \\ z44 + z36 + z45 + z46 + z38\end{matrix} \\ h22 + h14 + h24 + h33 + z32 + z34 + z43 + v85 + z48\end{matrix} \\ h11 + h21 + h31 + h23 + h34 + z31 + z41 + z33 + z44 + z45 + \\ v86\end{matrix} \\ h12 + h21 + h22 + h31 + h32 + h24 + z31 + z32 + z41 + z42 + \\ z34 + z46 + v87\end{matrix} \\ h21 + h13 + h14 + h23 + h32 + h24 + z31 + z33 + z42 + z34 + \\ z47 + v88 + z48\end{matrix} ) \\ {K8}_{4} = ( \begin{matrix}\begin{matrix}\begin{matrix}\begin{matrix}\begin{matrix}\begin{matrix}\begin{matrix}h01 + h21 + h04 + h22 + h23 + h32 + h24 + h34 + v01 + v21 + \\ v41 + z11 + v71 + z41 + z43 + z35 + z30 + z37 + z46 + z47 \\ h01 + h02 + h22 + h31 + h23 + h24 + h33 + v02 + v22 + v42 + \\ z12 + v72 + z41 + z42 + z35 + z44 + z36 + z45 + z37 + z38 + \\ z47 + z48\end{matrix} \\ h02 + h03 + h31 + h23 + h32 + h24 + h34 + v03 + v23 + v43 + \\ z13 + z41 + v73 + z42 + z43 + z38 + z37 + z46 + z38 + z48\end{matrix} \\ h03 + h21 + h22 + h31 + h23 + h33 + h34 + v04 + v24 + v44 + \\ z14 + z42 + v74 + z35 + z44 + z36 + z45 + z46 + z38\end{matrix} \\ h22 + h14 + h24 + h33 + v05 + v25 + v45 + z32 + z15 + z34 + \\ z43 + v75 + z48\end{matrix} \\ h11 + h21 + h31 + h23 + h34 + v06 + v26 + z31 + z41 + v46 + \\ z33 + z16 + z44 + v76 + z45\end{matrix} \\ h12 + h21 + h22 + h31 + h32 + h24 + v07 + z31 + v27 + z32 + \\ z41 + z42 + v47 + z34 + z17 + v77 + z46\end{matrix} \\ h21 + h13 + h14 + h23 + h32 + h24 + v08 + z31 + v28 + z33 + \\ z42 + z34 + v48 + z18 + v78 + z47 + z48\end{matrix} ) \\ {K9}_{1} = ( \begin{matrix}\begin{matrix}\begin{matrix}\begin{matrix}\begin{matrix}\begin{matrix}\begin{matrix}h02 + h12 + h21 + h31 + h23 + v01 + v21 + v41 + z11 + v71 + \\ z31 + z32 + v91 + z34 + z36 + z37 + z46 + z38 + z47 + z48 \\ h03 + h21 + h13 + h22 + h32 + h24 + v02 + v22 + v42 + z12 + \\ z31 + v72 + z32 + z33 + v92 + z37 + z38 + z47 + z48\end{matrix} \\ h01 + h11 + h21 + h04 + h22 + h14 + h23 + h33 + v23 + v43 + \\ z13 + z31 + z32 + v73 + z33 + z34 + v93 + z38 + z48\end{matrix} \\ h01 + h11 + h22 + h24 + h34 + v04 + v24 + v44 + z31 + z14 + \\ z33 + v74 + z35 + v94 + z36 + z45 + z37 + z46 + z38 + z47 + \\ z48\end{matrix} \\ h01 + h02 + h12 + h04 + h31 + h14 + h32 + h33 + h34 + v05 + \\ v25 + z31 + v45 + z41 + z15 + v75 + z35 + v95 + z38\end{matrix} \\ h01 + h02 + h11 + h03 + h13 + h32 + h33 + h34 + v06 + v26 + \\ z32 + v46 + z42 + z16 + z35 + v76 + z36 + v96\end{matrix} \\ h01 + h02 + h11 + h03 + h12 + h04 + h14 + h33 + h34 + v07 + \\ v27 + z33 + v47 + z43 + z17 + z36 + v77 + z37 + v97\end{matrix} \\ h01 + h11 + h03 + h13 + h31 + h14 + h32 + h33 + v08 + v28 + \\ z34 + v48 + z44 + z18 + z37 + v78 + v98\end{matrix} ) \\ {K9}_{2} = ( \begin{matrix}\begin{matrix}\begin{matrix}\begin{matrix}\begin{matrix}\begin{matrix}\begin{matrix}h01 + h11 + h03 + h21 + h13 + z32 + v91 + z35 + z36 + z45 + \\ z46 \\ h01 + h02 + h11 + h12 + h04 + h22 + h14 + z33 + v92 + z36 + \\ z37 + z46 + z47\end{matrix} \\ h01 + h02 + h11 + h03 + h12 + h13 + h23 + z31 + z34 + v93 + \\ z35 + z45 + z37 + z38 + z47 + z48\end{matrix} \\ h02 + h12 + h04 + h14 + h24 + z31 + z35 + v94 + z45 + z38 + \\ z48\end{matrix} \\ h01 + h02 + h11 + h03 + h12 + h04 + h13 + h31 + h14 + z31 + \\ z32 + z41 + z42 + z36 + v95 + z38\end{matrix} \\ h02 + h03 + h12 + h04 + h13 + h14 + h32 + z32 + z33 + z42 + \\ z43 + z35 + z37 + v96\end{matrix} \\ h03 + h04 + h13 + h14 + h33 + z31 + z41 + z33 + z34 + z43 + \\ z35 + z44 + z36 + z38 + v97\end{matrix} \\ h01 + h02 + h11 + h03 + h12 + h13 + h34 + z31 + z41 + z34 + \\ z35 + z44 + z37 + z38 + v98\end{matrix} )\end{matrix}$$

Then, the next step S103 is executed to carry out a variable transposition process. With the results of the vectors K11, K12, K13, K14, K21, . . . , K91 and K92 used as a base, the simultaneous linear equation is transformed so as to result in equations, which each include only terms zxx and vxx on the right-hand side thereof as follows.

k1₁₁=v11+z21

k1₁₂=v12+z22

k1₁₃=v13+z23

k1₁₄=v14+z24

k1₁₅=v15+z25

k1₁₆=v16+z26

k1₁₇=v17+z27

k1₁₈=v18+z28

h11+h21+h1330 k1₂₁=v11+z32+z42

h11+h12+h22+h14+k1₂₂=v12+z33+z43

h11+h12+h13+h23+k1₂₃=v13+z31+z41+z34+z44

h12+h14+h24+k1₂₄=v14+v31+z41

h01+h02+h03+h04+h31+k1₂₅=v15+z36+z46+z38+z48

h02+h03+h04+h32+k1₂₆=v16+z35+z45+z37+z47

h03+h04+h33k1₂₇=v17+z35+z36+z45+z46+z38+z48

h01+h02h03+h34+k1₂₈=v18+z35+z45+z37+z38+z47+z48

h01+h03+k1₃₁=v11+z42+z35+z36z45+z46

h01+h02+h04+k1₃₂=v12+z43+z36+z37+z46+z47

h01+h02+h03+k1₃₃=v13+z41+z35+z44+z45+z37+z38+z47+z48

h02+h04+k1₃₄=v14+z41+z35+z45+z38+z48

h11+h12+h13+h14+k1₃₅=v15+z31+z32+z41+z42+z46+z48

h12+h13+h14+k1₃₆=v16+z32+z33+z42+z43+z45+z47

h13+h14+k1₃₇=v17+z31+z41+z33+z34+z43+z44+z45+z46+z48

h11+h12+h13+z31+k1₃₈=v18+z41+z3431+z44+z45+z47+z48

h01+h03+k1₄₁=v01+z11+z42+z35+z36+z45+z46

h01+h02+h04+k1₄₂=v02+z12+z43+z36+z37+z46+z47

h01+h02+h03+k1₄₃=v03+z13+z41+z35+z44+z45+z37+z38+z47+z48

h02+h04+k1₄₄=v04+z14+z41+z35+z45+z38+z48

h11+h12+h13+h14+k1₄₅=v05+z31+z41+z15+z42+z46+z48

h12+h13h14+k1₃₆=v06+z32+z33+z42+z16+z43+z45+z47

h13+h14+k1₄₇=v07+z31+z41+z33+z34+z43+z17+z44+z45+z46+z48

h11+h12+h13+k1₄₈=v08+z31+z41+z34+z44+z18+z45+z47+z48

k2₁₁=v01+v21+z11

k2₁₂=v02+v22+z12

k2₁₃=v03+v23+z13

k2₁₄=v04+v31+z14

k2₁₅=v05+v25+z15

k2₁₆=v06+v26+z16

k2₁₇=v07+v27+z17

k2₁₈=v08+v28+z18

h02+h12+h21+h31h23+k2₂₁=v21+z31+z32+z34+z36+z37+z46+z38+z47+z48

h03+h21+h13+h22h24+k2₂₂=v22+z31+z32+z33+z37+z38+z47+z48

h01+h11+h2130 h04+h22+h14+h23+h33+k2₂₃=v23+z31+z32+z33+z34+z38+z48

h01+h11+h22+h24+h34+k2₂₄=v24+z31+z33+z35+z36+z45+z37+z46+z38+z47+z48

h01+h02+h12+h04+h31+h32+h33+h34+k2₂₅=v25+z31+z41+z35+z38

h01+h02+h11+h03+h13+h3230 h33+h34+k2₂₆=v26+z32+z42+z35+z36

h01+h02+h11+h03+h12+h04+h14+h33+h34+k2₃₇=v27+z33+z43+z36+h37

h01+h11+h03+h13+h31+h14+h32+k2₂₈=v28+z34+z44+z37

h01+h11+h12h1₃₁30 h33+k2₃₁=v21+z32+z41+z33+z3430 z43+z35+z36+z37+z46+z38+z47+z48

h02+h12h13+h31+h32+h34+k2₃₂=v22+z41+z33+z42+z34+z44+z36+z37+z38+z47+z48

h11+h03h13+h31+h14+h32+h33+k2₃₃=v23+z41+z42+z34+z43+z37+z38+z48

h11+h04h14+h32+h34+k2₃₄=v24+z31+z32+z33+z42+z34+z35+z44+z36+z45+z37+z46+z47+z48

h01+h02+h11+h21+h22+h14+h23+h24+k2₃₅=v25+z31+z32+z41+z33+z35+z48

h02+h11+h03+h12+h22+h23+h24+k2₃₅=v26+z32+z33+z42+z34+z36+z45

h01+h03+h12+h04+h13+h23+h24+k2₃₇=v27+z33+z34+z43+z37+z46

h01+h21+h04+h13+h22+h23+z31+z32+k2₂₈=v28+z33+z44+z38+z47+z48

h01+h11+h12+h31+h33k2₄₁=v11+z21+z32+z33+z41+z33+z34+z43+z35+z36+z37+z46+z38+z47+z48

h02+h12+h13+h31+h32+h34+k2₄₃=v12+z22+z41+z33+z42+z34+z44+z36+z37+z38+z47+z48

h11+h03+h13+h31+h14+h32+h33+k2₄₃=v13+z23+z41+z42+z34+z43+z37+z38+z37+z38+z48

h11+h04+h14+h34+k2₄₄=v14+z31+z32+z24+z33+z42+z34+z35+z44+z36+z45+z37+z46+z47+z48

h01+h02+h11+h21+h22+h14+h23+h24+k2₄₅=v15+z31+z32+z41+z33+z25+z34+z35+z48

h02+h11+h03+h12+h22+h23+h24+k2₄₈=v16+z32+z33+z42+z34+z26+z36+z45

h01+h03+h1230 h04+h13+h23+h24+k2₄₇=v17+z33+z34+z43+z27+z46

h01+h21+h04+h13+h22+h23+z31+k2₄₈=v18+z32+z33+z44+z28+z38+z47+z48

k3₁₁=v11+v31+z21

k3₁₂=v12+v32+z22

k3₁₃=v13+v33+z23

k3₁₄=v14+v34+z24

k3₁₅=v15+v35+z25

k3₁₆=v16+v36+z26

k3₁₇=v17+v37+z27

k3₁₈=v18+v38+z28

h02+h03+h04+h13+h22+h3130 h33+k3₃₁=v31+z32+z42+z35+z37

h11+h03+h04+h31+h14+h23+h32+h33+h34+k3₂₂=v32+z33+z43+z35+h36+z38

h11+h12+h21+h04+h32+h24+h33+h34+k3₂₃=v33+z31+z41+z34+z35+z44+z36+z37

h01+h02+h03h12+h2130 h04+h31+h32+h34+k3₂₄=v34+z31+z41+z36+z38

h01+h02h11+h03+h22+h31+h32+h24+h34+k3₂₅=v35+z31+z33+z35+z36+z45+z37+z46+z47

h01+h02h03+h12+h21+h04+h31+h23+h32+k3₃₃h31+k3₂₆=v36+z32+z34+z35+z36+z45+z37+z46+z38+z47+z48

h02+h03h21+h04+h13+h22+h3130 h32+h24+h33+h34+z31+z32+k3₂₇=v37+z33+z36+z37+z46+z38+z47+z48

h01+h02+h21+h04+h31+h14+h23+h24+h33+z32+k3₂₈=v38+z34+z35+z36+z45+z46+z38+z48

h01+h02+h03+h21+h04+h22+h31+k3₃₁=v31+z42+z35+z38+z47+z48

h02+h03+h04+h22+h23+h32+k3₃₂=v32+z43+z35+z36+z48

h02+h21+h04+h23+h24+h33+k3₃₂=v33+z41+z44+z36+z45+z37

h01+h02+h03+h21+h24h34+k3₃₄=v34+z41+z37+z46+z47+z48

h11+h12+h21+h13+h24+h33+h34+k3₃₅=v35+z31+z34+z43+z44+z45+z46+z47

h11+h12+h21+h13+h22+h14+h34+z31+k3₃₆=v36+z32+z44+z45+z46+z47+z48

h12+h13+h22+h31+h14+z32+z41+k3₃₇=v37+z33+z46+z47+z48

h11+h12+h1430 h23+h32+h33+h34+z33+z42+k3₃₈=v38+z43+z44+z45+z46+z48

h01+h02+h03+h21+h04+h22+h31+k3₄₁=v01+v21+z11+z42+z35+z38+z47+z48

h02+h03+h04+h22+h23+h32+k3₄₂=v02+v22+z12+z43+z35+z36+z48

h03+h21+h04+h23+h24+h33+k3₄₃=v03+v23+z13+z41+z44+z36+z45+z37

h01+h02+h03+h21+h24+h34+k3₄₄=v04+v24+z14+z41+z37+z46+z47+z48

h11+h12+h21+h13+h24+h33+h34+k3₄₅=v05+v25+z31+z15+z34+z43+z44+z45+z46+z47

h11+h12+h21+h13+h24+h33+h34+k3₄₅=v05+v25+z31+z15+z34+z43+z44+z45+z46+z48

h12+h13+h22+h31+h14+h23+k3₄₇=v07+v27+z32+z41+z33+z17+z46+z47+z46+z48

h11+h12+h14+h23+h32+h33+h34+k3₄₈=v08+v28+z33+z42+z43+z44+z18+z45+z46+z48

k4₁₁=v01+v41+z11

k4₁₂=v02+v42+z12

k4₁₃=v03+v43+z13

k4₁₄=v04+v44+z14

k4₁₅=v05+v45+z15

k4₁₆=v06+v46+z16

k4₁₇=v07+v47+z17

k4₁₈=v08+v48+z18

h01+h11+h03+h12+h13+h2330 h33+h34+k4₄₁=v41+z31+z32+z34+z35+z45+z37+z38+z47+z48

h01+h02+h11+h12+h21+h04+h13+h14+h24+h34+k4₂₂=v42+z31+z32+z33+h36+z46+z38+z48

h01+h02+h03+h12+h21+h13+h22+h31+h14+k4₂₃=v43+z31+z32+z33+z34+z35+z45+z37+z47

h02+h11+h12+h04+h2230 h14+h32+h33+h34+k4₂₄=v44+z31+z33+z36+z37+z46+z47

h01+h02h11+h03+h22+h31+h32+h24+h34+k3₂₅=v35+z31+z33+z35+z36+z45+z37+z46+z47

h01+h11+h03+h12+h21+h04+h31+h33+h34+z31+k4₂₅v45+z32+z41+z42+z34+z35+z44+z37+z38

h02+h12+h04+h13+h22+h32+h3430 z31+z32+z41+k4₂₆=v46+z33+z42+z43+z36+z38

h01+h11+h0330 h13+h31+h14+h23+h33+z31+z32+z41+z33+z42+k4₂₇=v47+z34+z43+z35+z44+z37

h02+h11+h03+h14+h32+h24+h33+z31+z41+z33+z43+k4₂₈=v48+v36+z37

h02+h04+h13+h14+h33+h34+k4₃₁=v41+z31+z33+z42+z34+z43+z36+z45+z37+z47+z48

h01+h03+h14+h34+k4₃₂=v42+z32+z41+z34+z43+z35+z44+z37+z46+z38+z48

h01+h02+h11+h04+h31+k4₃₈=v43+z31+z33+z42+z44+z36+z45+z38+z47

h01+h03+h12+h04+h13+h14+h32+h33+h34+k4₃₄=v44+z32+z41+z33+z42+z35+z36+z46+z47

h01+h02+h11+h03+h21+h04+h22+h31+h23+h34+k4₃₅=v45+z32+z41+z33+z42+z35+z44+z36+z46+z38+z47

h02+h03+h12+h21+h04+h22+h31+h23+h24+z31+z41+k4₃₆=v46+z33+z42+z34+z43+z35+z36+z45+z37+z47+z48

h03+h04+h13+h22+h23+h32+h24+h33+z32+z41+z42+k4₃₇=v47+z34+z43+z35+z44+z36+z37+z46+z38+z48

h01+h02+h03+h21+h22+h14+h24+h33+z31+z32+z41+k4₃₈=v47+z35+z45+z37+z46

h02+h04+h13+h14+h33+h34+k4₄₃=v11+v31+z21+z31+z33+z42+z34+z43+z36+z45+z37+z47+z48

h01+h03+h14+h34+k4₄₂=v12+v32+z22+z32+z41+z34+z43+z35+z44+z37+z46+z38+z48

h01+h02+h11+h04+h31+k4₄₃=v13+v33+z31+z23+z33+z42+z44+z36+z45+z38+z47

h01+h03+h12+h04+h13+h14+h32+h33+h34+k4₄₄=v14+v34+z32+z41+z24+z33+z42+z35+z36+z46+z47

h01+h02+h11+h03+h21+h04+h22+h31+h23+h34+k4₄₅=v15+v35+z32+z41+z33+z42+z25+z35+z44+z36+z46+z38+z47

h02+h03+h12+h21+h04+h22+h31+h23+h32+h24+k4₄₆=v16+z31+v36+z41+z33+z42+z34+z43+z26+z35+z36+z45+z37+z47+z48

h03+h04+h13+h22+h23+h32+h24+h33+k4₄₇=v17+z32+z41+v37+z42+z34+z43+z35+z44+z27+z36+z37+z46+z38+z48

h01+h02+h03+h31+h22+h14+h24+h33+z31+k4₄₈=v18+z32+z41+v38+z43+z35+z45+z28+z37+z46

k5₁₁=v31+v51+z21

k5₁₂=v32+v52+z22

k5₁₃=v33+v53+z23

k5₁₄=v34+v54+z24

k5₁₅=v35+v55+z25

k5₁₆=v36+v56+z26

k5₁₇=v37+v57+z27

k5₁₈=v38+v58+z28

h02+h21+h1330 h22+h23+k5₂₁=v51+z33+z34+z43+z44+z37

h11+h03+h21+h22+h14+h23+h24+k5₂₂=v52+z34+z35+z44+z38

h01+h11+h12+h04+h22+h24+k5₂₃=v53+z31+z41+z35+z36

h01+h12+h21+h22+h24+k5₂₄=v54+z32+z33+z42+z34+z43+z44+z36

h02+h03+h12+h21+h04+h13+h22+h14+h33+h34+k5₂₆=v55+z33+z36+z46

h03+h04+h13+h22+h14+h23+h34+z31+k5₂₆=v56+z34+z37+z47

h21+h04+h31+h14+h23+h24+z31+z32+k5₂₇=v57+z35+z45+z38+z48

h01+h02+h11+h03+h12+h21+h04+h13+h14+h32+h24+h33+h34+z32+z35+k5₂₈=v58+z45

h02+h12+h04+h13+h23+h32+h24+h34+k5₃₁=v51+z43+z44+z47

h01+h11+h03+h13+h31+h14+h24+h33+k5₃₂=v52+z44+z45+z48

h01+h02+h12+h21+h04+h31+h14+h32+h34+k5₃₃=v53+z41+z45+z46

h01+h11+h03+h12+h04+h22+h31+h23+h24+h33+h34+k5₃₄=v54+z42+z43+z44+z46

h11+h21+h14+h34+k5₃₆=v55+z43+z46

h11+h12+h22+h31+z41+k5₃₆=v56+z44+z47

h12+h13+h23+h32+z41+z42+k5₃₇=v57+z45+z48

h13+h24+h33+h34+z42+k5₃₈=v58+z45

h02+h12+h04+h13+h23+h32+h24+h34+k5₄₁=v01+v21+v41+z11+z43+z44+z47

h01+h11+h03+h13+h31+h14+h24+h33+k5₄₂=v02+v22+v42+z12+z44+z45+z48

h01+h02+h12+h21+h04+h31+h14+h32+h34+k5₄₃=v03+v23+v43+z13+z41+z45+z46

h01+h11+h03+h12+h04+h22+h31+h23+h24+h33+h34+k5₄₄=v04+v24+v44+z14+z42+z43+z44+z46

h11+h21+h14+h34+k5₄₅=v05+v25+v45+z15+z43+z46

h11+h12+h22+h31k5₄₆=v06+v26+z41+z46+z16+z44+z47

h12+h13+h23+h32k5₄₇=v07+v27+z41+z42+v47+z17+z45+z48

h13+h24+h33+h34k5₄₈=v08+v28+z42+z48+z18+z45

h02+h21+h1330 h22+h23+k6₁₁=v11+v31+v51+v61+z21+z33+z34+z43+z44+z37

h11+h03+h21+h22+h14+h23+h24+k6₁₂=v12+v32+v52+v62+z22+z34+z34+z35+z44+z38

h01+h11+h12+h04+h22+h23+h24+k6₁₃=v13+v33+v53+z31+v63+z23+z41+z35+z36

h01+h12+h21+h22+h24+k6₁₄=v14+v34+v54+z32+v64+z24+z33+z42+z34+z43+z44+z36

h02+h03+h12+h21+h04+h13+h22+h14+h33+h34+k6₁₅=v15+v35+v55+z33+v65+z25+z25+z36+z46

h03+h04+h13+h22+h14+h23+h34+k6₁₆=v16+z31+v36+v56+z34+v66+z26+z37+z47

h21+h04+h31+h14+h23+h24+k6₁₇=v17+z31+z32+v37+v57+z35+v67+z27+z45+z38+z48

h01+h02+h11+h03+h12+h21+h04+h13+h14+h32+h24+h33+h34+k6₁₈=v18+z32+v38+z35+v58+z45+v68+z28

h01+h02+h11+h03+h12+h04+h14+h23+k6₂₁=v61+z32+z33+z42+z43+z35+z36+z38

h02+h11+h03+h12+h21+h04+h13+h24+k6₂₂=v62+z31+z41+z33+z34+z43+z35+z44+z36+z37

h11+h03+h12+h21+h04+h13+h22+h14+k6₂₃=v63+z32+z42+z34=v35+z44+z36+z37+z38

h01+h02+h11+h03+h13+h22+z31+z32+z41+k6₂₄=v64+z42+z35+z37

h02+h12+h22+h23+h33+z31+k6₂₅=v05+z34+z36+z37+z46+z47

h03+h21+h13+h31+h23+h24+h34+z32+z34+k6₂₈=v66+z35+z45+z37+z38+z47+z48

h01+h11+h04+h22+h31+h14+h32+h24+z31+z33+k6₂₇=v67+z36+z46+z38+z48

h01+h11+h21+h22+h32+z32+z33+z35+z36+z45+k6₂₈=v68+z46

h12+h04+h13+h22+h14+h23+h34+k6₃₁=v61+z42+z43+z45+z46+z48

h01+h21+h13+h31+h14+h23+h24+k6₃₂=v62+z41+z43+z44+z45+z46+z47

h02+h22+h14+h32+h24+k6₃₈=v63+z42+z44+z45+z46+z47+z48

h11+h03+h12+h21+h04+h13+h22+h14+h33+h34+z41+k6₃₄=v64+z42+z45+z47

h12+h21+h22+h31+h14+h34+z41+k6₃₅=v65+z43+z44+z46+z47

h11+h13+h2230 h31+h23+h32+z42+k6₃₆=v66+z44+z45+z47+z48

h11+h12+h21+h14+h23+h32+h24+h33+z43+k6₃₇=v67+z46+z48

h11+h21+h13+h14+h24+h33+z42+z43+z45+k6₃₈=v68+z46

h12+h04+h13+h22+h14+h23+h34+k6₄₁=v01+v21+v41+z11+z42+z43+z45+z46+z48

h01+h21+h13+h31+h14+h23+h24+k6₄₂=v02+v22+v42+z12+z41+z43+z44+z45+z46+z47

h02+h22+h14+h32+h24+k6₄₃=v03+v23+v43+z13+z42+z44+z45+z46+z47+z48

h11+h03+h12+h21+h04+h13+h22+h14+h33+h34+k6₄₄=v04+v24+v44+z14+z41+z42+z45+z47+v37+v57+z35+v67+z27+z45+z38+z48

h12+h21+h22+h31+h14+h34+k6₄₅=v05+v25+v45+z41+z15+z43+z44+z46+z47

h11+h13+h22+h31+h23+h32+k6₄₆=v06+v26+v46+z42+z16+z44+z45+z47+z48

h11+h12+h21+h14+h23+h32+h24+h33+k6₄₇=v07+v27+z41+z47+z43+z17+z46+z48

h11+h21+h13+h14+h24+h33+k6₄₈=v08+v28+z42+z43=v48+z18+z45+z46

h01+h11+h03+h12+h13+h23+h33+h34+k7₁₁=v01+v21+v41+z11+v71+z31+z32+z34+z35+z45+z37+z38+z47+z48

h01+h02+h11+h12+h21+h04+h13+h14+h24+h34+k7₁₂=v02+v22+v42+z12+z31+v72+z32+z33+z36+z46+z38+z48

h01+h02+h03+h12+h21+h13+h22+h31+h14=k7₁₃=v03+v23v43++z13+z31+z32+v73+z33+z34+z35+z45+z37+z47

h02+h11+h12+h04+h22+h14+h32+h33+h34+k7₁₄=v04+v24+v44+z31+z14+z33+v74+z36+z37+z46+z47

h01+h11+h03+h12+h21+h04+h31+h33+h34+k7₁₅=v05+v25+z31+v45+z32+z41+z15+z42+z34+v75+z35+z44+z37+z38

h02+h12+h04+h13+h22+h32+h34+k7₁₆=v06+v26+z31+z32+z41+v46+z33+z42+z16+z43+v76+z36+z38

h01+h11+h03+h13+h31+h14+h23+h33+k7₁₇=v07+z31+v27+z32+z41+z33+z42+v47+z34+z43+z17+z35+z44+v77+z37

h02+h11+h03+h14+h32+h24+h33+k7₃₈=v08+z31+z41+v28+z33+z43+v48+z18+z36+z37+v48

h01+h21+h13+h32+h33+k7₂₁=v71+z32+z37+z38+z47+z48

h02+h11+h22+h31+h14+h33+h34+k7₂₂=v72+z33+z38+z48

h12+h03+h12+h23+h32+h34+z31+k7₂₃=v73+z34+z35+z45

h12+h04+h3130 h32+h24+z31+k7₂₄=v74+z36+z37+z46+z38+z47+z48

h01+h02+h03+h12+h21+h13+h22+h31+h32+h33+z33+z34+z43+k7₂₅=v75+z44+z36+z37

h01+h02+h11+h03+h04+h13+h22+h31+h14+h23+h32+h33+h34+z34+z35+z44+k7₃₅=v76+z36+z37+z38

h02+h03+h12+h21+h04+h14+h23+h32+h24+h33+h34+z31+z41+z36+k7₂₇=v77+z37+z38

h01+h02+h11+h12+h21+h04+h31+h32+h24+h34+z32+z33+z42+z34+z43+z35+z44+z36+k7₂₈=v78+z38

h12+h04+h13+h32+h33+k7₃₁=v71+z33+z42+z34+z43+z44+z36+z37+z38+z47+z48

h01+h11+h13+h31+h14+h33+h34+k7₃₂=v72+z34+v43+z44+z37+z38+z48

h02+h12+h14+h32+h34+z31+k7₃₃=v73+z44+z45+z38

h11+h03+h12+h04+h31+h32+z32+z41+z33+z42+k7₃₄=v74+z34+z43+z35+z44+z36+z37+z46+z38+z47+z48

h01+h11+h12+h32+h24+h34+z31+z32+z34+z43+k7₃₅=v75+z44+z45+z37+z46+z38+z48

h02+h12+h21+h13+h31+h33+z31+z32+z33+z44+k7₃₆=v76+z45+z46+z38=z47

h11+h03+h13+h22+h31+h14+h32+h34+z31+z32+z41+z33+z34+z35+z45+k7₃₇=v77+z47+z48

h11+h04+h31+h14+h23+h24+h33+h34+z31+z33+z42+z43+z44+z36+z45+z37+k7₃₈=v78+z38+z47

h12+h04+h13+h32+h33+k7₄₁=v11+v31v51++z61+z21+z33+v42+z34+z43+z44+z36+z37+z38+z47+z48

h01+h11+h13+h31+h14+h33+h34+k7₄₂+v12+v32+v52+v62+z22+z34+z43+z44+z37+z38+z48

h02+h12+h14+h32+h34+k7₄₅=v13+v33+v53+z31+v63+z23+z44+z45+z38

h11+h03+h12+h04+h31+h32+k7₄₄=v14+v34+v54+z32+z41+v64+z24+z33+z42+z34+z43+z35+z44+z36+z37+z46+z38+z47+z48

h01+h11+h12+h32+h24+h34+k7₄₅=v15+v35+z31+z32+v55+v65+z25+z34+z43+v44+z45+z37+z46+v38+z48

h02+h12+h21+h32+h13+h33+k7₄₆=v16+z31+v36+z32+z33+v56+v66+z26+z44+z45+z46+z38+v47

h11+h03+h13+h22+h31+h14+h32+h34+k7₄₇=v17+z31+z32+z41+v37+z33+z34+v57+z35+v67+z27+z45+v46+z47+z48

h11+h04+h31+h14+h23+h24+h33+h34+z31+k7₄₈=v18+z33+z42+v88+z43+z44+v58+z36+z45+v68+z28+z37+z38+z47

h02+h03+h04+h13+h22+h31+h32+h33+k8₁₁=v11+v31+v51+v61+z21+v81+z32+z42+z35+z37

h11+h03+h04+h31+h14+h23+h32+h33+h34+k8₁₂=v12+v32+v52+v62+z22+v82+z33+z43+z35+z36+z38

h11+h12+h21+h04+h32+h24+h33+h34+k8₁₃=v13+v33+v53+z31+v63+z23+z41+v83+z34+z35+z44+z36+z37

h01+h02+h03+h12+h21+h04+h31+h32+h34+k8₁₄=v14+v34+z31+v54+z41+v64+z24+v84+z36+z38

h01+h02+h11+h03+h22+h31+h32+h24+h34+k8₁₅=v15+v35+z33+v35+z33+v65+z25+z35+v85+z36+z45+z37+z46+z47

h01+h02+h03+h12+h21+h04+h31+h23+h32+h33+k8₁₆=v16+z31+v36+z32+v56+z34+v66+z26+z35+v36+z45+v86+z37+z46+z38+z47+z48

h02+h03+h21+h04+h13+h22+h31+h32+h24+h33+h34+k8₁₇=v17+z31+z32+v37+z33+v57+v67+z27z36+z37+z46+v87+z38+z47+z48

h01+h02+h21+h04+h31+h14+h23+h24+h33+k8₁₅=v18+z32+v38+z34+z35+v58+z36+z45+v68+z28+z46+z38+v88+z48

h01+h02+h11+h21+h23+h33+z31+k8₂₁=v81+z41+z33+z43+z35

h02+h03+h12+h21+h22+h31+h24+h34+z31+z32+z41+k8₂₂=v82+z42+z34+z44=z36

h01+h03+h21+h04+h13+h22+h31+h23+h32+z31+z32+z41+z33+z42+k8₂₃=v83+z43+z37

h01+h04+h22+h14+h32+h24+z32+z42+z34+k8₂₄=v84+z44+z38

h11+h12+h21+h04+h22+h31+h32+h24+h33+h34+z32+z33+z34+k8₂₅=v85+z28+z48

h01+h12+h13+h22+h23+h32+h32+h24+h33+h34+z33+z34+z35+z45+k8₂₆+v86

h02+h11+h13+h14+h23+h24+h33+h34+z34+z36+z46+k8₄₅=v87

h11+h03+h21+h04+h22+h31+h14+h23+h32+h33+z31+z32+z33+z34+z37+z38+z47+k8₂₃=v88+z48

h01+h21+h04+h22+h23+h24+h34+k8₃₁=v81+z41+z43+z35+z36+v65+z25+z37+z46+v47

h01+h02+h22+h31+h23+h24+h33+z02+k8₃₁=v82+z42+z35+z44+z36+z45+z37+z38+z47+z48

h02+h03+h31+h23+h32+h24+h34+z41+z42+k8₃₃=v83+z43+z36+z37+z46+z38+z48

h03+h21+h22+h31+h23+h33+h34+z42+k8₃₄=v84+z35+z44+z36+z45+z46+z38

h22+h14+h24+h33+z32+z34+z34+z43+k8₃₈=v85+z48

h11+h21+h31+h23+h34+z31+z41+z33+z44+z45+k8₃₀=v86

h12+h21+h22+h31+h32+h24+z31+z32+z41+z42+z46+k8₃₇=v87

h21+h13+h14+h23+h32+h24+z31+z33+z42+z34+z47+k8₃₆=v88+z48

h01+h21+h04+h22+h23+h24+h34+k8₄₁=v01+v21+v41+z11+v71+z41+z43+z35+z36+z37+z46+z47

h01+h02+h22+h31+h23+h24+h33+k8₄₂=v02+v22+v42+z12+v72+z42+z35+z44+z36+z45+z37+z38+z47+z48

h02+h03+h31+h23+h32+h24+h34+k8₄₃=v03+v23+v43+z13+z41+v73+z42+z43+v73+z42+z43+z36+z37+z46+z38+z48

h03+h21+h22+h31+h23+h33+h34+k8₄₄=v04+v24+v44+z14+z42+v74+z35+z44z36+z45+z46+z38

h22+h14+h24+h33+k8₄₅=v05+v25+v45+z32+z15+z34+z43+v75+z48

h11+h21+h31+h23+h34+k8₄₆=v06+v26+z31+z41+v46+z23+z16+z44+v76+v45

h12+h21+h22+h31+h32+h24+k8₄₇=v07+z31+v27+z32=z41+z42+v47+z34+z17=v77+z46

h21+h13+h14+h23+h32+h24+k8₄₃=v08+z31+v28+z33+z42+z34+v48=z18+v78+z47+z48

h02+h12+h21+h31+h23+k9₁₁=v01+v21+v71+z31+z32+v01+z34=z36+z37+z46+z38+z47+z48

h03+h21+h13+h22+h32+h24+k9₁₂=v02+v22+v42+z12+z31+v72+z33=v92+z37+z38+z47+z48

h01+h11+h21+h04+h22+h23+h33+k9₁₃+v03+v23+v43+z13+z31=z32+v73+z33+z34+v93+z38+z48

h01+h11+h22+h24+h34+k9₁₄=v04+v24+v44+z31+z14+z33=v74+z35+v94+z36+z45+z37+z46+z28+z47+z48

h01+h02+h12+h04+h31+h14+h32+h33+h34+k9₁₅=v05+v25+z31+z31+v45+z41+z15=v75+z35+v95+z38

h01+h02+h11+h03+h13+h32+h33+h34+k9₁₆=v06+v26+z32+v46+z42+z16+z35+v76+z36+z96

h01+h02+h11+h03+h12+h04+h14+z33+h34+k9₁₇=v07+v27+z33+v47+z43+z17+z36+v77+z37+v97

h01+h02+h11+h03+h13+h31+h14+h32+h33+k9₁₈=v08+v28+z34+v48+z44+z18+z37+v78+v98

h01+h11+h03+h21+h13+z3230 k9₂₁=v91+z35+z36+z45+z45

h01+h02+h11+h12+h04+h22+h14+z33+k9₂₂=v92+z36+z37+z46+v47

h01+h02+h11+h03+h12+h13+h23+z31+k9₂₃=v03+z25+z45+z37+z38+z47+z48

h02+h12+h04+h14+h24+z31+z35+k9₂₄=v94+z45+z38+z48

h01+h02+h11+h03+h12+h04+h13+h31+h41+z31+z32+z41+z42+z36+k9₂₅=v95+z38

h01+h03+h12+h04+h13+h14+h32+z32+z32+z33+z42+z43+z35+z37k9₂₆=v96

h03+h04+h13+h14+h33+z31+z41+z33+z34+z43+z35+z44+z36+z38k9₂₇=v97

h01+h02+h11+h03+h12+h13+h34+z31+z41+z34+z35+z44+z37+z38k9₂₈=v98 [formula 34]

Then, the next step S104 is executed to carry out a matricial-equation transformation process. In this process, vectors K, H, U and V are set as follows.

K=(k1₁₁, K1₁₂, . . . , k9₂₈)

H=(h01, h02, . . . , h44)

U=(z11, z12, . . . , z44)

V=(v01, v02, . . . , v74) [formula 35]

With the vectors K, H, U and V set as expressed by the above equations, the simultaneous linear equation can be transformed into the following matricial equation.

[Formula 36]

$${M}_{KH} ( \begin{matrix}{}^{t} K \\ {}^{t} H\end{matrix} ) = {M}_{UV} ( \begin{matrix}{}^{t} U \\ {}^{t} V\end{matrix} )$$

It is to be noted that, in the above equation, symbols M_{KH} and M_{UV} each denote a GF(2) matrix comprising coefficients of the simultaneous linear equation described above.

Then, the next step S105 is executed to carry out a unitary transformation process.

Let symbol Nᵣ denote the rank value of the matrix M_{UV} as follows:

rank(M_{UV})=Nᵣ [formula 37]

Then, let symbol Nm denote the number of rows composing the matrix M_{UV}. By multiplying both the left-hand and right-hand sides of the matricial equation by a row-deform unitary matrix Q from the left, the matrix M_{UV} can be deformed into a step matrix. In this process, a small matrix consisting of (Nₘ-Nᵣ) lowest rows of the matrix QM_{UV} becomes a null matrix.

Then, the next step S106 is executed to carry out a small-matrix selection process. Let symbol M*_{KH} denote a small matrix consisting of (Nₘ-Nᵣ) lowest rows of the matrix QM_{KH}. In this case, the small matrix M*_{KH} becomes a null matrix (O) as expressed by the following equation.

M*_{KH}=0 [formula 38]

Then, the next step S107 is executed to carry out a linear-relation equation generation process. This matricial equation is transformed into linear-relation equations, which are each associated with a row. Then, actual values are substituted for h01, h02, . . . and h44 to obtain the following relation equations:

[Formula 39]

0×07=k1₁₁+k1₂₁+k1₂₄+k₂₆+k1₃₁+k1₃₄+k1₃₆+k2₄₂+k2₁₂+k2₂₃+k3₁₁+k3₂₁

0×66=k1₁₂+k1₂₁+k1₂₂+k1₂₇+k1₃₁+k1₃₂+k1₃₇+k1₄₃+k2₁₃+k2₂₃+k3₁₂+k3₂₂

0×9e=k1₁₂+k1₂₂+k1₂₃+k1₂₅+k1₂₈+k1₃₂+k1₃₃+k1₃₅+k1₃₈+k1₄₁+k1₄₄+k2₁₁+k2₁₄+k2₂₄+k3₁₃+k3₂₃

0×df=k1₁₄+k1₂₃+k1₂₅+k1₃₃+k1₃₅+k1₄₁+k2₁₁+k2₂₁+k3₁₄+k3₂₄

0×e9=k1₁₅+k1₂₂+k1₂₄+k1₂₅+k1₂₆+k1₃₂+k1₃₄+k1₃₅+k1₃₈+k1₄₆+k1₄₈+k2₁₆+k2₁₈+k2₂₆+k2₂₈+k3₁₆+k3₂₅

0×23=k1₁₈+k1₂₁+k1₂₃+k1₂₆+k1₂₇+k1₃₁+k1₃₃+k1₃₆+k1₃₇+k1₄₅+k1₄₇+k2₁₅+k2₁₇+k2₂₅+k2₂₇+k3₁₈+k3₂₈

0×60=k1₁₇+k1₂₁+k1₂₂+k1₂₄+k1₂₅+k1₂₇+k1₂₈+k1₃₁+k1₃₂+k1₃₄+k1₃₅+k1₃₇+k1₃₈+k1₄₅+k1₄₀+k1₄₈+k2₁₅+k2₁₆+k2₁₅+k2₁₆+k2₁₈+k2₂₅+k2₂₆+k2₂₈+k3₁₇+k3₃₇

0×cd=k1₁₈+k1₂₂+k1₂₃+k1₂₄+k1₂₅+k1₂₈+k1₃₁+k1₃₃+k1₃₄+k1₃₅+k1₃₈+k1₄₅+k1₄₇+k1₄₈+k2₄₈+k2₁₅+k2₁₇+k2₁₈+k2₂₃+k2₂₇+k2₂₈+k3₃₈+k3₂₈

0×3d=k1₂₁+k1₂₄+k1₂₇+k1₂₈+k1₃₁+k1₃₄+k1₃₇+k1₃₈+k1₄₁+k1₄₂+k1₄₃+k2₁₁+k2₄₈+k2₁₁+k2₁₂+k2₁₈+k2₂₁+k2₂₂+k2₂₃+k2₁₃+k4₁₃+k3_{33 33}

0×00=k1₂₂+k1₃₅+k1₂₆+k1₂₇+k1₂₈+k1₃₂+k1₃₅+k1₃₆+k1₃₇+k1₃₈+k1₄₁+k1₄₃+k1₄₆+k1₄₇+k1₁₈+k2₁₃+k2₁₆+k2₁₇+k2₁₈+k2₂₁+k2₂₃+k2₂₆+k2₂₇+k2₂₈+k4₁₁+k4₃₁

0×e1=k1₂₃+k1₂₆+k1₂₇+k1₂₅+k1₃₃+k1₃₅+k1₃₇+k1₃₈+k1₄₁+k1₄₂+k1₄₄+k1₄₇+k1₄₈+k2₁₁+k2₁₄+k2₁₇+k2₁₆+k2₂₁+k2₂₂+k2₂₄+k2₂₇+k2₂₈+k4₁₂+k4₃₂

0×80=k1₂₄+k1₂₅+k1₂₆+k1₂₈+k1₃₄+k1₃₅+k1₃₆+k1₃₈+k1₄₁+k1₄₃+k1₄₄+k1₄₅+k1₄₆+k1₄₇+k2₁₁+k2₁₅+k2₁₆+k2₁₇+k2₂₁+k2₂₃+k2₂₄+k2₂₅+k2₂₆+k2₂₇+k4₃₂+k4₁₆+k4₃₃+k4₃₄

0×39=k1₂₅+k1₃₅+k1₄₃+k1₄₄+k1₄₅+k1₄₇+k1₄₅+k2₁₁+k2₁₂+k2₁₄+k2₁₅+k2₁₆+k2₁₇+k2₁₈+k2₂₁+k2_{24i +k}2₂₅+k2₂₇+k2₂₈+k4₁₂+k4₁₆+k4₃₂+k4₃₈

0×2d=k2₂₆+k1₃₆+k1₄₁+k1₄₂+k1₄₆+k1₄₈+k2₁₁+k2₁₂+k2₁₃+k2₁₆+k2₁₇+k2₁₈+k2₁₁+k2₂₂+k2₂₆+k2₂₈+k4₁₃+k4₁₇+k4₃₃+k4₃₇

0×d5d=k1₂₇₆+k1₂₈+k1₃₇+k1₃₈+k1₄₂+k1₄₅+k1₄₈+k2₁₄+k2₁₅+k2₁₆+k2₁₈+k2₂₂+k2₂₅+k2₂₆+k4₁₄+k4₁₈+k4₃₄+k4₃₈

0×fα=k1₂₈+k1₃₆+k1₄₃+k1₄₆+k1₄₇+k2₁₁+k2₁₃+k2₁₅+k2₁₆+k2₁₇+k2₂₃+k2₂₆+k2₂₇+k4₁₁+k4₁₅+k4₃₁+k4₃₅

0×39=k1₄₁+k1₄₂+k1₄₄+k1₄₆+k1₄₈+k2₁₃+k2₁₇+k2₁₈+k2₂₂+k2₂₄+k2₂₅+k2₂₈+k2₃₂+k4₁₁+k4₁₃+k4₁₃+k4₂₄+k4₁₈+k4₁₇+k4₃₃+k4₃₃+k4₃₄+k4₃₆+k4₃₇

0×35=k1₄₂+k1₄₃+k1₄₄+k1₄₄+k1₄₅+k1₄₆+k1₄₇+k2₁₁+k2₁₃+k2₁₆+k2₂₁+k2₂₂+k2₂₃+k2₂₅+k26+k2₂₇+k2₃₁+k2₃₅+k4₄₁+k4₁₁+k4₁₂+k4₁₅+k4₁₇+k430 k4₃₁+k4₃₂+k3₃₅+k4₃₇

0×4b=k1₄₃+k1₄₄+k1₃₅+k1₄₆+k1₄₇+k2₁₁+k2₁₂+k2₁₃+k2₁₄+k2₁₇+k2₂₁+k2₂₂+k2₂₃+k2₂₄+k2₂₅+k2₂₇+k2₂₈+k2₃₁+k2₃₂+k4₁₁+k4₁₂+k4₁₃+k4₁₅+k4₁₆+k4₁₈+k4₃₁+k4₃₂+k4₃₃+k4₃₆+k4₃₈

0×e7=k1₄₄+k1₄₅+k1₄₇+k1₄₈+k2₁₁+k2₁₂+k2₁₃+k2₁₅+k2₁₈+k2₂₂+k2₂₃+k2₂₄+k2₂₆+k2₂₇+k2₂₈+k2₃₂+k2₃₃+k4₁₁+k4₁₂+k4₁₃+k4₁₄+k4₁₅+k4₁₆+k4₁₇+k4₃₁+k4₃₃+k4₃₄+k4₃₅+k4₃₆+k4₃₇

0×33=k1₄₅+k1₄₆+k2₁₂+k2₁₃+k3₁₄+k2₁₆+k2₂₁+k2₂₅+k2₂₆+k2₃₁+k3₁₁+k4₁₂+k4₁₃+k4₁₄+k4₁₅+k4₃₂+k4₃₃+k4₃₄+k4₃₅+k5₁₁+k5₂₁

0×db=k1₄₅+k1₄₇+k2₁₃+k2₁₄+k2₁₇+k2₂₂+k2₂₆+k2₂₇+k2₃₂+k3₁₂+k4₁₃+k4₁₄+k4₁₆+k4₃₃+k4₃₄+k4₃₆+k5₁₂+k5₂₂

0×8f=k1₄₇+k1₄₈+k2₁₁+k2₁₃+k2₁₄+k2₁₅+k21₁₆+k2₁₇+k2₂₁+k2₂₂+k2₂₄+k2₂₇+k2₂₈+k2₃₁+k2₃₂+k2₃₄+k3₁₁+k2₁₂+k3₁₄+k4₁₁+k4₁₃+k4₁₄+k4₁₅+k4₁₆+k4₁₈+k4₃₁+k4₃₂+k4₃₄+k4₃₅+k4₃₈+k5₁₁+k5₁₂+k5₁₄+k5₂₂+k5₃₂+k5₂₄

0×83=k1₄₈+k2₁₂+k2₁₄+k2₁₆+k2₁₇+k2₁₈+k2₂₁+k2₂₂+k1₂₃+k2₂₈+k2₃₁+k2₃₂+k2₃₃+k3₁₁+k3₁₂+k4₁₃+k4₁₄+k4₁₅+k4₁₆+k4₁₇+k4₃₂+k4₃₄+k4₃₅+k4₃₆+k4₃₇+k5₁₁+k5₁₂+k5₁₃+k5₂₁+k5₂₂+k5₂₃

0×00=k2₁₁+k3₁₁+k4₁₁+k4₃₁+k4₄₁

0×00=k2₁₂+k3₁₂+k4₁₂+k4₃₂+k4₄₂

0×00=k2₁₃+k3₁₃+k4₁₃+k4₃₃+k4₄₃

0×00=k2₁₄+k3₁₄+k4₁₄+k4₂₄+k4₄₄

0×1f=k2₁₅+k2_{17i +k}2₂₂+k2₂₃+k2₂₄+k2₂₅+k2₃₂+k2₃₃+k2₂₄+k2₃₅+k3₁₁+k3₁₂+k3₁₃+k3₁₄+k4₁₅+k5₁₇+k4₃₅+k4₃₇+k4₄₁+k4₄₂+k4₄₃+k4₄₄

0×8e=k2₁₆+k2₁₇+k2₁₈+k2₂₂+k2₂₅+k2₂₆+k2₃₂+k2₃₅+k2₃₆+k3₁₁+k4₁₆+k4₁₇+k4₁₈+k4₃₆+k4₃₇+k4₃₆+k4₃₇+k4₃₈+k4₄₁

0×68=k2₁₇+k2₁₅+k2₂₃+k2₂₅+k2₂₇+k2₃₃+k2₃₇+k3₁₂+k4₁₇+k4₁₈+k4₃₇+k4₃₈+k4₄₂

0×35d=k2₁₈+k2₂₁+k2₂₄+k2₂₅+k2₂₇+k2₂₈+k2₃₁+k2₃₄+k2₃₆+k2₃₇+k2₃₈+k3₁₃+k4₁₈+k4₃₈+k4₄₂

0×42=k2₂₂+k2₂₃+k2₂₆+k2₂₈+k2₂₃+k2₃₂+k2₃₆+k2₃₈+k3₁₁+k3₁₄+k3₁₅+k4₄₁+k4₄₄+k4₄₅

0×e6=k2₂₂+k2₂₃+k2₂₅+k2₂₇+k2₃₂+k2₃₃+k2₂₅+k2₃₇+k3₁₁+k3₁₂+k3₁₆+k4₄₁+k4₃₂+k4₄₆

0×91=k2₂₃+k2₂₄+k2₂₈+k2₃₃+k2₃₄+k2₃₆+k3₁₂+k3₁₃+k3₁₄+k3₁₅+k3₁₈+k4₄₂+k4₄₃+k4₄₄+k4₄₅+k4₄₆+k4₄₈

0×f9=k2₂₄+k2₂₇+k2₃₄+k2₃₇+k3₁₃+k3₁₄+k3₁₅+k3₁₆+k3₁₇+k4₄₃+k4₄₄+k4₄₅+k4₄₆+k4₄₇

0×α0=k2₂₅+k2₂₈+k2₃₅+k2₃₈+k3₁₁+k3₁₃+k3₁₅+k5₁₁+k5₁₃+k5₁₄+k5₁₅+k5₂₁+k5₂₃+k5₂₄+k5₂₅

0×v7=k2₂₆+k2₂₈+k2₃₈+k2₃₆+k2₂₃+k3₁₂+k3₁₃+k3₁₆+k4₄₁+k4₄₄+k5₁₁+k5₁₂+k5₁₃+k5₁₅+k5₁₆+k5₂₁+k5₂₂+k5₂₃+k5₂₅+k5₂₆

0×07=k2₂₇+k2₂₈+k2₃₇+k2₃₈+k3₁₁+k3₁₄+k3₁₅+k3₁₆+k3₁₇+k4₄₁+k4₄₂+k4₄₄+k5₁₂+k5₁₅+k5₁₆+k5₁₇+k5₂₂+k5₂₅+k5₂₆+k5₂₇

0×c1=k2₂₈+k2₃₈+k3₁₁+k3₁₂+k3₁₅+k3₁₆+k3₁₇+k3₁₈+k4₄₁+k4₄₂+k4₄₃+k5₁₈+k5₁₅+k5₁₆+k5₁₇+k5₁₈+k5₂₂+k5₂₅+k5₂₆+k5₂₇+k5₂₈

0×c9=k2₄₁+k3₁₁+k3₁₂+k3₁₃+k3₁₆+k3₁₇+k3₂₁+k4₄₁+k4₄₂+k4₄₃+k4₄₇+k4₁₈+k5₁₁+k5₁₆+k5₁₈+k5₂₁+k5₁₆+k5₂₆+k5₂₈

0×ed=k2₄₂+k3₁₁+k3₁₂+k3₁₃+k3₁₄+k3₁₆+k3₁₇+k3₁₈+k3₂₂+k4₄₁+k4₄₂+k4₄₃+k4₄₄+k4₄₈+k5₁₂+k5₁₅+k5₁₇+k5₂₂+k5₂₅+k5₂₇

0×f6=k2₄₅+k3₁₂+k3₁₃+k3₁₄+k3₁₆+k3₁₅+k3₂₃+k4₄₂+k4₄₃+k4₄₄+k4₄₅+k5₁₂+k5₁₅+k5₁₆+k5₁₈+k5₂₃+k5₂₅+k5₂₃+k5₂₈

0×46=k2₄₄+k3₁₁+k3₁₂+k3₁₄+k3₁₅+k3₁₆+k3₂₄+k4₄₁+k4₄₂+k4₄₄+k4₄₅+k4₄₇+k4₄₈+k5₁₅+k5₁₇+k5₁₈+k5₂₄+k5₂₆+k5₂₇+k5₂₈

0×81=k2₄₅+k3₁₁+k3₁₄+k3₁₅+k3₁₆+k3₁₇+k3₁₈+k3₂₅+k4₄₁+k4₄₃+k4₄₆+k4₄₈+k5₁₂+k5₁₄+k5₂₃+k5₂₄+k5₂₇

0×29=k2₄₆+k3₁₁+k3₁₂+k3₁₆+k3₁₇+k3₁₈+k3₂₆+k4₄₁+k4₁₂+k4₄₄+k4₄₅+k4₄₇+k5₁₄+k5₁₅+k5₂₄+k5₂₅+k5₂₈

0×85=k2₄₇+k3₁₂+k3₁₃+k3₁₇+k3₁₈+k3₂₇+k4₄₁+k4₄₂+k4₄₃+k4₄₅+k4₄₆+k4₄₈+k5₁₁+k5₁₅+k5₁₆+k5₂₁+k5₂₅+k5₂₆

0×69=k2₄₈+k3₁₃+k3₁₅+k3₁₆+k3₁₇+k3₂₈+k4₄₂+k4₄₄+k4₄₅+k4₄₇+k4₄₈+k5₁₂+k5₁₃+k5₁₄+k5₁₆+k5₂₂+k5₂₃+k4₂₄+k5₂₈

0×8b=k3₁₁+k3₁₂+k3₁₆+k3₁₇+k3₁₈+k3₂₁+k4₄₁+k4₄₃+k5₁₆+k5₁₇+k5₁₈+k5₂₆+k5₂₇+k5₂₈+k5₄₁

0×1b=k3₁₂+k3₁₃+k3₁₄+k3₁₆+k4₁₁+k4₁₂+k4₄₂+k4₄₃+k4₄₄+k5₁₅+k5₂₆+k5₄₁+k5₄₂

0×bc=k3₁₃+k3₁₄+k3₁₇+k4₁₂+k4₁₃+k4₄₃+k4₄₄+k4₁₇+k5₂₇+k5₄₂+k5₄₃

0×53=k3₁₄+k3₁₅+k3₁₈+k4₁₁+k4₁₄+k4₄₄+k5₁₅+k5₁₈+k5₂₅+k5₂₉+k5₄₂+k5₄₃+k5₄₄

0×04=k3₁₅+k3₁₇+k4₁₁+k4₁₂+k4₁₃+k4₁₅+k4₄₁+k4₄₄+k4₄₅+k4₄₆+k4₄₇+k4₄₈+k5₁₁+k5₁₄+k5₁₆+k5₁₈+k5₂₁+k5₂₄+k5₂₆+k5₂₈+k5₄₁+k5₄₂+k5₄₃+k5₄₅

0×cf=k3₁₆+k3₁₇+k3₁₈+k4₁₄+k4₁₅+k4₁₆+k4₄₂+k4₄₄ₖ3₁₅+k3₁₇+k4₁₁+k4₁₂+k4₁₃+k4₁₅+k4₄₁+k4₄₄+k4₄₅+k4₄₆+k5₁₂+k5₁₄+k5₁₅+k5₁₆+k5₁₇+k5₁₈+k5₂₂+k5₂₄+k5₂₅+k5₂₈+k5₂₇+k5₄₄+k5₄₅+k5₄₈

0×58=k3₁₇+k3₁₆+k4₁₁+k4₁₆+k4₁₇+k4₄₁+k4₄₂+k4₄₅+k5₁₁+k5₁₂+k5₁₅+k5₁₇+k5₁₈+k5₂₁+k5₂₃+k5₄₁+k5₄₆+k5₄₇

0×21=k3₁₇+k4₁₂+k4₁₅+k4₁₇+k4₁₈+k4₄₁+k4₄₂+k4₄₇+k5₁₁+k5₁₂+k5₁₄+k5₁₇+k5₁₈+k5₂₁+k5₂₂+k5₂₄+k5₂₇+k5₂₈+k5₄₂+k5₃₄+k5₄₇+k5₄₈

0×37=k3₂₁+k3₃₁+k4₁₁+k4₁₂+k4₁₃+k4₁₄+k4₁₆+k4₁₇+k4₁₈+k4₁₁+k4₄₄+k4₄₄450 k4₄₇+k5₁₁+k5₁₄+k5₁₅+k5₁₇+k5₂₁+k5₂₄+k5₂₅+k5₂₇+k5₄₁+k5₄₂+k5₄₃+k5₄₄+k5₄₆+k5₄₆+k5₄₈

0×α3=k3₂₂+k3₃₂+k4₁₂+k4₁₃+k4₁₄+k4₁₇+k4₁₈+k4₄₁+k4₄₂+k4₄₈+k5₁₁+k5₁₂+k5₁₅+k5₁₆+k5₂₁+k5₂₂+k5₂₅+k5₂₆+k5₂₈+k5₄₂+k5₄₃+k5₄₄′k5₄₇+k5₄₈

0×9b=k3₂₈+k3₃₃+k4₁₄+k4₁₈+k4₄₂+k4₄₃+k4₄₅+k4₄₇+k5₁₂+k5₁₃+k5₁₅+k5₁₆+k5₁₇+k5₂₃+k5₂₆+k5₂₈+k5₂₇+k5₄₃+k5₄₄+k5₄₈

0×51=k3₂₄+k3₃₄+k4₁₁+k4₁₂+k4₁₃+k4₁₅+k4₁₆+k4₁₇+k4₁₈+k4₄₃+k4₄₆+k4₄₈+k5₁₃+k5₁₆+k5₂₃+k5₂₆+k5₄₁+k5₄₂+k5₄₃+k5₄₅+k5₄₆+k5₄₇+k5₄₈

0×4α=k3₂₅+k3₃₈+k4₁₂+k4₁₄+k4₁₆+k4₁₇+k4₁₈+k4₄₁+k4₄₆+k4₄₇+k5₁₁+k5₁₆+k5₁₇+k5₂₁+k5₂₆+k5₁₇+k5₂₁+k5₂₆+k5₂₇+k5₄₂+k5₄₄+k5₄₅+k5₄₇+k5₄₈

0×4f=k3₂₆+k3₃₆+k4₁₁+k4₁₃+k4₁₇+k4₁₈+k4₄₂+k4₄₅+k4₄₇+k4₄₃+k5₁₂+k5₁₅+k5₁₇+k5₁₈+k5₂₂+k5₂₅+k5₂₇+k5₂₈+k5₄₁+k5₄₃+k5₄₇+k5₄₈

0×8α=k3₂₇+k3₃₇+k4₁₁+k4₁₂+k4₁₄+k4₁₈+k4₄₃+k4₄₆+k4₄₈+k5₁₃+k5₁₆+k5₁₈+k5₂₃+k5₃₆+k5₂₈+k5₄₁+k5₄₂+k5₄₄+k5₄₈

0×c2=k3₂₈+k3₃₈+k4₁₁+k4₁₃+k4₁₄+k4₁₅+k4₁₆+k4₁₇+k4₁₈+k4₄₄+k4₄₅+k4₄₆+k5₁₄+k5₁₅+k5₁₆+k5₂₄+k5₂₅+k5₂₆+k5₄₁+k5₄₂+k5₄₄+k5₄₅+k5₄₇+k5₄₈

0×72=k3₄₁+k4₁₄+k4₁₅+k4₃₁+k4₄₃+k4₄₇+k5₁₃+k5₁₇+k5₂₃+k5₂₇+k5₄₁+k5₄₄+k5₄₈

0×α2=k3₁₂+k4₁₁+k4₁₅+k4₃₂+k4₄₁+k4₄₄+k4₄₅+k5₁₁+k5₁₄+k5₁₅+k5₁₈+k5₂₁+k5₂₄+k5₂₆+k5₂₈+k5₄₁+k5₄₃+k5₄₅

0×68=k3₁₃+k4₁₂+k4₁₆+k4₃₃+k4₄₁+k4₄₂+k4₄₅+k5₁₁+k5₁₂+k5₁₆+k5₂₁+k5₂₂+k5₂₅+k5₂₆+k5₂₈k5₄₂+k5₄₃+k5₄₆

0×56=k3₄₄+k4₁₃+k4₁₄+k4₁₇+k4₁₈+k4₂₄+k4₄₆+k5₁₂+k5₁₆+k5₂₂+k5₂₈+k5₄₃+k5₄₇+k5₄₈

0×80=k3₄₅+k4₁₂+k4₁₃+k4₁₅+k4₁₈+k4₃₅+k4₄₂+k4₄₃+k4₄₇+k5₁₂+k5₁₃+k5₁₇+k5₂₂+k5₂₃+k5₂₇+k5₄₂+k5₄₃+k5₄₅+k5₄₈

0×dα=k3₄₆+k4₁₁+k4₁₂+k4₁₄+k4₁₅+k4₁₇+k4₃₆+k4₁₁+k4₁₃+k4₄₄+k4₄₅+k5₁₁+k5₁₃+k5₁₄+k5₁₅+k5₁₈+k5₂₁+k5_{23i +k}5₂₄+k5₂₅+k5₂₈+k5₄₁+k5₄₄+k5₄₅+k5₄₆+k5₄₈

0×c4=k3₄₇+k4₁₂+k4₁₄+k4₁₅+k4₁₆+k4₁₈+k4₃₇+k4₄₆+k5₁₂+k5₁₄+k5₁₅+k5₁₆+k5₂₂+k5₂₄+k5₂₅+k5₂₆+k5₄₂+k5₄₄+k5₄₅+k5₄₆+k5_{47i +k}5₄₈

0×2c=k3₄₈+k4₁₁+k4₁₂+k4₁₅+k4₁₇+k4₁₈+k4₃₈+k4₄₁+k4₄₂+k4₄₈+k5₁₁+k5₁₂+k5₁₆+k5₂₁+k5₂₁+k5₂₂+k5₂₆+k5₄₁+k5₄₂+k5₄₅+k5₄₇

0×5e=k4₁₁+k4₁₃+k4₁₄+k4₁₅+k4₁₆+k4₁₇+k4₁₈+k4₄₁+k4₄₄+k4₄+k4₄₅+k4₄₈+k5₁₄+k5₁₆+k5₁₈+k5₂₁+k5₂₄+k5₂₆+k5₂₈+k5₄₁+k5₄₃+k5₄₄+k5₄₅+k5₄₈+k5₄₇+k5₄₈+k6₁₁+k6₃₁

0×69=k4₁₂+k4₁₄+k4₁₆+k4₁₇+k4₁₈+k4₄₁+k4₄₂+k4₄₅+k4₄₇+k5₁₁+k5₁₅+k5₁₇+k5₂₁+k5₂₂+k5₂₅+k5₂₇+k5₄₃+k5₄₄+k5₄₆+k5₄₇+k5₄₈+k6₁₂+k6₃₂

0×66=k4₁₃+k4₁₄+k4₁₅+k4₁₈+k4₄₁+k4₄₂+k4₄₃+k4₄₈+k5₁₁+k5₁₃+k5₁₃+k5₁₄+k5₁₈+k5₂₁+k5₂₂+k5₂₃+k5₂₉+k5₄₃+k5₄₄+k5₄₅+k5₄₈+k6₁₂+k6₁₄+k6₃₂+k6₃₄

0×94=k4₁₄+k4₁₅+k4₁₆+k4₄₃+k4₄₂+k4₄₃+k4₄₄+k4₄₅+k5₁₂+k5₁₄+k5₁₅+k5₂₁+k5₂₂+k5₂₃+k5₂₄+k5₂₅+k5₄₄+k5₄₅+k5₄₆+k6₁₁+k6₁₃+k6₃₁+k6₃₃

0×8f=k4₁₅+k4₁₆+k4₄₁+k4₄₂+k4₄₃+k4₄₄+k5₁₆+k5₂₁+k5₂₂+k5₂₃+k5₂₄+k5₄₃+k5₄₆+k6₁₁+k6₁₂+k6₁₃+k6₁₄+k6₁₆+k6₃₁+k6₃₂+k6₃₃+k6₃₄+k6₃₅

0×1b=k4₁₆+k4₁₇+k4₄₂+k4₄₃+k4₄₄+k5₁₆+k5₂₂+k5₂₃+k5₂₄+k5₄₆+k5₄₇+k6₁₂+k6₁₃+k6₁₄+k6₁₆+k6₃₂+k6₃₃+k6₃₄+k6₃₆

0×48=k4₁₇+k4₁₈+k4₄₂+k4₄₃+k5₁₅+k5₁₆+k5₁₈+k5₂₂+k5₂₃+k5₄₇+k5₄₈+k6₁₂+k6₁₃+k6₁₆+k6₁₈+k6₃₂+k6₃₅+k6₃₆+k6₃₈

0×28=k4₁₈+k4₄₂+k4₄₃+k4₄₄+k5₁₅+k5₁₆+k5₁₇+k5₂₂+k5₂₃+k5₂₄+k5₄₈+k6₁₁+k6₁₃+k6₁₄+k6₁₅+k6₁₆+k6₁₇+k6₃₁+k6₃₃+k6₃₄+k6₃₅+k6₃₆+k6₃₇

0×00=k4₂₁+k4₃₁+k4₄₅+k5₂₅+k6₁₅+k6₃₅

0×00=k4₂₂+k4₃₂+k4₄₆+k5₂₆+k6₁₆+k6₃₆

0×00=k4₂₃+k4₃₃+k4₄₇+k5₂₇+k6₁₇+k6₃₇

0×00=k4₂₄+k4₃₄+k4₄₈+k5₂₈+k6₁₈+k6₃₈

0×00=k4₂₅+k4₃₅+k4₄₁+k5₂₁+k6₁₁+k6₃₂

0×00=k4₂₈+k4₃₆+k4₄₂+k5₂₂+k6₁₂+k6₃₂

0×00=k4₂₇+k4₃₇+k4₄₃+k5₂₃+k6₁₃+k6₃₃

0×00=k4₂₈+k4₃₈+k4₄₄+k5₂₄+k6₁₄+k6₃₄

0×7b=k4₄₁+k4₄₃+k5₁₅+k5₁₇+k5₁₈+k5₂₁+k5₂₃+k5₄₅+k6₁₁+k6₁₃+k6₁₆+k6₁₇+k6₁₈+k6₃₁+k6₃₃+k6₃₆+k6₃₇+k6₃₈+k6₄₅

0×1b=k4₄₂+k4₄₃+k4₄₄+k5₁₈+k5₂₂+k5₂₃+k5₂₄+k5₄₅+k5₄₈+k6₁₂+k6₁₃+k6₁₄+k6₁₆+k6₃₂+k6₃₃+k6₃₄+k6₃₆+k6₄₅+k6₄₈

0×bc=k4₄₃+k4₄₄+k5₁₇+k5₂₃+k5₂₄+k5₄₆+k5₄₇+k6₁₃+k6₁₄+k6₁₇+k6₃₃+k6₃₄+k6₃₇+k6₄₆+k6₄₇

0×53=k4₄₄+k5₁₅+k5₁₆+k5₂₄+k5₄₅+k5₄₇+k5₄₈+k6₁₁+k6₁₈+k6₁₈+k6₃₄+k6₃₅+k6₃₈+k6₄₅+k6₄₇+k6₄₈

0×79=k4₄₅+k4₄₆+k4₄₇+k5₁₃+k5₂₃+k5₂₆+k5₂₇+k5₄₁+k6₁₃+k6₁₅+k6₁₆+k6₁₇450 k6₃₃+k6₃₅+k6₃₆+k6₃₇+k6₄₁

0×d8=k4₄₆+k4₄₈+k5₁₁+k5₂₆+k5₂₇+k5₂₈+k5₄₃+k6₁₁+k6₁₃+k6₁₆+k6₁₇+k6₁₈+k6₃₁+k6₃₂+k6₃₆+k6₃₇+k6₃₈+k6₄₃

0×fb=k4₄₇+k4₄₈+k5₁₂+k5₁₃+k5₂₇+k5₂₈+k5₄₁+k5₄₄+k6₁₂+k6₁₃+k6₁₇+k6₁₈+k6₃₂+k6₃₃+k6₃₇+k6₃₈+k6₄₁+k6₄₄

0×bα=k4₁₈+k5₁₁+k5₁₂+k5₁₄+k5₂₈+k5₄₁+k5₄₂+k6₁₁+k6₁₃+k6₁₄+k6₁₈+k6₃₁+k6₃₃+k6₃₄+k6₃₈+k6₄₁+k6_{42 k}5₄₃+k5₄₅+k5₄₆+k5₄₇+k5₄₈

0×04=k5₁₁+k5₁₄+k5₁₅+k5₄₄+k5₄₅+k5₄₈+k6₁₁+k6₁₄+k6₁₅+k6₃₁+k6₃₄+k6₃₅+k6₄₃+k6₄₄+k6₄₅+k6₄₆+k7₁₃+k7₂₃

0×25=k5₁₂+k5₁₇+k5₁₈+k5₄₂+k5₄₃+k5₄₄+k5₄₆+k6₁₂+k6₁₇+k6₁₈+k6₃₂+k6₂₇+k6₃₈+k6₄₁+k6₄₂+k6₄₃+k6₄₄+k6₄₈+k7₁₁+k7₂₁

0×96=k5₁₃+k5₁₈+k5₄₃+k5₄₄+k5₄₇+k6₁₃+k6₁₈+k6₂₃+k6₃₃+k6₄₂+k6₄₃+k6₄₄+k6₄₇+k7₁₂+k7₂₂

0×cα=k5₁₅+k5₁₅+k5₁₆+k5₁₇+k5₁₈+k5₄₁+k5₄₂+k5₄₃+k5₄₈+k6₁₄+k6₁₅+k6₁₆+k6₁₇+k6₁₈+k6₃₄+k6₃₅+k6₃₆+k6₃₇+k6₃₈+k6₄₁+k6₄₂+k6₄₄+k6₄₅+k7₁₃+k7₁₄+l7₂₃+k7₂₄

0×94=k5₁₅+k5₁₆+k5₁₇+k5₁₈+k5₄₁+k5₄₄+k5₄₈+k6₁₅+k6₁₀+k6₁₇+k6₁₈+k6₃₆+k6₃₇⇄k6₃₈+k6₃₇+k6₃₃+k6₄₁+k6₄₃+k6₄₈+k7₁₂+k7₁₄+k7₂₁+k7₂₃+k7₂₄+k7₃₂

0×α7=k5₁₆+k5₁₇+k5₁₈+k5₄₁+k5₄₂+k5₄₅+k6₁₆+k6₁₇+k6₁₈+k6₃₆+k6₃₇+k6₃₈+k7₂₂⇄k7₂₄+k7₃₂

0×ef=k5₁₇+k5₁₈+k5₄₂+k5₄₆+k6₁₇+k6₁₈+k6₃₇+k6₃₈+k6₄₁+k6₄₂+k6₄₃+k6₄₅+k7₁₁+k7₂₁+k7₂₃+k7₃₃

0×e7=k5₁₈+k5₄₁+k5₄₃+k5₄₄+k5₄₇+k5₁₈+k6₃₈+k8₄₃+k6₄₂+k6₄₃+k6₄₄+k6₄₇+k7₁₂+k7₂₁+k7₂₂k7₃₁+k7₃₄

0×69=k5₂₁+k5₃₁+k5₄₁+k5₄₃+k5₄₄+k4₄₁+k6₄₃+k6₄₄+k7₂₂+k7₃₂

0×cα=k5₂₂+k5₃₂+k4₄₂+k5₄₄+k6₄₂+k6₄₄+k7₂₃+k7₃₃

0×51=k5₃₂+k5₃₃+k5₄₁+k5₄₃+k6₄₁+k6₄₃+k7₂₁+k7₂₄+k7₃₁+k7₃₄

0×5e=k5₂₄+k5₃₄+k5₄₂+k5₄₃+k6₄₂+k6₄₃+k7₂₁+k7₃₁

0×33=k5₂₅+k5₃₅+k5₄₂+k5₄₄+k5₄₈+k6₄₂+k6₄₃+k6₄₄+k6₄₈+k7₁₃+k7₂₁+k7₂₂+k7₂₃+k7₃₁+k7₃₂

0×48=k5₂₆+k5₃₆+k5₄₁+k5₄₃+k5₄₅+k6₄₃+k6₄₄+k6₄₅+k7₁₁+k7₁₄+k7₂₁+k7₂₂+k7₂₃+k7₂₄+k7₃₂+k7₃₃

0×28=k5₂₇+k5₃₇+k5₄₁+k5₄₂+k5₄₄+k56₄₆+k6₁₄+k6₄₆+k7₁₁+k7₁₂+k7₂₂+k7₂₃+k7₂₄+k7₃₁+k7₃₃+k7₃₄

0×e7=k5₂₈+k5₃₈+k5₄₁+k5₄₃+k5₄₄+k5₄₈+k6₄₃+k6₄₁+k6₄₂+k6₄₃+k6₄₄+k6₄₇+k6₄₈+k7₁₂+k7₂₂+k7₂₄+k7₃₁+k7₃₃

0×09=k5₄₁+k5₄₂+k5₄₃+k5₄₄+k6₁₁+k6₄₁+k6₄₂+k7₁₃+k7₁₄+k7₂₁+k7₂₂+k7₂₃+k7₂₄+k7₃₁+k7₃₃+k7₄₁

0×16=k5₄₂+k5₄₃+k5₄₄+k6₁₂+k6₁₄+k6₄₂+k6₄₃+k7₁₄+k7₂₂+k7₂₃+k7₂₄+k7₃₂450 k7₃₃+k7₄₂

0×de=k5₄₃+k5₄₄+k6₁₃+k6₄₂+k6₄₃+k6₄₄+k7₁₁+k7₂₃+k7₂₄+k7₃₁+k7₃₅+k7₃₄+k7₄₃

0×2c=k5₄₄+k6₁₁+k6₁₄+k6₄₂+k6₄₄+k7₁₂+k7₂₆+k7₃₂+k7₃₄+k7₄₁+k7₄₄

0×02=k5₄₆+k5₄₇+k6₁₂+k6₁₃+k6₁₄+k6₁₆+k6₄₂+k6₄₃+k6₄₄+k6₄₆+k6₄₇+k7₁₂+k7₁₃+k7₁₄+k7₂₂+k7₂₃+k7₃₄+k7₄₂+k7₄₃+k7₄₄+k7₄₀

0×43=k5₄₆+k5₄₃+k6₁₁+k6₁₂+k6₁₃+k6₁₄+k6₁₅+k6₄₁+k6₄₂+k6₄₃+k6₄₄+k6₄₅+k6₄₈+k7₁₁+k7₁₂+k7₁₃+k7₁₄+k7₂₃+k7₃₃+k7₃₄+k7₄₁+k7₄₂+k7₄₃+k7₄₄+k7₄₅

0×7d=k5₄₇+k6₁₁+k6₁₂+k6₁₃+k6₁₄+k6₁₅+k6₁₆+k6₁₇+k6₄₁+k6₄₃+k6₄₄+k6₄₇+k7₁₁+k7₁₃+k6₁₄+k7₂₄+k7₃₁+k7₃₃+k7₄₁+k7₄₃+k7₄₄+k7₄₅+k7₄₇

0×57=k6₄₄+k6₁₁+k6₁₄+k6₁₆+k6₁₈+k6₄₁+k6₄₄+k6₄₈+k7₁₁+k7₁₄+k7₂₁+k7₂₂+k7₂₃+k7₃₄+k7₃₂+k7₃₃+k7₄₁+k7₄₄+k7₄₈+k7₄₈

0×37=k6₁₁+k6₁₄+k6₂₂+k6₂₃+k6₃₂+k6₄₂+k7₁₂+k7₂₁+k7₂₂+k7₃₁+k7₄₁+k7₄₄

0×94=k6₁₂+k6₁₄+k6₂₂+k6₂₃+k6₃₂+k6₃₃+k6₄₂+k6₄₃+k7₁₂+k7₁₃+k7₂₁+k7₂₃+k7₃₁⇄k7₃₃+k7₄₂+k7₄₄

0×51=k6₁₃+k6₂₃+k6₃₁+k6₄₁+k7₁₁+k7₂₁+k7₂₄+k7₃₄+k7₄₃

0×5e=k6₁₄+k6₂₂+k6₂₃+k6₂₄+k6₃₂+k6₃₃+k6₃₄+k6₄₂+k6₄₃+k6₄₄+k7₁₂+k7₁₃+k7₁₄+k7₂₁+k7₃₁+k7₃₂+k7₃₂+b 7₃₃+k7₃₄+k7₄₄

0×33=k6₁₅+k6₁₆+k6₁₇+k6₁₈+k6₂₂+k6₂₄+k6₂₅+k6₃₂+k6₃₄+k6₃₅+k6₄₁+k7₁₁+k7₂₁+k7₄₅+k7₄₆k7₄₇+k7₄₈

0×48=k6₁₆+k6₁₇+k6₁₈+k6₂₁+k6₂₃+k6₂₆+k6₃₁+k6₃₆+k6₄₂+k7₁₂+k7₂₂+k7₄₆+k47+k7₄₈

0×28=k6₁₇+k6₁₈₂+k6₂₁+k6₂₂+k6₂₄+k6₂₇+k6₃₁+k6₃₄+k6₃₇+k6₄₃+k7₁₅+k7₂₃+k7₄₇+k7₄₈

0×f4=k6₁₈+k6₂₁+k6₂₂+k6₂₃+k6₂₅+k6₂₆+k6₃₁+k6₃₂+k6₃₃+k6₃₅+k6₃₈+k6₄₁+k6₄₁+k7₁₁+k7₁₄+k7₂₁+k7₂₄+k7₄₈

0×f7=k6₂₁+k6₂₅+k6₃₁+k6₃₅+k6₄₂+k7₁₁+k7₂₂+k7₂₄+k7₃₁+k7₃₂+k7₃₄+k7₄₃+k8₁₃+k8₂₃

0×cc=k6₂₂+k6₂₃+k6₂₄+k6₂₈+k6₂₇+k6₂₃+k6₃₂+k6₃₃+k6₃₄+k6₃₅+k6₃₇+k6₃₈+k6₄₂+k6₄₃+k6₄₄+k7₁₄+k7₁₃+k7₁₄+k7₂₁+k7₂₂+k7₃₁+k7₃₂+k7₃₄+k7₄₄+k8₁₄+k8₂₄

0×52=k6₂₃+k6₂₄+k6₂₇+k6₂₈+k6₃₃+k6₃₄+k6₃₇+k6₃₈+k6₄₃+k6₄₄+k7₁₃+k7₁₄+k7₂₂+k7₂₃+k7₃₂₃+k7₃₄+k7₄₁+k8₁₁+k8₂₁

0×f8=k6₂₄+k6₂₈+k6₃₄+k6₃₃+k6₃₄+k6₃₃+k6₄₄+k7₁₄+k7₂₁+k7₂₃+k7₂₄+k7₃₁+k7₃₃+k7₄₂+k8₁₂+k8₂₂

0×f9=k6₂₅+k6₃₇+k6₂₈+k6₃₅+k6₃₇+k6₃₈+k6₃₁+k6₄₂+k6₄₄+k7₁₁+k7₁₂+k7₁₄+k7₂₂+k7₂₃+k7₂₄+k7₃₁+k7₃₃+k7₄₁+k7₄₂+k7₄₃+k7₄₄+k7₄₆+k8₁₁+k8₁₂+k8₁₃+k8₁₄+k8₁₆+k8₂₁+k8₂₂+k8₂₄+k8₂₅

0×60=k6₂₆+k6₂₇+k6₃₆+k6₃₇+k6₄₁+k6₄₃+k7₁₁+k7₁₃+k7₂₇+k7₂₂+k7₂₄+k7₃₂+k7₃₄+k7₄₁+k7₄₂+k7₄₃+k7₄₅+k8₁₁+k8₁₂+k8₁₃+k8₁₅+k8₂₁+k8₁₅+k8₂₁+k22₂₇+k8₂₃+k8₂₅

0×c1=k6₂₇+k6₂₈+k6₃₇+k6₃₈+k6₄₂+k7₁₂+k6₂₁+k7₂₂+k7₃₁+k7₄₁+k7₄₄+k7₄₅+k7₄₇+k8₁₁+k8₁₄+k8₁₅+k8₁₇+k8₂₁+k8₂₄+k8₂₅+k8₂₇

0×c0=k6₂₄+k6₃₈+k6₄₃+k7₁₃+k7₂₂+k7₂₃+k7₄₁+k7₄₂+k7₄₈+k7₄₆+k7₄₈+k8₁₁+k8₁₂+k8₁₃+k8₁₆+k8₁₈+k8₂₁+k8₂₂+k8₂₅+k8₂₆+k8₂₈

0×2c=k6₄₁+k6₄₃+k7₁₁+k7₁₃+k7₂₁+k7₂₂+k7₃₄+k7₃₂+k7₃₄+k7₄₁+k7₄₃+k7₄₄+k7₄₅+k8₁₁+k8₁₃+k8₁₄+k8₁₅+k8₂₃+k8₂₄+k8₂₅+k8₃₁

0×08=k6₄₃+k6₄₄+k7₁₃+k7₁₄+k7₂₄+k7₃₃+k7₄₁+k7₄₂+k7₄₃+k7₄₄+k7₄₆+k7₄₇+k8₁₁+k8₁₂+k8₁₃+k8₁₄+k8₁₆+k8₁₇+k8₂₁+k8₂₄+k8₂₆+k8₂₇+k8₂₂+k8₂₃

0×e9=k6₄₄+k7₁₄+k7₂₂+k7₃₁+k7₃₄+k7₄₃+k7₄₄+k7₄₅+k7₄₇+k7₄₈+k8₁₂+k8₁₃+k8₁₄+k8₁₅+k8₁₇+k8₁₈+k8₂₁+k8₂₂+k8₂₃+k8₂₇+k8₂₈+k8₂₁+k8₂₄

0×cd=k6₄₅+k7₁₅+k7₂₁+k7₂₂+k7₂₃+k6₇₃240 k7₂₅+k7₃₁+k7₃₂+k7₃₃+k7₃₄+k7₄₁+k7₄₅⇄k8₁₁+k8₁₂+k8₁₈+k8₂₂+k8₂₃+k8₂₆+k8₂₈+k8₃₁+k8₃₂+k8₃₃

0×fd=k6₄₅+k7₁₆+k7₂₂+k7₂₃+k7₂₄+k7₂₆+k7₃₂+k7₅₃+k7₃₄+k7₄₂+k7₄₅+k7₄₇+k8₁₂+k8₁₅+k8₁₇+k8₂₁+k8₂₃+k8₂₄+k8₂₅+k8₂₇+k8₃₁+k8₃₂+k8₃₃+k8₃₄

0×e1=k6₄₇+k7₁₇+k7₂₃+k7₂₄+k7₂₇+k7₃₃+k7₃₄+k7₄₃+k7₄₈+k8₁₂+k8₁₅+k8₁₆+k8₁₈+k8₂₂+k8₂₄+k8₂₅+k8₂₆+k8₂₈+k8₃₂+k8₃₃+k8₃₄

0×e9=k6₄₈+k7₁₈+k7₂₁+k7₂₂+k7₂₃+k7₃₈+k7₃₁+k7₃₂+k7₃₃+k7₄₄+k7₄₅+k7₄₇+k7₄₅+k8₁₄+k8₁₅k8₁₆+k8₂₁+k8₂₂+k8₂₅+k8₂₇+k8₂₈+k8₃₁+k8₃₂+k8₃₄

0×0α=k7₁₁+k7₂₃+k7₂₄+k7₃₃+k7₃₄+k7₄₃+k7₄₄+k8₁₃+k8₁₄+k6₂₂+k8₃₂+k8₃₃+k8₃₄+k8₄₁

0×02d=k7₁₂+k7₂₄+k7₃₄+k7₃₇+k7₄₄+k8₁₄+k8₂₃+k8₃₃+k8₃₄+k8₄₂

0×e0=k7₁₃+k7₂₁+k7₃₁+k7₄₁+k8₁₁+k8₂₁+k8₂₄+k8₃₄+k8₄₃

0×α4=k7₁₄+k7₂₂+k7₂₃+k7₂₄+k7₃₂+k7₃₃+k7₃₄+k7₄₂+k7₄₃+k7₄₄+k8₁₂+k8₁₃+k8₁₄+k8₂₁+k8₃₁+k8₃₂+k8₃₃+k8₄₄

0×8e=k7₁₅+k7₂₁+k7₂₂+k7₃₁+k7₃₂+k7₄₂+k7₄₃+k7₄₄+k7₄₅+k8₁₂+k8₁₄+k8₁₅+k8₂₁+k8₂₃+k8₂₄+k8₂₅+k8₃₁+k8₃₁+k8₃₂+k8₄₅

0×db=k7₁₆+k7₂₂+k7₂₃+k7₃₂+k7₃₃+k7₄₃+k7₄₄+k7₄₅+k7₄₆+k8₁₃+k8₁₄+k8₁₅+k8₂₃+k8₂₄+k8₂₆+k8₃₂+k8₃₃+k8₄₅

0×58=k7₁₇+k7₂₁+k7₂₃+k7₂₄+k7₃₁+k7₃₃+k7₃₄+k7₄₄+k7₄₇+k8₁₄+k8₁₇+k8₂₁+k8₂₃+k8₂₇+k8₃₁+k8₃₃+k8₃₄+k8₄₇

0×2e=k7₁₈+k7₂₁+k7₂₄+k7₃₁+k7₂₄+k7₄₁+k7₄₂+k7₄₃+k7₄₅+k7₄₆+k8₁₁+k8₁₂+k8₁₃+k8₁₄+k8₁₈+k8₂₂+k8₃₁+k8₃₄+k8₄₈

0×91=k7₂₁+k7₂₄+k7₃₂+k7₃₄+k7₄₁+k7₄₁+k7₄₂+k7₄₃+k7₄₄+k8₁₁+k8₁₂+k8₁₄+k8₂₃+k8₂₄+k8₂₈+k8₃₁+k8₃₂+k8₃₅

0×68=k7₂₂+k7₂₄+k7₃₂+k7₃₄+k7₄₁+k8₁₁+k8₂₃+k8₂₄+k8₂₇+k8₃₁+k8₃₃+k8₃₆+k8₃₇

0×1f=k7₂₃+k7₃₃+k7₄₁+k7₄₂+k7₄₃+k8₁₁240 k8₁₂+k8₁₃+k8₂₂+k8₂₃+k8₂₄+k8₂₅+k8₃₁⇄k8₂₄+k8₃₅

0×bb=k7₂₄+k7₃₄+k7₄₂+k7₄₄+k8₁₂+k8₁₄+k8₂₁+k8₂₂+k8₂₄+k8₂₆+k8₂₇+k8₂₈+k8₃₁+k8₃₅+k8₃₇+k8₃₈

0×e6=k7₃₅+k7₃₅+k7₄₅+k7₄₇+k7₄₈+k8₁₅+k8₁₇+k8₁₈+k8₂₂+k8₂₃+k8₂₅+k8₂₇+k8₃₂+k8₃₃+k8₃₈+k8₃₄'k8₃₅+k8₃₇

0×5e=k7₂₈+k7₃₆+k7₄₅+k7₄₇+k7₄₈+k8₁₆+k8₁₇+k8₁₈+k8₂₁+k8₂₃+k8₂₄+k8₂₅+k8₂₆+k8₃₁+k8₃₃k8₃₄+k8₃₅+k8₃₇

0×77=k7₂₇+k7₃₇+k7₄₇+k7₄₈+k8₁₇+k8₁₈+k8₂₂+k8₂₄+k8₂₅+k8₂₆+k8₂₇+k8₃₂+k8₃₄+k8₃₅+k8₃₆k8₃₈

0×42=k7₃₅+k7₃₈+k7₄₅+k7₄₈+k7₄₇+k8₁₅+k8₁₆+k8₁₇+k8₂₁+k8₂₂+k8₂₆+k8₂₈+k8₃₁+k8₃₂+k8₂₅₃+k8₃₇+k8₃₈

0×78=k7₄₁+k7₄₅+k7₄₆+k7₄₈+k8₁₁+k8₁₅+k8₁₆+k8₁₈+k8₂₂+k8₂₄+k8₂₆+k8₃₁+k8₃₂+k8₃₄+k8₃₅+k8₃₈+k8₄₁+k9₁₁+k9₂₁

0×85=k7₄₁+k7₄₅+k7₄₆+k7₄₇+k8₁₂+k8₁₆+k8₁₇+k8₂₁+k8₂₃+k8₂₇+k8₃₁+k8₃₂+k8₃₃+k8₃₄+k8₃₅+k8₄₂+k9₁₂+k9₂₂

0×16=k7₄₃+k7₄₄+k7₄₆+k7₄₇+k7₄₈+k8₁₅+k8₁₅+k8₂₁+k8₂₂+k8₂₄+k8₂₅+k8₂₈+k8₃₁+k8₃₂+k8₃₃+k8₃₄+k8₃₅+k8₃₇+k8₄₃+k8₁₃+k8₂₃

0×24=k7₄₄+k7₄₅+k7₄₆+k8₁₄+k8₁₅+k8₁₇+k8₂₁+k8₂₃+k8₂₄+k8₂₅+k8₃₇+k8₄₄+k9₁₄+k9₂₄

0×7c=k7₄₅+k7₄₇+k7₄₈+k8₁₅+k8₁₇+k8₁₈+k8₁₈+k8₂₁+k8₂₂+k8₂₅+k8₂₇+k8₂₈+k8₃₁+k8₃₂+k8₃₅+k8₄₈+k8₁₃+k9₁₆+k9₂₃+k9₂₈

0×42=k7₄₆+k7₄₇+k8₁₆+k8₁₇+k8₂₁+k8₂₄+k8₂₅+k8₂₆+k8₂₇+k8₂₈+k8₃₁+k8₃₄+k8₃₅+k8₄₂+k8₄₅k9₁₂+k9₂₂+k9₂₅

0×5d=k7₄₇+k7₄₈+k8₁₇+k8₁₉+k8₂₁+k8₂₂+k8₂₃+k8₂₄+k8₂₅+k8₂₆+k8₃₁+k8₃₂+k8₃₃+k8₃₄+k8₃₆k8₃₇+k8₄₁k8₄₂+k8₄₄+k8₄₅+k8₄₇+k9₁₁+k9₁₄+k9₂₂+k9₂₄+k9₂₅k9₂₇

0×56=k7₄₈+k8₁₈+k8₂₂+k8₂₃+k8₂₄+k8₂₅+k8₂₆+k8₃₂+k8₃₃+k8₂₄+k8₃₅+k8₃₆+k8₃₈+k8₄₁+k8₄₂+k8₄₅+k8₄₆+k8₄₈+k9₁₁+k9₁₂+k9₁₅+k9₁₆+k9₁₈+k9₂₁+k9₂₂+k9₂₃+k9₂₅+k9₂₆+k9₂₃ [formula 39]

Here, the following equation holds true.

rank(M*_{KH})=Nₘ-Nᵣ [formula 40]

Thus, the above 168 linear-relation equations are linear-relation equations independent of each other. It is therefore obvious that (2¹⁶⁸-1) linear-relation equations obtained from linear concatenation of any of the 168 equations on the GF(2) hold true. If the number of such linear-relation equations is large, it is feared that a new attack that the designer of the encryption method is not aware of is brought about. For this reason, the total number of linear-relation equations obtained by adoption of the method described above can be used as an indicator for the evaluation of the encryption level.

The present invention has been described in detail by referring to the specific embodiments. It is obvious, however, that a person skilled in the art is capable of correcting and modifying the embodiments within a range not deviating from the principle of the present invention. That is to say, the embodiments are explained only for the purpose of disclosing the present invention and not to be interpreted as limitations imposed on the present invention. The scope of the present invention should thus be determined by referring to claims appended at the end of this specification.

It is to be noted that the series of processes explained in this specification can be carried out by using hardware, software or a combination of hardware and software. In the case of software used as an execution means, a program prescribing the series of processes is executed. The program is installed in advance in a memory employed in a computer including embedded special hardware or a general-purpose computer capable or carrying out various kinds of processing. Typically, the program is recorded in advance in a recording medium embedded in the computer. Examples of the embedded recording medium are a hard disc or a ROM (Read Only Memory).

As an alternative, the program is stored (or recorded) in advance in a removable recording medium temporarily of permanently. Examples of the removable recording medium are a flexible disc, a CD-ROM (Compact Disc Read Only Memory), an MO (Magneto-optical) disc, a DVD (Digital Versatile Disc), a magnetic disc and a semiconductor memory. Then, the program recorded on the removable recording medium is presented to the user as the so-called package software. The program is then installed in the computer from the removable recording medium described above.

It is to be noted, however, that the program can also be downloaded to the computer from a download site by a wireless communication or by a wire communication through a network instead of being presented to the user by using a removable recording medium. Examples of the network are a LAN (Local Area Network) and the Internet. The computer includes functions to receive the downloaded program and install the received program in the embedded recording medium such as a hard disc.

It is to be noted that the various kinds of processing described in this specification can be carried out not only sequentially in accordance with a predetermined sequence but also concurrently or individually in accordance with the processing capacity of the apparatus for performing the processing or in accordance with the necessity.

As described above, in accordance with the configuration of the present invention, it is possible to comprehend all equations expressing linear relations among round keys in the common-key block encryption method without regard to the complexity of key scheduling and possible to evaluate the encryption level of the common-key block encryption method on the basis of the derived equations expressing linear relations among round keys.

In addition, in accordance with the configuration of the present invention, the key-scheduling part algorithm, which is one of encryption algorithms, is expressed in terms of equations represented by vectors and a matrix and, then, non-linear transformation output values and initial values are eliminated from the matricial equation by carrying out a unitary transformation process in order to find all equations expressing linear relations among round keys. If the relations among the round keys are simple dependence relations, the number of true round keys decreases. Thus, the designer of the encryption method needs to use caution so as to prevent a large number of such relation equations from existing. In accordance with the method provided by the present invention, the level of encryption keys is evaluated for the purpose of reducing the number of equations expressing linear relations among round keys. As a result, a safer encryption method can be designed.

What is claimed is:

1. An encryption level indicator calculation method based on an encryption processing algorithm and composed of:
a step of setting a common key block encryption processing algorithm, which is to serve as said encryption processing algorithm to be used as the base of said encryption level indicator calculation method, has a key-scheduling part comprising a linear transformation part and a non-linear transformation part and includes:
a sub-step of generating initial values Uᵢ (where i=1, 2 and so on) from a master key;
a sub-step of calculating intermediate values Zᵢ⁽⁰⁾ (where i=1, 2 and so on) from said initial values Uᵢ (where i=1, 2 and so on);
a plurality of sub-steps of calculating intermediate values Zᵢ^{(r)} (where i=1, 2 and so on) from intermediate values Zᵢ^{(r-1)} (where i=1, 2 and so on);
a sub-step of calculating said non-linear transformation part outputs Vᵢ^{(r)} (where i=1, 2 and so on and r=1, 2 and so on) from said intermediate values Zᵢ^{(r)} (where i=1, 2 and so on and r=1, 2 and so on) and said initial values Uᵢ (where i=1, 2 and so on); and
a sub-step of calculating round keys Kᵢ^{(r)} (where i=1, 2 and so on and r=1, 2 and so on) from said intermediate values Zᵢ^{(r)} (where i=1, 2 and so on and r=1, 2 and so on) and said non-linear transformation part outputs Vᵢ^{(r)} (where i=1, 2 and so on and r=1, 2 and so on);
a step of eliminating said intermediate values Zᵢ^{(r)} (where i=1, 2 and so on and r=1, 2 and so on) serving as variables so that said round keys Kᵢ^{(r)} (where i=1, 2 and so on and r=1, 2 and so on) can be expressed as a linear combination of said initial values Uᵢ (where i=1, 2 and so on) and said non-linear transformation part outputs Vᵢ^{(r)} (where i=1, 2 and so on and r=1, 2 and so on);
a step of transforming said linear combination into a simultaneous linear equation completing transposition of terms and, thus, consisting of only terms of said initial values Uᵢ (where i=1, 2 and so on) and said non-linear transformation part outputs Vᵢ^{(r)} (where i=1, 2 and so on and r=1, 2 and so on) on the right-hand side of said equation;
a step of transforming said simultaneous linear equation into a matricial equation;
a step of multiplying both the left-hand and right-hand sides of said matricial equation by a row-deform unitary matrix deforming a matrix on the right-hand side of said matricial equation obtained as a result of transformation into a step matrix from the left;
a step of creating a new matrix consisting of lowest N rows of a matrix on the left-hand side of said matricial equation obtained as a result of transformation where N is a number obtained as a result of subtracting the rank value of said step matrix from the number of rows in said step matrix; and
a step of finding N linear-relation equations by multiplying a column vector consisting of said round keys Kᵢ^{(r)} (where i=1, 2 and so on and r=1, 2 and so on) as elements by said new matrix generated at said preceding step,.
where:
symbol Uᵢ (where i=1, 2 and so on) denotes an initial value of said key-scheduling part;
symbol Zᵢ^{(r)} (where i=1, 2 and so on and r=1, 2 and so on) denotes an intermediate value of said key-scheduling part;
symbol Vᵢ^{(r)} (where i=1, 2 and so on and r=1, 2 and so on) denotes an output of said non-linear transformation part; and
symbol Kᵢ^{(r)} (where i=1, 2 and so on and r=1, 2 and so on) denotes a round key calculated from said intermediate values Zᵢ (where i=1, 2 and so on).

2. A program to be executed as a computer program in carrying out an encryption level indicator calculation process based on an encryption processing algorithm and composed of:
a step of setting a common key block encryption processing algorithm, which is to serve as said encryption processing algorithm to be used as the base of said encryption level indicator calculation process and includes:
a sub-step of generating initial values Uᵢ (where i=1, 2 and so on) from a master key;
a sub-step of calculating intermediate values Zᵢ⁽⁰⁾ (where i=1, 2 and so on) from said initial values Uᵢ (where i=1, 2 and so on);
a plurality of sub-steps of calculating intermediate values Zᵢ^{(r)} (where i=1, 2 and so on) from intermediate values Zᵢ^{(r-l)} (where i=1, 2 and so on);
a sub-step of calculating said non-linear transformation part outputs Vᵢ^{(r)} (where i=1, 2 and so on and r=1, 2 and so on) from said intermediate values Zᵢ^{(r)} (where i=1, 2 and so on and r=1, 2 and so on) and said initial values Uᵢ (where i=1, 2 and so on); and
a sub-step of calculating round keys Kᵢ^{(r)} (where i=1, 2 and so on and r=1, 2 and so on) from said intermediate values Zᵢ^{(r)} (where i=1, 2 and so on and r=1, 2 and so on) and said non-linear transformation part outputs Vᵢ^{(r)} (where i=1, 2 and so on and r=1, 2 and so on);
a step of eliminating said intermediate values Zᵢ^{(r)} (where i=1, 2 and so on and r=1, 2 and so on) serving as variables so that said round keys Kᵢ^{(r)} (where i=1, 2 and so on and r=1, 2 and so on) can be expressed as a linear combination of said initial values Uᵢ (where i=1, 2 and so on) and said non-linear transformation part outputs Vᵢ^{(r)} (where i=1, 2 and so on and r=1, 2 and so on);
a step of transforming said linear combination into a simultaneous linear equation completing transposition of terms and, thus, consisting of only terms of said initial values Uᵢ (where i=1, 2 and so on) and said non-linear transformation part outputs Vᵢ^{(r)} (where i=1, 2 and so on and r=1, 2 and so on) on the right-hand side of said equation;
a step of transforming said simultaneous linear equation into a matricial equation;
a step of multiplying both the left-hand and right-hand sides of said matricial equation by a row-deform unitary matrix deforming a matrix on the right-hand side of said matricial equation obtained as a result of transformation into a step matrix from the left;
a step of creating a new matrix consisting of lowest N rows of a matrix on the left-hand side of said matricial equation obtained as a result of transformation where N is a number obtained as a result of subtracting the rank value of said step matrix from the number of rows in said step matrix; and
a step of finding N linear-relation equations by multiplying a column vector consisting of said round keys Kᵢ^{(r)} (where i=1, 2 and so on and r=1, 2 and so on) as elements by said new matrix generated at said preceding step,
where:
symbol Uᵢ (where i=1, 2 and so on) denotes an initial value of said key-scheduling part;
symbol Zᵢ^{(r)} (where i=1, 2 and so on and r=1, 2 and so on) denotes an intermediate value of said key-scheduling part;
symbol Vᵢ^{(r)} (where i=1, 2 and so on and r=1, 2 and so on) denotes an output of said non-linear transformation part; and
symbol Kᵢ^{(r)} (where i=1, 2 and so on and r=1, 2 and so on) denotes a round key calculated from said intermediate values Zᵢ (where i=1, 2 and so on).
